(19) United States
(12) Patent Application Publication
(10) Pub. No.: US 2015/0058234 A1
(43) Pub. Date: Feb. 26, 2015

(54) METHOD AND SYSTEM FOR COMPUTER ASSISTED VALUATION MODELING

(71) Applicant: Raymond L. Dozier, Palm Desert, CA (US)

(72) Inventor: Raymond L. Dozier, Palm Desert, CA (US)

(21) Appl. No.: 14/463,512

(22) Filed: Aug. 19, 2014

Related U.S. Application Data
(60) Provisional application No. 61/867,975, filed on Aug. 20, 2013.

(51) Int. Cl. G06T 11/20; G06Q 50/16; G06Q 10/04

(52) U.S. Cl. CPC G06T 11/206; G06Q 10/04; G06Q 50/165
USPC 705/315; 345/440

(57) ABSTRACT

Methods and systems for computer assisted valuation modeling are disclosed. In one aspects, an apparatus includes a processor, configured to present a real estate project timeline on a user interface of an electronic display. The processor is configured to display the timeline as one of two types, the first type indicating an as if complete at stabilized occupancy value, the second type indicating an aggregate retail value. In some aspects, the processor is further configured to execute a first module that presents an as is value of unentitled land with the timeline when the timeline is of the first or second type.

### CROSS REFERENCE TO RELATED APPLICATIONS

This application claims priority to U.S. Provisional Application No. 61/867,975, filed Aug. 20, 2013. The disclosure of this prior application is considered part of this application, and is hereby incorporated by reference in its entirety.

### BACKGROUND

The current state of the art in determining values based on future forecasts for any specific property is the discounted cash flow model (DCF). This model generally uses commercial spreadsheet software whereby the user fills in spreadsheet cells indicating net operating incomes or cash flows during a typical investment holding period. In certain circumstances, the user will forecast an ending sale price or “reversion.” Therefore, net operating income or cash flow annuities and reversion may be discounted to the present using a discount rate that also represents the annual property yield of the total investment both non-leveraged (property yield) and leveraged (equity yield). Current state of the art solutions provide the resulting net present value or value indication together with the associated risk rate or yield.

### SUMMARY

This patent application describes methods, systems, and computer readable media designed to solve many of the problems associated with the current generation of valuation methods described above. In addition to the methods, a computer-implemented system for performing a method according to various embodiments of the disclosed solution is also provided. The system, also referred to as an apparatus, includes a web server connected to a network, for example, the Internet. The web server further comprises a database and an application for providing an interface and performing the methods according to an embodiment of the disclosed solution. Methods according to the present disclosed solution may be performed by software residing on the web server, or on other servers on the network that are accessible to the web server. The web server may contain web pages and other information transmitted to the network in response to a request received from the network. The system may also include one or more secondary web servers connected to the network.

In addition, a computer readable media including instructions operative to configure a processor to perform the methods is also disclosed. This computer readable media may be included as part of a web server, or may be accessible by the web server. The computer readable media may be accessed by one or more web application programs running on one or more web servers that load and execute the instructions stored on the computer readable media. These instructions then cause the web server to perform aspects of the methods.

Another aspect disclosed is an apparatus for computer assisted valuation modeling. The apparatus includes a processor, configured to present a real estate project timeline on a user interface of an electronic display, the processor configured to display the real estate project timeline as one of two types, the first type indicating an as if complete at stabilized occupancy value, the second type indicating an aggregate retail value, wherein the processor is further configured to execute: a first module that presents an as is value of unentitled land with the timeline when the timeline is of the first or second type, a second module that presents an as is value of entitled land with the timeline when the timeline is of the first or second type, and a third module that presents an as is value of entitled land and improvements with the timeline when the timeline is of the first or second type.

In some aspects, the processor is further configured to execute a fourth module that presents an as if complete at non stabilized occupancy value with the timeline when the timeline is of the first type and displays a bulk value with the timeline when the timeline is of the second type. In some aspects, the processor is further configured to present a second timeline on a user interface of an electronic display, the processor configured to execute a fifth module that presents an as is complete value and a reversion value with the second timeline.

Another aspect disclosed is an apparatus for computer assisted valuation modeling. The apparatus includes a network interface configured to receive data defining an economic fabric graph, an electronic display presenting the economic fabric graph and a wave cycle overlay, the economic fabric graph relating a market value to an intrinsic/natural value; and an electronic processor configured to receive data from the network interface and present the data on the electronic display. In some aspects, the economic fabric graph relates both a real estate project's natural value to the real estate project's market value, and a reversion of the real estate project's natural value to a reversion of the real estate project's market value. In some aspects, the display is presenting a wave cycle flow graph with the economic fabric graph, the wave cycle flow graph intersecting the market value and the natural value reversion. In some aspects, the display presents a yield sustainability indicator intersecting the wave cycle flow graph. In some aspects, the display presents the wave cycle flow graph with a bubble indicator when the market value is above the intrinsic value by greater than a threshold. In some aspects, the display presents, with the wave cycle flow graph, an indication of the sustainability of the market value.

Another aspect disclosed is an apparatus for valuation modeling of a real estate project. The apparatus includes one or more electronic processors configured to present, on a user interface of a computer, a graphical depiction of a development timeline for the real estate project, and present, simultaneously with the development timeline, an indication of whether the real estate project is economically feasible on the user interface of the computer.

In some aspects, the one or more processors are configured to: determine an as is value based on a discounted cash flow based on a going out capitalization rate, present the as is value simultaneously with the timeline on the user interface, receive input defining an updated as is value, update the going out capitalization rate and recompute the discounted cash flow based on the updated going out capitalization rate until the discounted cash flow generates a value equivalent to the updated as is value; and present the updated going out capitalization rate on the user interface.

In some aspects of the apparatus, the one or more processors are configured to determine an as is value based on a discounted cash flow using a property discount rate, present the as is value simultaneously with the timeline on the user interface, receive input defining financing information, update the property discount rate and recompute a second discounted cash flow using the updated property discount rate and the financing information until the second discounted cash flow generates a value equivalent to the as is value; and present the updated property discount rate as an equity yield on the user interface of the computer.

In some aspects of the apparatus, the one or more processors are configured to present, on the user interface of the computer, simultaneous with the development timeline, two or more of an as is value, an as if complete stabilized value, and an aggregate retail value. In some aspects, the one or more processors are configured to: present either an as if complete at non-stabilized occupancy value or an bulk/wholesale value on the timeline, present a cost of production value on the timeline; and present the indicator of financial feasibility based on a relationship between the cost of production and either the presented as if complete at non-stabilized occupancy value or the presented bulk/wholesale value. In some aspects, the one or more processors are further configured to request holding period data from the user if the project is not financially feasible, receive holding period data from the user in response to the request, adjust the presented timeline based on the received holding period data, determine whether the real estate project is financially feasible based on the received holding period data; and present an updated indication of financial feasibility on the user interface based on the determining.

In some aspects of the apparatus, the one or more processors are further configured to present on the user interface, input fields for one or more components of value of the real estate project; and iteratively receive updates to one or more of the components of value, determining an updated as is value based on the updated components of value, and updating the project timeline based on the updated “as is” value. In some aspects, the one or more processors are further configured to receive financing parameters for the real estate project, determine an equity yield based at least in part on the financing parameters, present data on the user interface indicating the equity yield, iteratively receive updates to the financing parameters; and update the equity yield based at least in part on the updated financing parameters, and present the updated equity yield on the user interface.

In some aspects of the apparatus, the one or more processors are further configured to determine the property's natural value based on an estimated rent and an estimated rental growth rate, determine the property's market value based on a discounted cash flow; and present, on the user interface of the computer, a first graph relating the property's natural value to the property's market value.

In some aspects of the apparatus, the one or more processors are further configured to present the graph to indicate tenant rental personal income. In some aspects, the one or more processors are further configured to present on the user interface, simultaneous with the first graph, a second graph of estimated valuations of the property over a plurality of points in time, the second graph intersecting the market value and a reversion value for the property's natural value. In some aspects of the apparatus, the one or more processors are further configured to present the second graph to have a maximum or minimum value of a market reversion value. In some aspects of the apparatus, the one or more processors are further configured to present the second graph based on whether an estimate of rental income over time is positive or negative. In some aspects of the apparatus, the one or more processors are further configured to present on the user interface, simultaneous with the second graph, a horizontal line indicating the sustainability of the market value, each end of the horizontal line intersecting a separate point on the second graph, wherein one of the separate points is the market value.

A more complete understanding of the methods, systems, and computer readable media for valuation modeling using a computer may be afforded to those skilled in the art, as well as a realization of additional advantages and objects thereof, by a consideration of the following detailed description. Reference may also be made to the appended sheets of drawings which will first be described briefly.

### BRIEF DESCRIPTION OF THE DRAWINGS

FIG. 1 is a block diagram illustrating a system for delivering a web application over a network according to the present disclosed solution.

FIG. 2 is a simplified block diagram illustrating the internal software architecture of one embodiment of a web server 170.

FIG. 3A illustrates an exemplary organization for five timelines that may be presented on a display (used for properties with a reversion).

FIG. 3B illustrates an exemplary organization for four timelines that may be presented on a display (used for properties where individual units are sold off one by one, and there may be no reversion).

FIG. 3C illustrates an example timeline with discounted cash flows overlaid.

FIG. 3D illustrates an example user interface map of a system for computer assisting valuation modeling.

FIGS. 4A-E illustrate one example of wizard questions displayed to a user when a project type is a multi-family apartment development.

FIG. 5 illustrates one example of a screen displaying components of value resulting from answers to the wizard questions of FIGS. 4A-E.

FIG. 6A illustrates a discounted cash flow for a development's prospective “as if complete” value at non-stabilized occupancy.

FIG. 6B illustrates a discounted cash flow of a development's prospective “as if entitled” value when the land is fully entitled.

FIG. 6C illustrates a discounted cash flow of a development's “as is” value of the land as of the current date.

FIG. 6D illustrates determination of a “cost of production” value at a non-stabilized occupancy for a real estate project.

FIG. 7A is one example of a development timeline with a reversion.

FIG. 7B shows an example of an updated timeline with a reversion.

FIG. 7C shows a development timeline with reversion that also includes an indication that the project is financially infeasible.

FIG. 8 shows a timeline graphic including user interface controls.

FIG. 9A shows a project timeline with reversion and an indication that a proposed development is economically feasible.

FIG. 9B shows a bulk model project timeline with an indication that a proposed development is economically feasible.

FIG. 9C illustrates a project timeline screen constructed from two discounted cash flow models.

FIG. 9D illustrates a project timeline screen based on two discounted cash flow models.

FIG. 9E illustrates how units of comparison are determined.

FIG. 10 is a method of displaying values of a real estate project.

FIG. 11A shows a timeline 1102 for a project that is not economically feasible.

FIG. 11B shows another example of a project that is financially infeasible.

FIG. 11C shows an example of a holding period dialog.

FIGS. 11D-E show project timelines 1172 and 1182 that include respective holding periods 1174 and 1184.

FIG. 11F shows user interface controls that may be present in some aspects of development timelines that include holding periods.

FIG. 11G shows that the addition of the holding period has resulted in a project that is economically feasible.

FIG. 12A shows the selection of a project type indicating an existing property that has already been developed and does not need remodeling but has not reached stabilized occupancy and/or stabilized market rent (module 4 reversion).

FIG. 12B-D show exemplary wizard questions for the project type selected in FIG. 12A.

FIG. 12E illustrates examples of components of value.

FIG. 12F illustrates an example of a discounted cash flow based on components of value of FIG. 12E.

FIG. 12G shows an example of a timeline (module 4).

FIG. 12H shows an example of a “what if” scenario using the timeline of FIG. 12G (module 5 with reversion).

FIG. 13A shows the selection of a project type indicating the property that is already developed and does not need remodeling and has reached stabilized occupancy and stabilized market rents.

FIG. 13B-D show examples of wizard questions for the project type of FIG. 13A.

FIG. 13E shows an example of components of value.

FIG. 13F shows an example of a discounted cash flow using the components of value of FIG. 13E and generating an as is value at stabilized occupancy.

FIG. 13G shows an example timeline graphic 1352 that may be presented on a user interface of the user's computer.

FIG. 13H shows modification of a COV box and its effect on the timeline graphic of FIG. 13G.

FIG. 14A highlights wizard questions that receive financing related data.

FIG. 14B shows components of value that receive financing related data.

FIG. 14C shows a discounted cash flow based on the components of value of FIG. 14B.

FIG. 14D show a discounted cash flow that indicates equity received after loan balance payoff

FIG. 14E shows a discounted cash flow that may be applied to a valuation model of FIG. 3B.

FIG. 14F illustrates one example of a method of determining equity yield.

FIG. 14G shows an example of equity yield presented on a display

FIG. 14H is an example timeline showing a yield spread.

FIG. 14I shows an example “what if” scenario that changes the equity yield based on updated financing parameters.

FIG. 15A-E show example wizard questions.

FIG. 15F shows an example timeline illustrating the economic fabric graph timeline extending beyond the development timeline.

FIG. 15G1 shows one implementation of an economic fabric graph.

FIG. 15G2 is a flowchart of a method for determining yield values on an economic fabric graph.

FIG. 15H shows one implementation of an economic fabric graph (EFG) if different combinations of market value and market value reversions are mixed with intrinsic value and intrinsic value reversions.

FIG. 16A illustrates one implementation of wizard questions for reverse engineering components of value based on a known sales price.

FIG. 16B shows refinement of example database search results.

FIG. 16C shows example component of value ranges found during the database search of FIG. 16B.

FIG. 16D shows example component of value point values identified from the component of value ranges of FIG. 16C.

FIG. 16E1 illustrates an example discounted cash flow based on the component of value point values identified based on comparable properties (that of FIG. 16D). The discounted cash flow is shown before the going out capitalization rate is iterated.

FIG. 16E2 is a method of determining a going out capitalization rate based on a known sales price.

FIG. 16F shows another example of a discounted cash flow that reverse engineers a sales price after a going out capitalization rate is iterated.

FIG. 16G shows a development timeline presented on a user interface of a computer and how the going out capitalization rate was changed through iteration.

FIG. 16H shows an example of a “what if” use case for reverse engineering a sales price.

FIG. 16I is a method of reverse engineering a property's components of value based on a sales price.

FIG. 17A shows example wizard questions for an automated valuation model.

FIG. 17B shows refinement of comparable properties found in a database.

FIG. 17C shows component of value ranges resulting from selection of comparable properties.

FIG. 17D shows refinement of component of value ranges into point values.

FIG. 17E-F shows discounted cash flows using the component of value point values of FIG. 17D.

FIG. 17G shows an example timeline displaying values determined based on the discounted cash flows of FIG. 17E-F.

FIG. 17H shows an example “what if” analysis when using the automated valuation model.

FIG. 18A shows example wizard questions for one aspect of database and comparables searching.

FIG. 18B shows results of a database search filtered through a decision tree model.

FIG. 18C shows an example display on a user interface of comparable search results.

FIG. 19A shows a user interface flow for financial reporting.

FIG. 19B shows an EFG graph displaying historical value changes

FIG. 20 is a method of periodic revaluation and reporting of a portfolio of assets. In some aspects, process 2000 may be performed by the web server(s) 170a-c.

FIG. 21A shows an economic fabric graph (EFG) and how the market value has detached from the intrinsic value by 30%.

FIG. 21B shows an economic fabric graph (EFG) that includes a wave-cycle overlay 2110b.

FIG. 21C illustrates a wave cycle overlay with an expansion or contraction bubble cycle.

FIG. 21D shows an economic fabric graph with a wave cycle overlay indicating a bubble phenomenon that is presented on a user interface of a display based on a detachment above a threshold.

FIG. 21E shows another example of an economic fabric graph with a wave cycle overlay indicating a normal non-bubble cycle that is presented on a user interface of a display based on a detachment below a threshold.

FIGS. 21F-I show examples of a current market value of a property deviating substantially above the natural or intrinsic value timelines.

FIGS. 21J-O show examples of a market value of a property that is below the natural or intrinsic value.

### DETAILED DESCRIPTION

The methods and systems disclosed herein satisfy the need for a method, apparatus, and computer readable media for managing a project. In one especially advantageous implementation, the methods and systems disclosed also satisfy the need for commercial real estate valuation. Various terms and acronyms are used throughout the detailed description, including at least some of the following:

Application: Within the context of computer hardware and software, an application is a set of one or more computer programs that performs a function when executed within a computer hardware device. If the set is comprised of plural programs, the programs are coordinated to perform a function together; such programs may also perform other functions individually. Similarly, a program may be comprised of plural modules that perform certain functions individually and other functions when combined in various ways.

Absorption Period—The actual or expected period required from the time a property is initially offered for lease, purchase, or use by its eventual users until all portions have been sold or stabilized occupancy has been achieved. Although marketing may begin before the completion of construction, most forecasters consider the absorption period to begin after the completion of construction.

Ad Valorem Tax—1. A tax levied in proportion to the value of the property being taxed. (USPAP, 2002 ed.) 2. A tax levied in proportion to the value of the thing(s) being taxed; generally refers to property taxes, etc. Exclusive of exemptions, use value assessment provisions, and the like, the property tax is an ad valorem tax. (IAAO)

Aggregate Retail—The sum total dollar amount when a multi-property development (condos, lots, etc.) are sold over time one-by-one to separate buyers.

Appraisal—The act or process of developing an opinion of value; an opinion of value. (adj.) of or pertaining to appraising and related functions such as appraisal practice or appraisal services. See also Complete appraisal; limited appraisal

“As If Complete” Bulk Value—When a multi-property development (condos, lots, etc.) is 100% complete but before the first unit is sold. Bulk value concept is what one person will buy all finished units on the same date.

“As If Complete” Non-Stabilized Value—When a property is 100% complete but has not reached it's stabilized leasing potential.

“As If Complete” Stabilized Value—When a property is 100% complete and has reached it's stabilized leasing potential.

“As Is” Prospective Value—The future physical and economic condition of the property if the current highest and best use of the property is not ready to start the development process.

“As Is” Value—The current physical and economic condition of the property as of the date of valuation.

Below-the-line expense—An expense that is recorded “below” the net operating income line in a reconstructed operating statement and therefore is not considered part of the total operating expenses for the property; tenant improvements and leasing concessions are the most common line items recorded below the net operating income.

Cash Flow—The periodic income attributable to the interest in real property. See also After Tax Cash Flow (ATCF); Pretax Cash Flow.

Classification—The act of segregating property into two or more classes for the application of different effective tax rates by means of one or more special property taxes or a classified property tax system (IAAO). Valuexpose has 13 major property classifications (i.e. residential, office, retail, industrial, etc.)

Closing Costs—The settlements costs incurred in the transferring of property ownership, e.g., recording fees, attorney fees, and title insurance premiums.

Components of Value—Market value is the present value of the property's forecasted future benefits. Therefore, bundled up in a property's sale price are the market's forecasts or “bets” associated with the expected benefits of the property. These “bets” are all components of value or (COV). Some of the major forecasts or “bets” are amount of rent the property can generate now and throughout the investment holding period; the occupancy levels; the expense levels; and what the property will sell for in the future at the end of the investment holding period. If these forecasts or “bets” are too optimistic or with a low probability of being achieved, the beginning sale price might not be sustainable throughout the investment holding period.

Cost of Production—Total cash needed to develop a property and deliver into the market place before it is leased (in the case of a single property) or selling the first unit (in the case of multi-units, i.e. Condos, lots, etc.). Total costs include: land cost, direct costs, entrepreneurial profit, opportunity costs, and soft costs. Cost of production does not include leasing or selling costs of the developed product.

Direct costs—1. Expenditures for the labor and material used in the construction of improvements; also called hard costs. See also Indirect costs. 2. The labor, material, subcontractor, and heavy equipment costs directly incorporated into the construction of physical improvements.

Discount Rate—An interest rate used to convert future payments or receipts into present value. The discount rate may or may not be the same as the internal rate of return (IRR) or yield rate depending on how it is extracted from the market and/or used in the analysis.

Discounted Cash Flow (DCF) Analysis—The procedure in which a discounted rate is applied to a set of projected income streams and reversions. The analyst specifies the quantity, variability, timing, and duration of the income streams as well as the quantity and timing of the reversion and discounts each to its present value at a specified yield rate. DCF analysis can be applied with any yield capitalization technique and may be performed on either a lease-by-lease or aggregate basis.

Economic Feasibility—The ability of a project or an enterprise to meet defined investment objectives; an investment's ability to produce sufficient revenue to pay all expenses and charges and to provide a reasonable return on a recapture of the money invested. In reference to a service or residential property where revenue is not a fundamental consideration, economic soundness is based on the need for a desirability of the property for a particular purpose. An investment property is economically feasible if its prospective earning power is sufficient to pay a fair rate of return on its complete cost (including indirect costs), i.e., the estimated value at completion equals or exceeds the estimated cost. Valuexpose quantifies economic feasibility of a proposed development if the “as if complete” non-stabilized value is greater than the developments costs of production. In the case of a multi-property development (i.e. condos, lots, etc.), economic feasibility is achieved when the “as if complete” bulk value is greater than the development's cost of production.

Effective Gross Income (EGI)—The anticipated income from all operations of real property after all allowance is made for vacancy and collection losses. Effective gross income includes items constituted other income, i.e., income generated from the operation of the real property that is not derived from space rental (e.g., parking rental or income from vending machines).

Entitlement—In the context of ownership, use, and/or development of real property, the right to receive governmental approvals for annexation, zoning, utility extensions, construction permits, and occupancy/use permits. The approval period is usually finite and may require the owner and/or developer to pay impact and/or user fees in addition to other costs to secure the entitlement. Entitlements may be transferable, subject to covenants or government protocols, may constitute vested rights, and may represent an enhancement to a property's value.

Entrepreneurial Profit—1. A market-derived figure that represents the amount an entrepreneur receives for his or her contribution to a project and risk; the difference between the total cost of property (cost of development) and its market value (property value after completion), Which represents the entrepreneur's compensation for the risk and expertise associated with development. 2. In economics, the actual return on successful management practices, often identified with coordination, the fourth factor of production following land, labor, and capital; also called entrepreneurial return or entrepreneurial reward. See also entrepreneurial incentive.

Escalation Clause—A clause in an agreement that provides for the adjustment of a price or rent based on some event or index, e.g., a provision to increase rent if operating expenses increase; also called expense recovery clause.

Equity Yield Rate—A rate of return on equity capital as distinguished from the rate of return on debt capital; the equity yield rate considers the effect of debt financing on the cash flow to the equity investor.

Feasibility—An indication that a project has a reasonable likelihood of satisfying explicit objectives. See also Economic Feasibility.

Financing Costs—The cost of acquiring capital to finance a project.

Going-in Capitalization Rate—The overall capitalization rate obtained by dividing a property's net operating income for the first year after purchase by the present value of the property. See also Terminal Capitalization Rate

Going-out Capitalization Rate—See terminal capitalization rate.

Gross Rent Multiplier—(GRM) The relationship or ratio between the sale price or value of a property and its gross rental income. See also Effective gross income multiplier (EGIM); Potential gross income multiplier (PGIM).

Highest and best use—The reasonably probable and legal use of vacant land or an improved property, which is physically possible, appropriately supported, financially feasible, and that results in the highest and best use must meet are legal permissibility, physical possibility, financial feasibility, and maximum productivity.

Holding Period—The term of ownership of investment.

Inflation—An erosion of the purchasing power of currency characterized by price escalation and an increase in the volume of money, i.e., the proliferation of monetary units and consequent decline in the value of each unit. Inflation tends to increase discount rates because investors require nominal rate of return to offset the loss in value due to inflation. Investors often include an additional risk premium in the required rate of return on investments that do not respond well to unexpected inflation. See also Appreciation.

Internal Rate of Return (IRR)—The annualized yield rate or rate of return on capital that is generated or capable of being generated within an investment or portfolio over a period of ownership. The IRR is the rate of discount that makes the net present value of the investment equal to zero. The IRR discounts all returns from the investment, include returns from its reversion, to equal the original capital outlay. This rate is similar to the equity yield rate. As a measure of investment performance, the IRR is the rate of discounts that produces a profitability index of one and a net present value of zero. It may be used to measure profitability after income taxes, i.e., the after-tax equity yield rate. See also. Equity Yield Rate; Financial management Rate of Return (FMRR); Modified Internal Rate or Return (MIRR) Yield Rate.

Interest Rate—The price of money; the level of market interest carried by a debt instrument from the day it is created over the duration of its life. The rate of return or yield rate on debt capital, usually expressed as the nominal annual percentage of amount loaned or invested.

Interim use—The temporary use to which a site or improved property is put until it is ready to be put to its future highest and best use.

Land Residual technique—A method of estimating land value in which the net operating income attributable to the land is isolated and capitalized to produce and indication of the land's contribution to the total property.

Leasing Commissions—Fees paid to an agent for leasing tenant space. When leasing fees are spread over the term of a lease or lease renewal, they are treated as a variable operating expense. Initially leasing fees usually fall under capital expenditures for development and are not included among periodic expenses.

Leasing Fees—See Leasing Commissions

Leverage—The effect of borrowed funds, which may increase or decrease the return that would be realized on equity free and clear.

Loan to value ratio—The ratio between a mortgage loan and value of the property pledged as security; also called loan ratio.

Lot—1. A distinct piece of land; a piece of land that forms a part of a district, community, city block. Etc. 2. A smaller portion into which a city block or subdivision is divided; described by reference to a record plat or by definite boundaries. A piece of land in one ownership, whether platter or unplatted.

Market Area Life cycle—The objective analysis of observable and/or quantifiable data indicating discernible patters of urban growth, structure, and change that may detract from or enhance property values; focuses on four sets of considerations that influence value: social, economic, governmental, and environmental factors.

Market Value—The major focus of most real property appraisal assignments. Both economic and legal definitions of market value have been developed and refined. Continual refinement is essential to the growth of the appraisal profession.
1. The most widely accepted components of market value are incorporated in the following definition: The most probable price, as of a specified date, in cash, or in terms equivalent to cash, or in other precisely revealed terms, for which the specified property rights should sell after reasonable exposure in a competitive market under all conditions requisite to a fair sale, with the buyer and seller each acting prudently, knowledgeably, and for self-interest, and assuming the neither is under undue duress.
2. Market value is defined in the Uniform Standard of Professional Appraisal Practice (USPAP) as follows: A type of value, stated as an opinions, that presumes the transfer of a property (i.e., specific conditions set forth in the definition of the term identified by the appraiser as applicable in an appraisal. (USPAP, 2002 ed.) USPAP also requires that certain items be included in every appraisal report. Among these items, the following are directly related to the definition of market value.
   Identification of the specific property rights to be appraised.
   Statement of the effective date of the value of opinion.
   If the appraisal is conditioned upon financing or other terms, specification as to whether the financing or terms are at, below or above market interest rates and/or contain unusual conditions or incentives. The terms must be clearly set forth; their contribution to, or negative influence on, value must be described and estimated; and the market data supporting the opinion of value must be described and explained.
3. The following definition of market value is used by agencies that regulate federally insured financial institutions in the United States: the most probable price which a property should bring in a competitive and open market under all conditions requisite to a fair sale, the buyer and seller each acting prudently and knowledgeably, and assuming the price is not affected by specified date and passing of title from seller to buyer under conditions whereby:
   Buyer and seller are typically motivated;
   Both parties are well informed or well advised, and acting in wheat they consider their best interests;
   A reasonable time is allowed for exposure in the open market;
   A reasonable time is allowed for exposure in the open market. Person performing appraisal services that may be subject to litigation are cautioned to seek the exact definition of market value applicable to the jurisdiction where the services are being performed. For further discussion of this important term, see The Appraisal of Real Estate, 12th ed. (Chicago: Appraisal Institute, 2001), 21-24.

Natural or Intrinsic Value—The beginning value (sale price) and the reversion (ending sale price) of a property that would achieve the markets expected annual yield of the investment over the holding period. The annual yield expectation is compared to alternative investment of similar risks that can be found in the market place. Consequently, the going out capitalization rate or terminal rate used to capitalize the ending net operating income is the annual yield expectation. Higher or lower going out capitalization rates will push the beginning value and the reversion (ending sale price) away from the natural or intrinsic beginning and ending value. No matter how far these market values detach from the natural or intrinsic values, the annual yield between these two market values will be the same as the natural or intrinsic values. Consequently, the farther the detachment the greater the hidden risk because market values tend to gravitate toward natural or intrinsic values (equilibrium) over time.

Net operating Income (NOI)—The actual or anticipated net income that remains after all operating expenses are deducted from effective gross income, but before mortgage debt service and book depreciation are deducted; may be calculated before or after deducting replacement reserves.

Off-site Costs—Costs incurred in the development of a project, excluding actual building construction costs, e.g., the costs of streets, sidewalks, curbing, traffic signals, water and sewer mains; also called common costs or off-site improvement costs.

On-site Costs—Costs incurred for the actual construction of buildings and improvements on a particular parcel of land. See also Construction cost; direct costs.

Opportunity Cost—The lost interest cost a developer would incur by taking his money out of a safe rate financial instrument or account for development purposes.

Present Value (PV)—The value of a future payment or series of future payments discounted to the current date of to time period zero.

Price—The amount a particular purchaser agrees to pay and particular seller agrees to accept under the circumstances surrounding their transaction.

Property Type—Specific property type under one of the 13 classifications (see classifications)

Property Yield—The dollar return on the entire real property from all sources, i.e., the annual net operating income including any gain or loss in the original property investment at termination.

Prospective value Opinion—A forecast of the value expected at a specified future date. A prospective value opinion is most frequently sought in connection with real estate projects that are proposed, under construction, or under conversation to a new use. Or those that have no achieved sellout or a stabilized level of long-term occupancy at the time the appraisal report is written. See also Effective Date; Value as is.

Real Estate Taxation Appraisal—See Ad Valorem Tax.

Remodeling—A type of renovation that changes property use or configuration by changing property design.

Rent Escalation—See Escalation Clause.

Rent Loss Insurance—Insurance that protects a landlord against loss of rent or rental value due to fire or other casualty that renders the lease premises unavailable for use and as a result of which the tenant is excused from paying rent.

Replacement Cost—The estimated cost to construction, at current prices as of the effective appraisal date, a building with utility equivalent to the building being appraised, using modern materials and current standards, design, and layout.

Reservation—A clause found in legal instruments and conveyances that creates a new right or interest on behalf of the grantor. While title passes to the grantee, some use or income is reserved for the grantor. Reservations may include mineral rights, rental income, or easements.

Reversion—A lump-sum benefit that an investor receives or expects to receive at the termination of an investment; also called reversionary benefit. See also Terminal Capitalization Rate.

Risk Management—Procedure to minimize the effects of a possible financial loss by 1) Identifying potential sources of loss, 2) measuring the financial consequences of a loss occurring, and 3) using controls to minimize actual losses or their financial consequences.

Sales Commission—A fee paid to a sales-person or broker who arranges for the sale of property; generally expressed as a percentage of the sale price.

Sinking Fund—A fund in which a periodic deposits of equal amounts are accumulated to pay a debt or replace assets; usually designed to receive equal

Stabilized Occupancy—Occupancy at that point in time when abnormalities in supply and demand or any additional transitory conditions cease to exist and the existing conditions are those expected to continue over the economic life of the property; the optimum rage of long-term occupancy that an income-producing real estate project is expected to achieve under competent management after exposure for leasing in the open market for a reasonable period of time at terms and conditions comparable to competitive offering. See also Stabilized income.

Tenant—One who holds or possesses real property; commonly a person who occupies and uses the property of another under a lease, although such a person is technically a lessee, not a tenant.

Tenant Improvements—Fixed improvements to the land or structures installed and paid for by a tenant or lessee.

Terminal Capitalization Rate—The rate used to convert income, e.g., NOI, cash flow, into an indication of the anticipated value of the subject real property at the end of an actual or anticipated holding period. The terminal capitalization rate is used to estimate the resale value of the property. Also called reversionary capitalization rate or going-out capitalization rate. See also Going-in Capitalization rate.

Time Series—A statistical technique used to describe and measure the cyclical movements, random variations, seasonal variation, and secular trends observed over a period of time.

Valuation—The process of estimating the market value, insurable value, or some other property defined value of an identified or interests in a specific parcel or parcels of real estate as of a given date. Valuation is a term used interchangeably with appraisals.

Variable Expenses—Operating expenses that generally vary with the level of occupancy or the extent of services provided.

Wave Cycle—Typical stages of the fundamental market cycle (expansion, contraction, recession, and recovery) in relation to a property's equilibrium or intrinsic value.

The foregoing definitions are not intended to limit the scope of the present disclosed solution, but rather are intended to clarify terms that are well understood by persons having ordinary skill in the art. It should be appreciated that the defined terms may also have other meanings to such persons having ordinary skill in the art. These and other terms are used in the detailed description below.

In the following description, specific details are given to provide a thorough understanding of the examples. However, it may be understood by one of ordinary skill in the art that the examples may be practiced without these specific details. For example, electrical components/devices may be shown in block diagrams in order not to obscure the examples in unnecessary detail. The functionality of different blocks can be moved, combined, or re-arranged, as the different blocks are present for illustrative purposes only. In other instances, such components, other structures and techniques may be shown in detail to further explain the examples.

It is also noted that the examples may be described as a process, which is depicted as a flowchart, a flow diagram, a finite state diagram, a structure diagram, or a block diagram. Although a flowchart may describe the operations as a sequential process, many of the operations can be performed in parallel, or concurrently, and the process can be repeated. In addition, the order of the operations may be re-arranged. A process is terminated when its operations are completed. A process may correspond to a method, a function, a procedure, a subroutine, a subprogram, etc. When a process corresponds to a software function, its termination corresponds to a return of the function to the calling function or the main function.

Previous generations of real estate valuation systems tend to be designed as a “one size fits all” discounted cash flow (DCF) solution for all property types and sub-categories. Moreover, they have the following deficiencies:
The data necessary to make these solutions function may be manually populated.
They do not graphically illustrate a property's unique market economic fabric timeline and trajectory expectations.
There are no AVM (Automated Valuation Model) software systems in the marketplace that can value commercial real properties based on components of value derived from reversed engineered sales, market participant's predictions of similar properties with similar highest and best uses, physical characteristics, market economic fabrics and trajectories as the property to be valued.
There are no AVM software systems in the marketplace that can derive a property's value and graphically indicate value results as it relates to the property's specific market economic fabric and trajectory. For example, using known methods and systems, a user is unable to ascertain whether a property value has detached from the economic fabric of its specific market and entered into a bubble phenomenon.
There are no software systems in the marketplace that graphically illustrate economic feasibility for proposed developments or indicate associated values throughout the development process (timeline). For example, a user is unable to determine, using existing methods or systems, if a proposed development project is economically feasible (go or no go). This is at least a result of the current software's lack of an indication of a development's bulk/wholesale value. This value is used to determine economic feasibility in land development applications by comparing it to the development's cost of production.
Likewise, if a prospective “as if complete” value at non-stabilized occupancy is not given in known systems and methods, how is the user to know if his vertical development (commercial property) is economically feasible (prospective “as if complete value at non-stabilized occupancy may be equal or greater than the cost of production to be considered economically feasible)? In both cases, the user needs to easily know if his/her proposed project is economically feasible which means he/she will recapture the agents of production, i.e. land, labor, capital, entrepreneurial profit and give a competitive annual yield on capital invested.
There are no software systems that can place a portfolio of properties in their databases and automatically update, daily if needed, the individual property values for financial reporting requirements.
The are no software systems that can give the user, for his/her specific property, very focused components of value data and very similar comparable sales data. This comparable data is based on similar specific market types that have the same economic fabric as the user's property, as well as historic and predicted trajectories of this economic fabric.
Value does not change based on various financing scenarios or creative financing. However, there are no software systems that first value the property based on cash which produces an unleveraged (non-financed) yield to the investor. Leveraging (financing) a development or an existing property is used to simply enhance the yield on equity invested. Unlike other financial software, the disclosed methods and systems may allow users to first value property using an unleveraged model. This can derive accurate components of value. Once the components of value are established, the disclosed methods and systems allow the user to inject financing scenarios which provides an indication of equity yields, but does not change the value or component of value results from the previous unleveraged analysis. This safeguard may function to prevent fraud by preventing the user from manipulating values and components of value with creative financing.
The current valuation and financial analysis software is complicated to use, needs extensive training or classes, and is prohibitively expensive when compared to the disclosed systems.

The disclosed systems and methods provide for an automated valuation and data collection system. Some aspects prompt the user to answer easy to understand basic questions about the subject property (real property or business property) to be analyzed. Based on the user's answers, the disclosed systems create the necessary DCF's (discounted cash flow models) and other automated financial analysis. The system may then display graphically illustrated value results and other financial answers sought by the user. These displayed results are easy to understand and readily answer the financial question(s) the user is trying to solve. Although the system is highly sophisticated, a laymen with little financial training or experience can use it to answer complex financial questions.

In some aspects, the disclosed methods and systems determine whether a real estate project is economically feasible. The project may be in one of several stages when economic feasibility is determined. For example, the project may be a proposed development, partially completed, or at a non-stabilized development stage.

### Indicating Economic Feasibility

Land Development The disclosed solution will mathematically and visually indicate economic feasibility whereby the prospective bulk/wholesale market value indication may be greater than or equal to the calculated cost of production.

Vertical Development The disclosed solution will mathematically and visually indicate economic feasibility whereby the prospective “as if complete market value at non-stabilized occupancy” may be equal or greater than the cost of production.

The value a developer is creating represents the prospective bulk/wholesale market value (land development) or the prospective “as if complete,” market value at non-stabilized occupancy (Vertical development projects, i.e. commercial buildings).

This development product is what he is delivering to the marketplace in the future based on the development timeline. If these values (bulk/wholesale or “as if complete” market value at non-stabilized occupancy) are equal or greater to their cost of production than agents of production are recaptured when sold. This means the developer is being “paid back” all of his investment (land purchase, labor, capital and entrepreneurial profit). Included in this payback is a yield or risk race on capital invested based on the risk of the development when compared to alternative similar investments. Also the developer is being paid for his entrepreneurial effort for coordinating all the agents of production by way of an entrepreneurial profit or developer's profit. He is also being paid back the contractors profit (whether he was the contractor or whether he hired the contractor/builder) and is being paid back the value of the land when its highest and best use ready for immediate development (start of the entitlement process).

Consequently, the disclosed solution answers the following specific questions for development properties,
a. The “as is” market value of the land when it is ready for immediate development (ready to start the entitlement process).
b. Indicates the prospective “as if entitled” market value of the land “as if entitled”.
c. Indicates the prospective bulk/wholesale market value of the land development product when it is introduced in the market place. In the case of vertical development (commercial buildings), the disclosed solution indicates the prospective “as if complete” market value at non-stabilized occupancy. In both cases, the disclosed solution also graphically shows the cost of production (costs up to bulk/whole market value or “as if complete” market value at non-stabilized occupancy) to see if economic feasibility is achieved (bulk/wholesale market value or “as if complete” market value at non-stabilized occupancy may be equal or greater than the cost of production to be economic feasible).
d. After values along the development timeline are indicated using cash, the user may be allowed to introduce various financing scenarios. The financial scenarios will not change the cash values but will indicate how it will affect the equity yield (financed) as opposed to the property yield (non-financed).
B. If the land is NOT ready for immediate development (When Cost of Production is greater than the bulk/wholesale or the Cost of Production is greater then the “as if complete” value at non-stabilized occupancy).
   1. If the development proves to be infeasible to start the development process, the disclosed solution will allow the user to automatically add a holding period to extend the development timeline. This strategy will deliver the proposed development product later to the market place when the expectation of greater price points (sale prices) and absorption (selling pace) of the development product are higher and faster.
      If economic feasibility can be achieved in the future, as a result of adding a holding period to the development timeline, the disclosed solution will recalculate the “as is” value of the land (when not economically feasible to start the development process) as well as the prospective “as is” value of the land when it is ready for immediate development.
   2. After values along the development timeline (with holding) are indicated using cash, the user may be allowed to introduce various financing scenarios. The financial scenarios will not change the cash values but will indicate how it will affect the equity yield (equity portion not financed) as opposed to the property yield (all cash non-financed).
C. Existing developed properties and how their values relate to their specific markets economic fabric.
   1. All specific properties have a specific market for its product type and are based on the property user's ability to produce business income from the type of companies that use this type of product. In the case of residential property types, the market that uses this type of product generates personal income from employment or business income. Property user's business or personal income defines the economic fabric of each particular market and the expectation as to the future behavior of the economic fabric (whether it gets stronger, weaker or stays the same). Consequently, there is a relationship between the specific market's economic fabric and the value of property types within the specific market (business or personal income's economic fabric equates into ability to pay rent that equates value of the property). When supply and demand are in balance and expectations in the market place are in sync with how the economic fabric is expected to behave in the future, property values will generally follow the economic fabric path.
      On the other hand, if supply and demand, as well as predictions about property rentals and future property appreciation, fall out of sync with its market economic fabric, property values may begin to significantly detach from the economic fabric path. This detachment creates bubbles and added risk that is otherwise hard to detect until it is too late and values collapse.
D. Reverse Engineered Sale Prices
   1. Existing known sale prices for specific properties can be reversed engineered by testing a variety of components of value until the present value indicates the known sale price. Market participants (buyers, sellers, lenders, bank examiners, bond rating companies, etc.) can now assess the risk of the sale price by evaluating if the components of value or the bets that make up the value (sale price) are reasonably probable and can be achieved in the future. This known sale price can be superimposed on the property's economic fabric path for its specific market to evaluate risk.
E. Existing properties whereby the value is not known.
   1. Users of this disclosed solution can manually or have the disclosed solution automatically derive a market value for a specific property. If the user chooses to manually evaluate the property's value, he can input his expectations of the future benefits the property will generate in the future.
      Alternatively, if chosen, the disclosed solution will automatically estimate the value of the property by applying components of value harvested from similar markets that are expected to behave in similar manner as the subject property's specific market. This harvested data may be from reversed engineered sales and market participant's expectations for similar properties in similar markets.
      In both cases (manual value or automatic value) the indicated value may be superimposed onto the economic fabric path for the property's specific market.
F. Components of value that are harvested from actual sales of specific property types in specific markets.
   1. Reversed engineered actual sales of specific properties, subtypes, and market types may be harvested and retained in databases. This data will he used to evaluate similar properties in similar markets where the subject property's value is unknown. The selection and weight given components of value harvested in similar markets as the subject may be based on trajectory of the economic fabric path from where the components of value were taken. If the trajectory of the economic fabric path is significantly angled upward, the market participants are expecting tenant income to significantly increase or a more successful type of tenant is expected to penetrate the market (i.e. national tenants).
G. Components of value that are harvested from market participants predictions for specific property types in specific markets.
   1. Blending components of value from reversed engineered sales together with current expectations from market participants that are imputing their predictions for a particular property type and market may be harvested and applied to similar properties with unknown values.
H. Financial Reporting Feature
   1. Frank-Dodd financial reform requires banks and publicly traded companies to regularly mark-to-market portfolios of properties as to their current market value. These portfolios of properties can be listed on the disclosed solution's application whereby components of value of similar type properties and markets can be regularly applied to the properties in an effort to update and evaluate each properties current value.
I. Comparable Sale Feature
   1. Once a specific property is identified and placed within a specific market, similar comparable sales within similar specific markets with similar economic fabrics and trajectories can be indicated on the subject's economic fabric graph timeline.

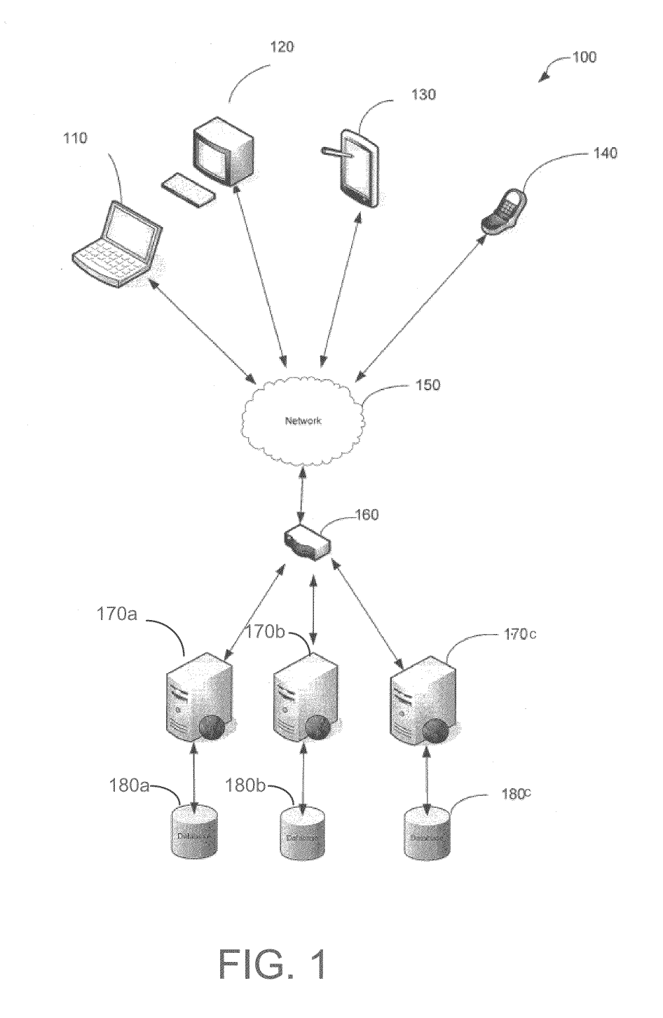

FIG. 1 is a block diagram of a network topology that includes an implementation of the disclosed methods and systems. The illustrated web application system 100 operates with a plurality of computers coupled together on a network such as the Internet 150, or any other communications network. FIG. 1 depicts a network that includes user computers 110, 120, 130, and 140 that communicate with one or more web servers 170a-c though communication links that include the Internet 150. The user computers 110, 120, 130, and 140 may be any type of computing device that allows a user to interactively browse websites, such as a personal computer (PC) that includes a web browser (e.g., Microsoft Internet Explorer or Google Chrome). Suitable user computers equipped with browsers are available in many configurations, including laptop (e.g. user computer 110), desktop computers (e.g. user computer 120), and handheld devices (e.g. user computer 130 and/or 140).

The one or more web servers 170a-c may be optionally managed by a load balancer 160. Load balancer 160 may receive requests from computer network 150 and route these requests to one or more web servers 170a-c based on a variety of criteria. These criteria may optionally include the current load of each web server 170a-c, session information included in the network request, a round robin counter maintained by load balancer 160, or other criteria.

One or more web servers may also communicate with one or more databases 180a-c. These databases may be in a mirrored or striped configuration to support the data storage requirements of web applications running on web server(s) 170a-c.

The web server(s) 170a-c include a server computer running a web interface application and capable of selectively delivering data files, such as HTML files, to the user computers using a protocol such as HTTP. Web server(s) 170a-c may also dynamically generate content for delivery to user computers in response to a request from a user computer. The content may be generated by web server 170a-c directly, or may be generated by other computers linked to web server 170a-c in response to a request from web server(s) 170a-c. Web server(s) 170a-c may then forward the requested content to a user computer over network 150. In some aspects, one or more portions of a user interface may be generated by the web server(s) 170a-c. For example, in some aspects, a graphic may be generated (for example, a .jpeg or .gif file) by the web server (s) 170a-c and transmitted for display on the user computer(s).

In other aspects, parameters defining the graphic may be transmitted to the user computer(s), by the web server(s) 170a-c, and the user computers may generate the graphic to be displayed on an electronic display connected to the user computer(s). For example, in some aspects, the web server(s) may transmit one or more browser plug-in files to the user computer(s) to support display functions, such as graphic generation, on the user computer(s). The web server(s) 170a-c may then transmit input parameters for the browser plug-ins, with the browser plug ins presenting the graphics based on the input parameters on a display of the user computer. In some aspects, one or more browser plug-ins may already be installed on the user computer(s) and may not need to be transmitted by the web server(s) to the user computer(s).

In addition to presenting a user interface capable of being viewed on a browser as described above, web server 170 may also expose a web services interface on network 150. In some aspects, the web services interface may use a SOAP or REST interface to provide the web services. Such interfaces may provide an ability for other network based programs to interface with the methods and systems provided by web server 170.

Web server applications may be coded in various programming languages, such as Java, Perl, C#, C, or C++, and are customized to run on their respective server(s) 170a-c. Web server(s) 170a-c may also include applications utilizing a variety of specialized application languages such as Microsoft® Silverlight®, or Adobe® Flash® to implement user interfaces displayed on the user computers. These specialized applications may be integrated with files or dynamic content provided by Web server 170 to the user computers in response to a request from those user computers.

Web server applications, such as those running on web server(s) 170a-c, also typically interface with a database application, such as a SQL Server engine from Microsoft Corporation, Oracle database engine, or MySQL as part of their architecture. These database applications may control or manage database servers 180a-c illustrated in FIG. 1.

Web applications running on web server(s) 170a-c may access a database of web pages, distributable applications, and other electronic files containing information of various types. Web pages or other electronic files may be viewed on the displays of the user computers by a suitable application program residing on a user computer, such as a browser, or by a distributable application provided to a user computer by the web server 170. It should be appreciated that many different user computers, many different web servers, and many different application servers of various types may be communicating with each other at the same time.

The present disclosed solution allows a user to obtain valuation information on one or more real estate projects. In some aspects, web pages are generally requested by communicating an HTTP request from a browser application. The HTTP request includes the Uniform Resource Locator (URL) of the desired web page, which may correspond to a web page stored at a destination web site, such as web server 170. The HTTP request is routed to the web server 170 via the Internet 150. The web server 170 then retrieves the requested web page, identified by a URL, from database 180 and communicates the web page across the Internet 150 to the browser application running on user computers 110, 120, 130, or 140. The web page may be communicated in the form of plural message packets as defined by standard protocols, such as the Transport Control Protocol/Internet Protocol (TCP/IP), although it should be appreciated that communication using other protocols would be within the scope of the disclosed solution.

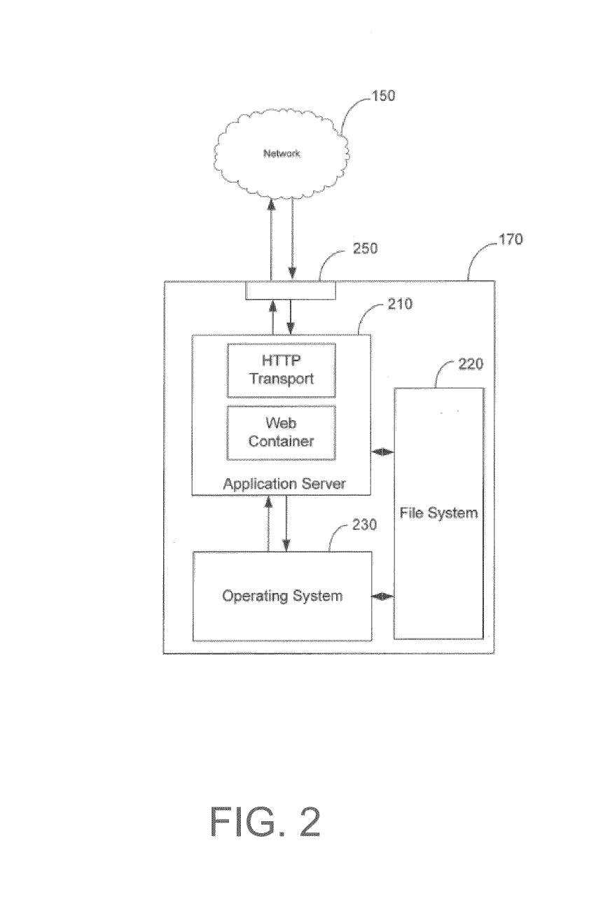

FIG. 2A is a simplified block diagram illustrating the internal software architecture of one embodiment of a web server 170. Web server 170 may be implemented using one of several standard hardware web server platforms including general purpose computers or specialized web server computers from any one of a number of manufacturers to include Hewlett Packard, Apple, Dell, IBM, or the like. These web server hardware platforms may run any one of a number of operating systems 230 to include Microsoft Windows Server, Linux, or several other versions of Unix. Web Server 170 may also be virtualized within a server virtualization system using programs such as VMWare to enable multiple web servers or other applications to operate on one individual computer.

Running on these hardware and operating system web server platforms may be software applications including what is known in the art as an application server 210. Applications servers may include Apache Tomcat, WebSphere, or Jboss. Simplified web application architectures may also be used, to include http servers such as an Apache http server running cgi scripts, or open source applications such as Drupal or Jumla.

As illustrated in FIG. 2A, Application Server 210 running on web server 170 interacts via a network port 250 with a network 150. Application server 210 may receive requests from the network 150 generated by user computers of FIG. 1 over network port 250. Within Application server 210 may be a web container containing one or more web application programs as described above. These applications may respond to the network requests generated by user computers present web content back to user computers over network 150. These application programs may include instructions that configure a processor running in web server 170 to perform the methods of one or more operative embodiments described herein.

Web server 170 also includes a file system 220. Application server 220 may read and write data to file system 220 in order to respond to requests from user computers over network 150. File system 220 may store static files including html files that define one or more aspects of a user interface provided by Application Server 210 to user computers over network 150. File system 220 may also store instructions of the web applications described above that cause the processor running in web server 170 to perform the method of one or more of the operative embodiments described in this application. In some aspects, the file system 220 may not be physically part of the web server 170, but may be a separate component, and may in some aspects be accessed by the web server 170 via a network.

While a web based architecture is contemplated for one aspect of the disclosed methods and systems, Applicant further contemplates that the solution described herein may be implemented using other delivery architectures and is not limited to a web based architecture. For example, one aspect of the disclosed solution may be a computer application that runs on a computer that includes a display interface. This computer may also include a directly connected keyboard and/or pointing device such as a mouse. In these aspects, the disclosed methods and systems may receive input directly from the attached keyboard and/or pointing device and present the various user interfaces described herein directly on a locally connected electronic display of the computer. Some contemplated architectures may mix a web-based architecture as described above with some local functions. For example, the system may be implemented to include a local application that still communicates with web servers for certain functions, such as accessing comparable databases, while handling certain operations locally (for example, user interface functions).

Current financial feasibility methodologies supported by The Appraisal Institute and CCIM (certified commercial investment member) are 1) net present value technique 2) whether or not the development's cost of production is less than the development's “as if Complete” stabilized market value (in the case of a single property development) or “as if complete” bulk/wholesale market value (in the case of a multiple property development).

The net present value technique (NPV) uses a discounted cash flow model used to measure investment performance. This method uses the initial potential dollar investment along with the minimum acceptable rate of return for the investor. If there is a surplus of NPV (positive numbers) above zero, the investment may be considered financially feasible to pursue. If the NPV is below zero (a negative number) the investment may be considered not financially feasible. NPV techniques require the user to provide the starting investment amount. These methods do not indicate other values along the development timeline such as “as if complete” value at non-stabilized occupancy; “as if complete” bulk wholesale value; “as if entitled” value of the land; “as if complete” at stabilized occupancy; and the “as is” market value of the land based on the land's highest and best use.

The second financial feasibility method simply starts with a proposed development's “as if complete” value at stabilized occupancy (single property rental development, office bldgs, etc.) or the aggregate retail (multiple units to be sold to multiple users-condos, etc.). If these two values, in each development scenario, equal or exceed all costs of production (COP), including entrepreneurial profit, then the development may be deemed financially feasible. This technique does not generally rely on present value analysis and does not define how the COP is determined. Therefore, particular details vary depending on the individuals employing the techniques. For example, should the cost of production include an opportunity cost? How is an initial rental income during the leasing phase to stabilized occupancy handled when the cost of production is determined? When determining a cost of production, should a price paid for the land be used or should the indicated value of the land based on its highest and best use be used instead? How should the cost of production be adjusted for the time value of money?

Therefore, these current financial feasibility methodologies being used today contribute to confusion due to the lack of standardization and are subject to fraud via incompetence or deceit.

Methods and systems disclosed provide for the display of at least three different timeline graphics that enable a user to determine financial feasibility and related property values for a proposed development. Each of the three timeline graphics is a collection of discounted cash flow models that are solving for value creation waypoints via the economics of the development process. The three displayed development timelines will accommodate single property rental developments (i.e. office, residential, etc.) or multiple units to be sold to multiple users (condos, lots, etc.). These three timeline graphics accommodate development properties that 1) need an entitlement period before construction can start, 2) a development that does not need an entitlement period before it can start construction, 3) existing partially built properties or existing properties that need major remodeling.

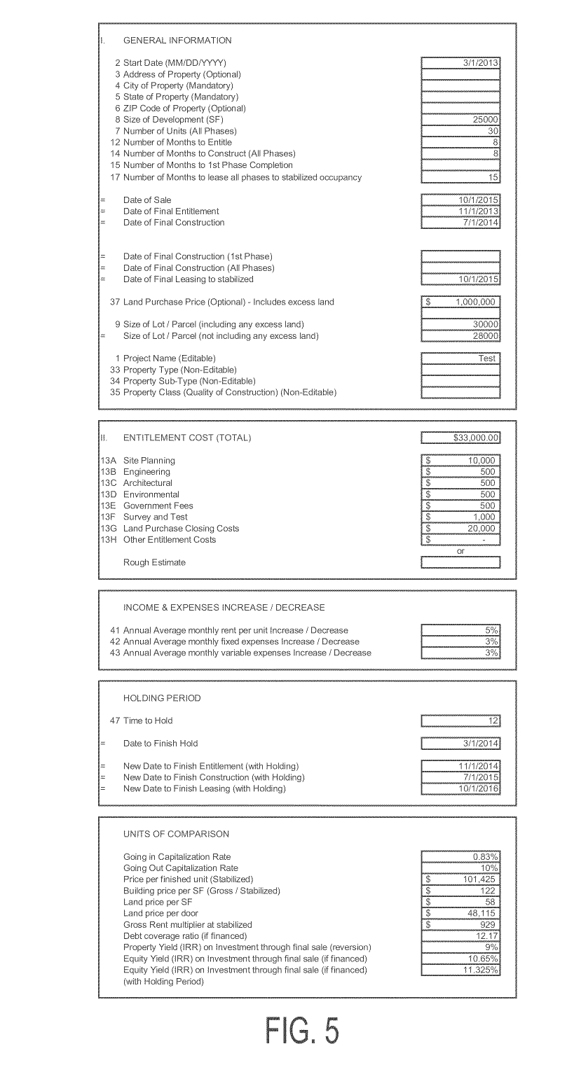

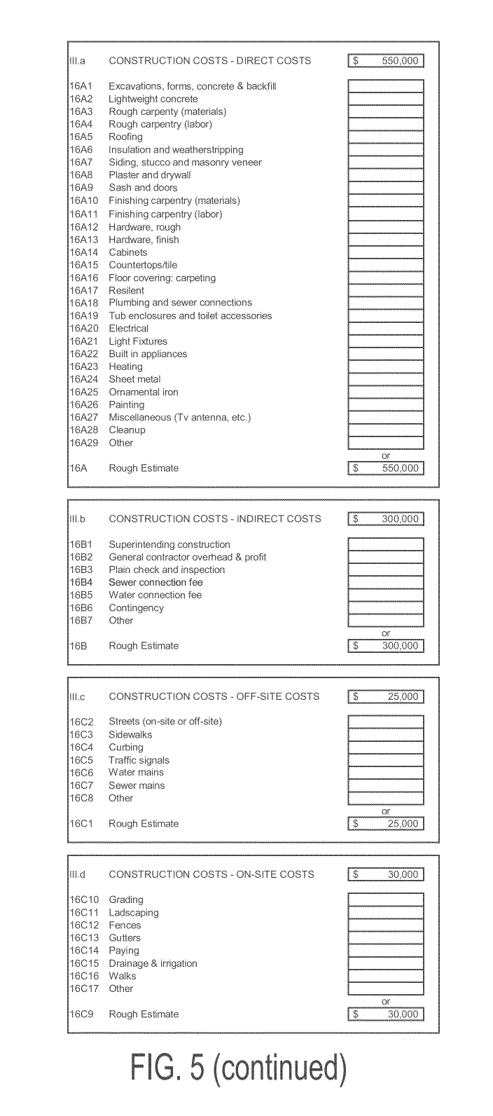

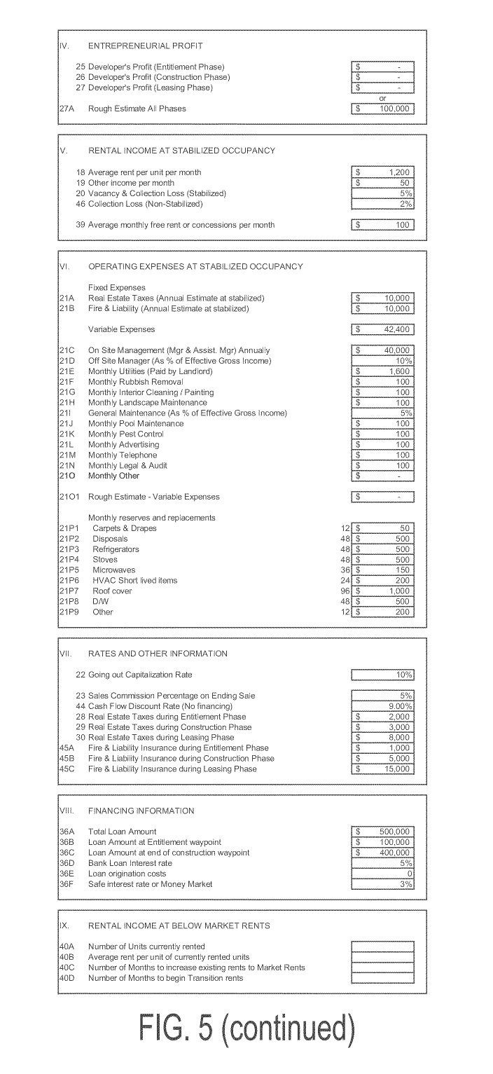

FIG. 2B is a data flow diagram of one aspect of the disclosed methods and systems. In block 252, project attributes are obtained. The methods and systems disclosed display a menu or decision tree of initial questions corresponding to the user's development scenario. The user may select a property classification (for example, i.e. office, retail, industrial, residential, etc.), select a property type within the selected classification (example—retail classification, shopping center type) and then may select one of the three development timelines depending on the development scenario. The user's selections may be filtered by one or more criteria, and then appropriate wizard questions for the proposed development may be presented to the user on a display. This is shown in block 254 of data flow 250. Once the user answers the wizard questions, components of value are derived for the property based on the answers to the wizard questions. This is shown in data flow 250 in block 256. Examples of components of value are discussed below with respect to FIG. 5. The components of value (COV) are used to populate the appropriate discounted cash flow models (DCF's). The DCF's shown in block 258 solve for the particular value waypoints during the proposed development timing expectation. These values are graphically displayed on the appropriate timeline graphic shown in block 260 and the answers populating the COV boxes may be graphically displayed underneath the timeline. The cost of production (COP) may be displayed above the timeline, in some aspects over the “as if complete” value at non-stabilized occupancy (in the case of a single property development) or the “as if complete” value of bulk/wholesale (multiple use development to sold to multiple users).

The cost of production (COP) is determined using all the agents of production (land, labor, capital and entrepreneurial profit) up to the point when the finished product is delivered into the marketplace (“as if complete” of a property to lease at non-stabilized occupancy; and the “as if complete” of a multi-unit property before the first unit is sold). The cost of production may not account for any financing costs but may consider opportunity cost based on an interest rate as equity (cash) is invested into the development.

In some aspects, the cost of production is compared to the “as if complete” value positioned, in some aspects, below the COP value. If the “as if complete” value is greater than the COP, the development may be considered financially feasible and the timeline will boldly indicate this result in a content box above the COP value. In some aspects, color may also be used to indicate financial feasibility. For example, when the project is financially feasible, the indication may be in green. If the COP is greater than the “as if complete” value directly below the COP value, the invention will indicate the proposed development is financially infeasible. A red content box on the timeline graphic will boldly indicate this result.

Comparing the COP to the “as if complete” non-stabilized or “as if complete” bulk/wholesale value is based on the premise that value is created when the “as if complete” property is first placed in the marketplace, not after it is leased to stabilized occupancy or the units for sale are 100% sold out indicating the aggregate retail sale price accumulation. Intrinsic in the “as if complete” value at non-stabilized or “as if complete” bulk/wholesale value is the time and expense it took to lease up to stabilized occupancy or to sell out all units for sale (aggregate retail). The value of the annuity (either positive or negative) regarding the lease-up period or the sell-out period is also intrinsic in the “as if complete” value at non-stabilized occupancy or “as if complete” bulk/wholesale value (before the first unit is sold). Consequently, if the COP value is higher than the corresponding “as if complete” value, this indicates enough value has been created to recapture (repay) the agents of production (land, labor, capital and entrepreneurial profit).

The land value that makes up part of the COP is based on the property's highest and best use. This is used in determining financial feasibility because a developer's purchase price or cost basis used in the COP can be misleading and result in a false indication that proposed project is financial feasible. Current methodologies in solving for financial feasibility (net present value or comparing stabilized COP value to the “as if complete” stabilized value or the aggregate retail) do not consider this step. As the developer obtains more and more accurate information regarding his proposed development through due diligence, there is no trigger in the current methodologies to re-analyze how these changes impact the “as is” value of the property based on the land's revised highest and best use.

In some aspects, the DCF's are recalculated in response to any changes in input data provided by a user. This is shown by arrow 262 in data flow 250. This may result in additional updated to the associated timeline graphic and related values when the answers are changed in the COV boxes associated with the timeline graphic. These changes may instantly update the property's highest and best use; the “as is” value of the property; the updated COP; and further indicate whether or not the development changes still keeps the project financially feasible.

If a proposed development is indicated to be financially feasible, any difference between the COP and the corresponding “as if complete” values may be added to the entrepreneurial profit expectation and may show this result in COV boxes that may be entitled “units of comparison.”

Once financial feasibility is found for a proposed development, the user can insert his own “as is” value of the land/property that might represent his sale price, listing price, or whatever he thinks he can buy the property for. The user may insert an “as is” value onto the timeline and test the financial feasibility in two ways. First, a user's value may be inserted just below the “as is” value derived based on the property's highest and best use. The user's “as is” value may then be substituted into the COP to test if financial feasibility is still present. In some other aspects, an “as is” value specified by a user is substituted for the derived “as is” value, and the lease rate (in the case of a single property that will be leased) or the price point of the average unit sale price (in the case of a multi units to be sold to multiple users) is iterated until the present value of the DCF model reaches the user's inputted “as is” value. This indicates that if the highest and best use of the property's “as is” value represents the user's inputted “as is” value, the revised iterated lease rates or price points must be achieved.

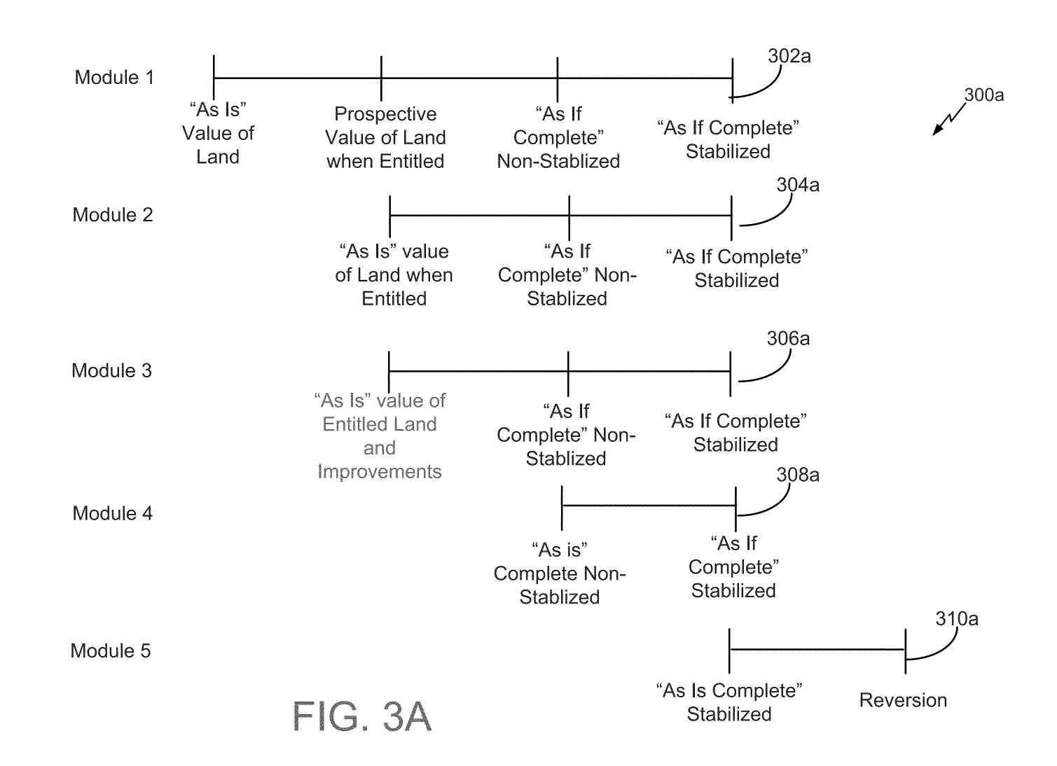

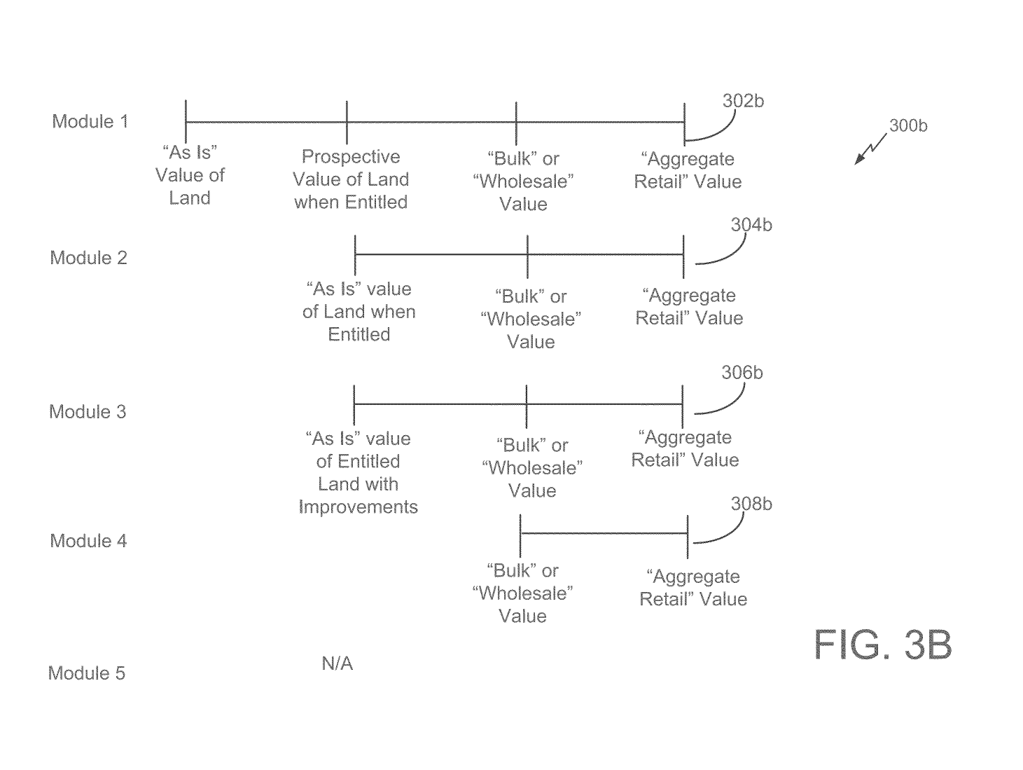

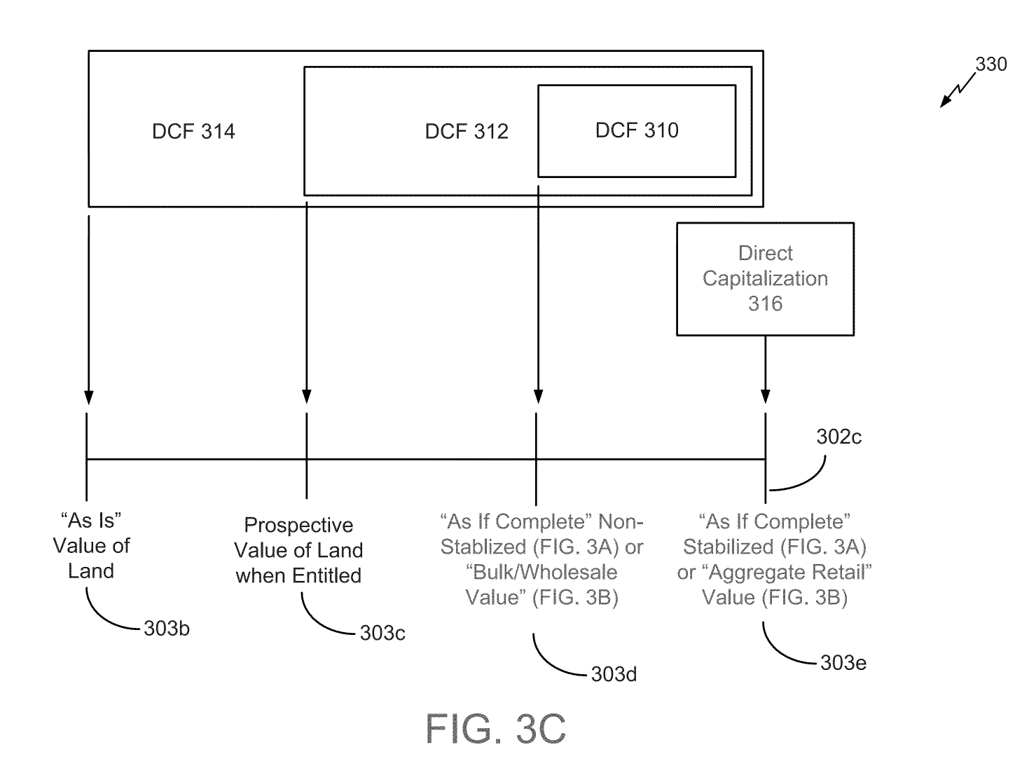

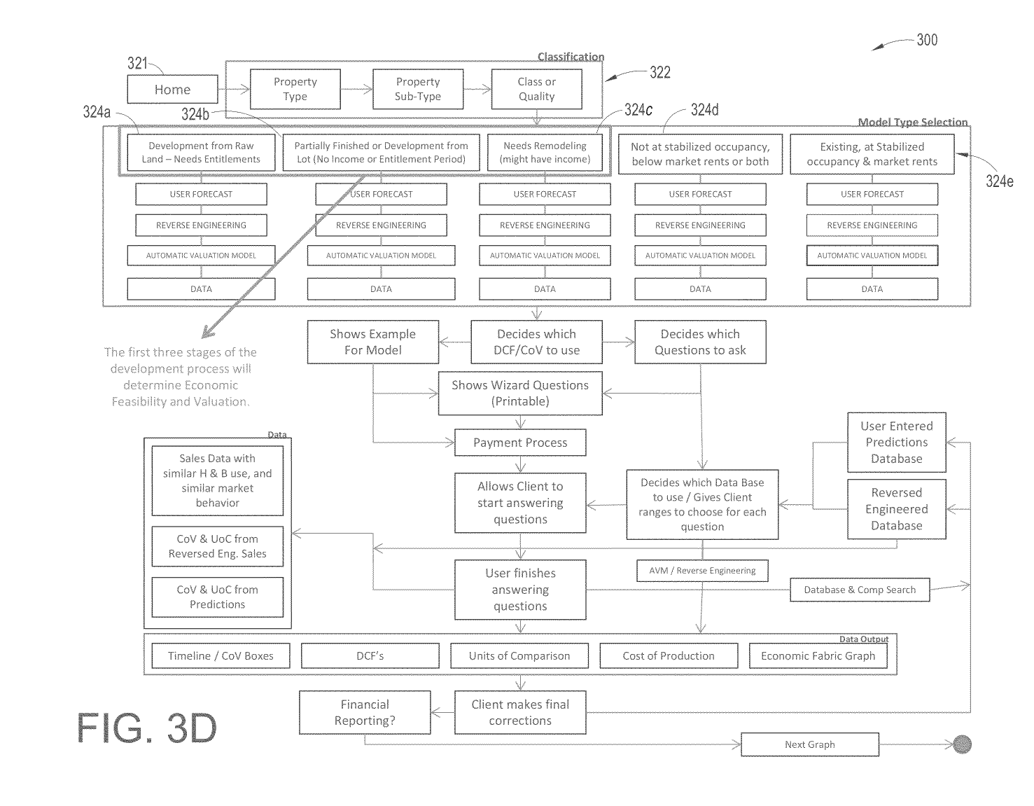

FIG. 3A illustrates an exemplary organization for five timelines that may be presented on a display. In some aspects, each of the timelines may be presented on a display by a different software or electronic module implementing the disclosed methods and systems. Each of the timelines of FIG. 3A are applicable to the valuation of properties that may be held during a leasing period where rents are collected on the property. Each of the five timelines is associated with one of five modules of the disclosed methods and systems. The first timeline 302a is generated by module 1, and shows values for a subject property that will be developed from raw land and needs entitlement. Thus, the current “as is” value at the far left of the timeline represents a value of the land, before being entitled. The next value represents the value of the land after entitlement. The following value represents the value of the subject property after development is complete, but before market rents for all units has been established and are stabilized. The next value represents the value of the property after stabilized operating conditions have been achieved.

The timeline 304a is generated by module 2, and facilitates valuation modeling of a property with entitled property. Timeline 304a shares many values with timeline 302, except there is no value of unentitled land presented in the timeline 304 since the land is already entitled. Timeline 306a is generated by module 3, and facilitates valuation modeling of a property that needs remodeling. Timeline 306a appears similar to timeline 304a, but module 3 may generate a different set of wizard questions compared to module 2 which generates timeline 304a. For example, because module 3 is focused on properties that need remodeling, the wizard questions used to populate data upon which the timeline 306a is based may be different when compared to wizard questions used to populate the timeline 304a by module 2.

The timeline 308a is generated by module 4 and facilitates valuation modeling of a property that has been developed, but is not at stabilized rents. Thus, the furthest left “as is” value reflects a property that is complete but does not have stabilized operating conditions. No value of entitled land is provided by this module, since development has already been completed. The timeline 310a is generated by module 5, and facilitates valuation modeling of a property that has reached stabilized operating conditions.

FIG. 3B illustrates an exemplary organization for four timelines that may be presented on a display. In some aspects, each of the timelines may be presented on a display by a different software or electronic module implementing the disclosed methods and systems Each of the timelines of FIG. 3B are applicable to the valuation of properties that may be sold off over time unit by unit. For example, the timelines of FIG. 3B may be used by developers of condominium projects, or a developer of single family homes. Each of the four timelines is associated with one of four modules of the disclosed methods and systems. The first timeline 302b is generated by module 1, as was timeline 302a of FIG. 3A. Contrasting timeline 302b with 302a reveals that the “as if complete” non-stabilized value has been replaced with a bulk/wholesale” value. Similarly, the “as if complete” at stabilized value of timeline 302a has been replaced with an “aggregate retail” value in timeline 302b. These changes tailor the timeline 302b for a real estate developer not engaged in leasing properties, but instead is focused only on constructing properties and selling them after development is finished, leaving the leasing portion of the property's life cycle to other parties. Timelines 304b, 306b, and 308b has been modified in a similar manner relative to timelines 304a, 306a, and 308a respectively. There is no equivalent of timeline 310a in FIG. 3B, because timeline 310a is focused on modeling the leasing phase of a property, whereas the timelines of FIG. 3B are focused on, as discussed above, a developer who does not intend to lease properties. Each of the timelines presented in FIGS. 3A and 3B may be generated based on one or more data fields specific to the each timeline. These data fields may be determined, in some aspects, based on answers to wizard questions presented to users on a display, as discussed further below. In some other aspects, the data values may be determined based on a data import process. For example, the methods and systems may determine the data values necessary to generate each of the timelines of FIGS. 3A-B via data received from a file, or other data importing process.

FIG. 3C illustrates an example timeline 330 with discounted cash flows overlaid. While FIG. 3C shows a timeline 302c, which corresponds in format to timeline 302a of FIG. 3A, the concepts presented with respect to FIG. 3C may be generally applied to each of the timelines presented in FIGS. 3A-B.

The timeline 302c shows an “as is” value of land 303b, a prospective value of land when entitled 303c, and an “as if Complete” at non-stabilized occupancy value 303d. The “As If Complete” Stabilized value 303e shown in FIG. 3C may be generated based on a direct capitalization 316 of net operating income of the subject property based on an outgoing capitalization rate. In embodiments shown in FIG. 3B, the corresponding “Aggregate/retail” value may be obtained based on aggregating the price points for each unit sold.

Discounted cash flow 310 may generate the “as if complete” non-stabilized value 303d. Based on the value 302d, discounted cash flow 312 may generate the prospective value of land when entitled value 303c. Based on the value 303c, discounted cash flow 324 may determine the “as is” value of land 303b. The other timelines 304a-b, 306a-b, and 308a-b shown in FIG. 3A-B operate in a similar manner. These timelines may not utilize discounted cash flow 324, since they do not present an “as is” value of the land without entitlements 303b, since these timelines are applied to projects that already have entitlements. Timelines 306a-b may not utilize discounted cash flow 312, since timelines 306a-b does not include a value of land when entitled 303c. Timelines 308a-b may not utilize discounted cash flow 310 since they do not include an “as if complete” non-stabilized value (or in the case of timeline 308b a bulk/wholesale value) such as 303d. FIG. 3C also shows that a direct capitalization process 316 may be used to obtain a revision value 303f based on income information associated with the real estate project valued in timeline 302c.

FIG. 3D illustrates an example user interface map of a system for computer assisting valuation modeling. The map 300 illustrates that from a home page 311, a user may first select a property classification parameters 312. Classification parameters 312 may include a property type, sub-type, class/quality. In some aspects, one or more wizard questions are presented on the user interface based on the classification parameters 312.

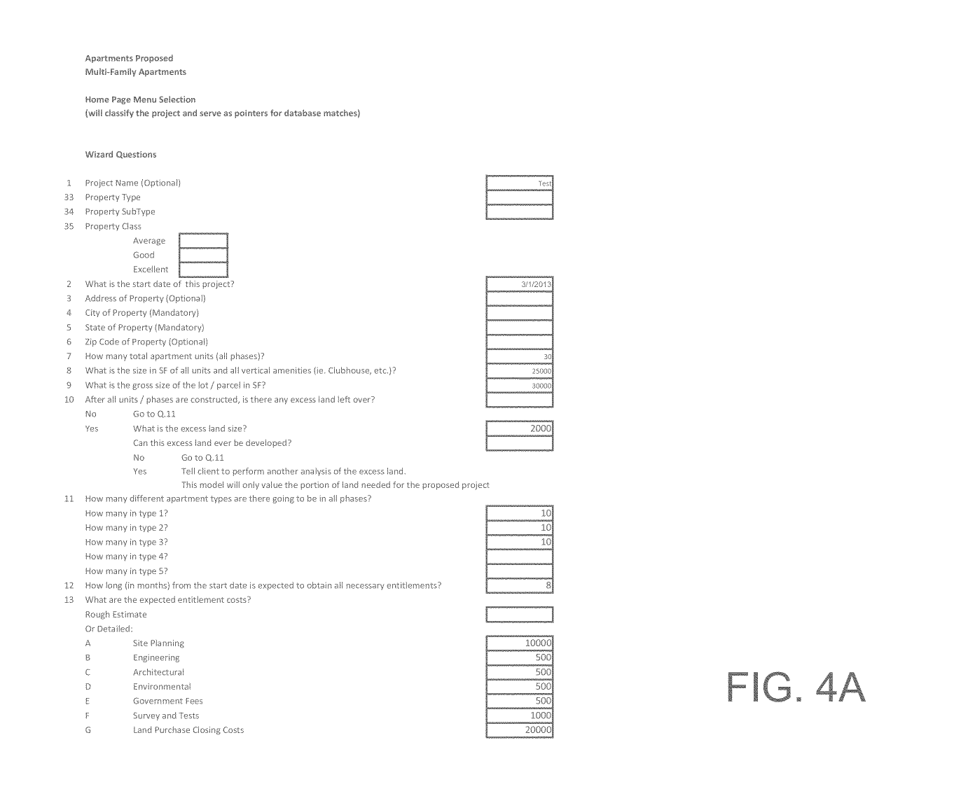

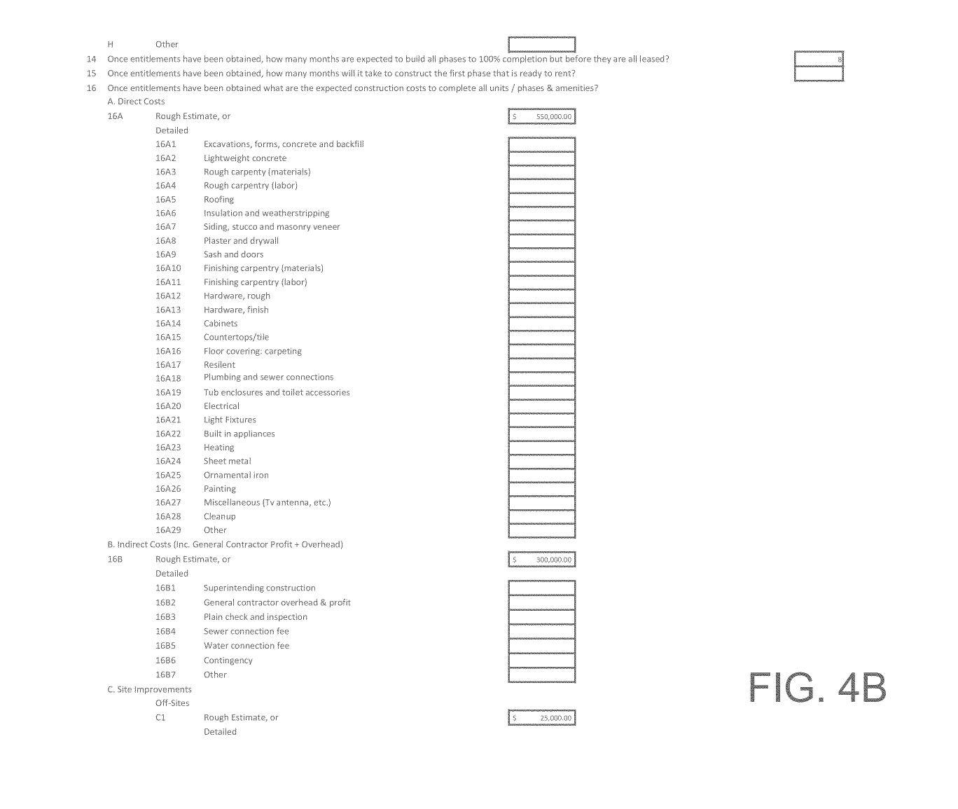

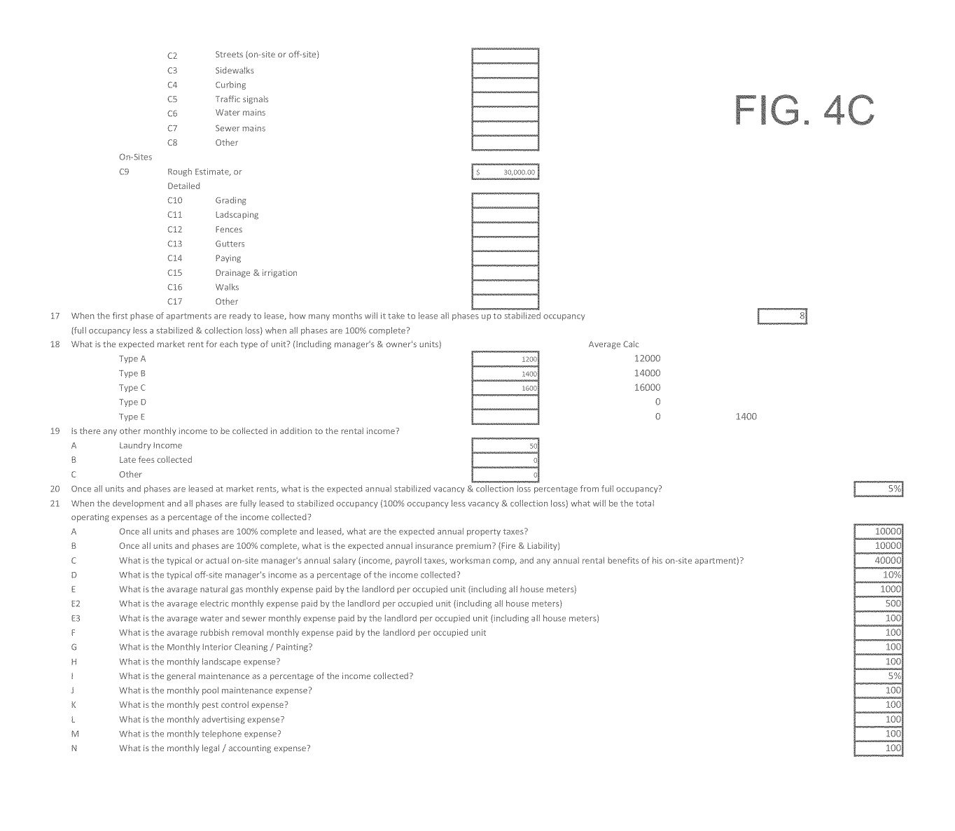

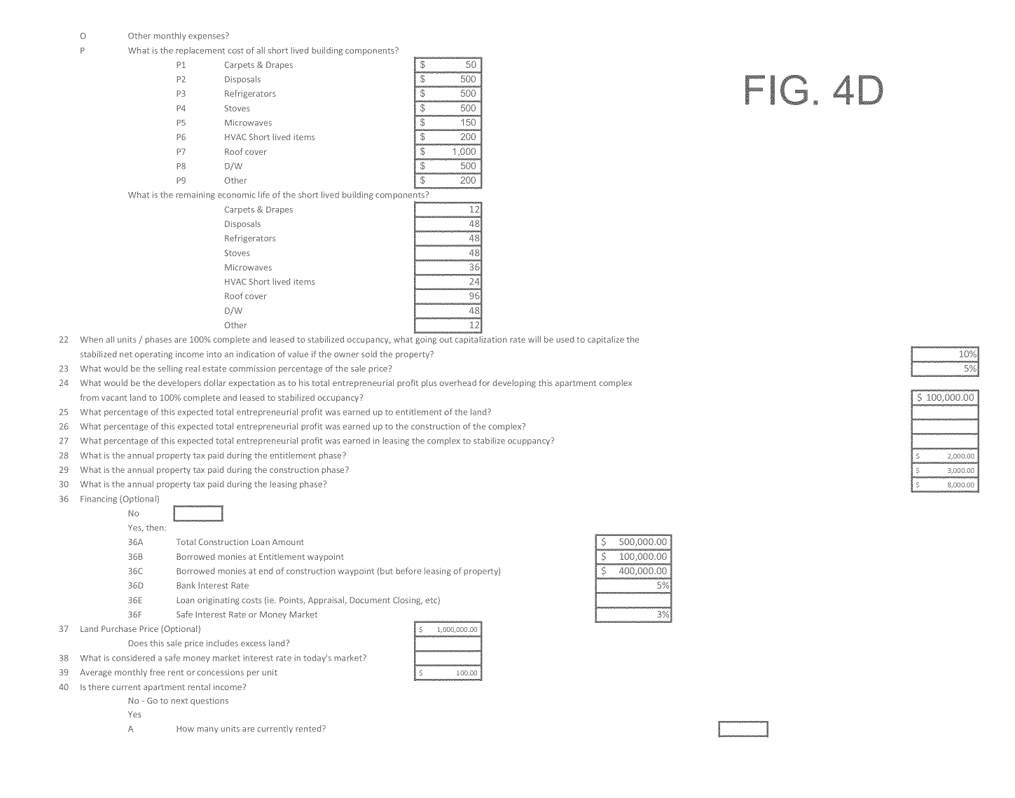

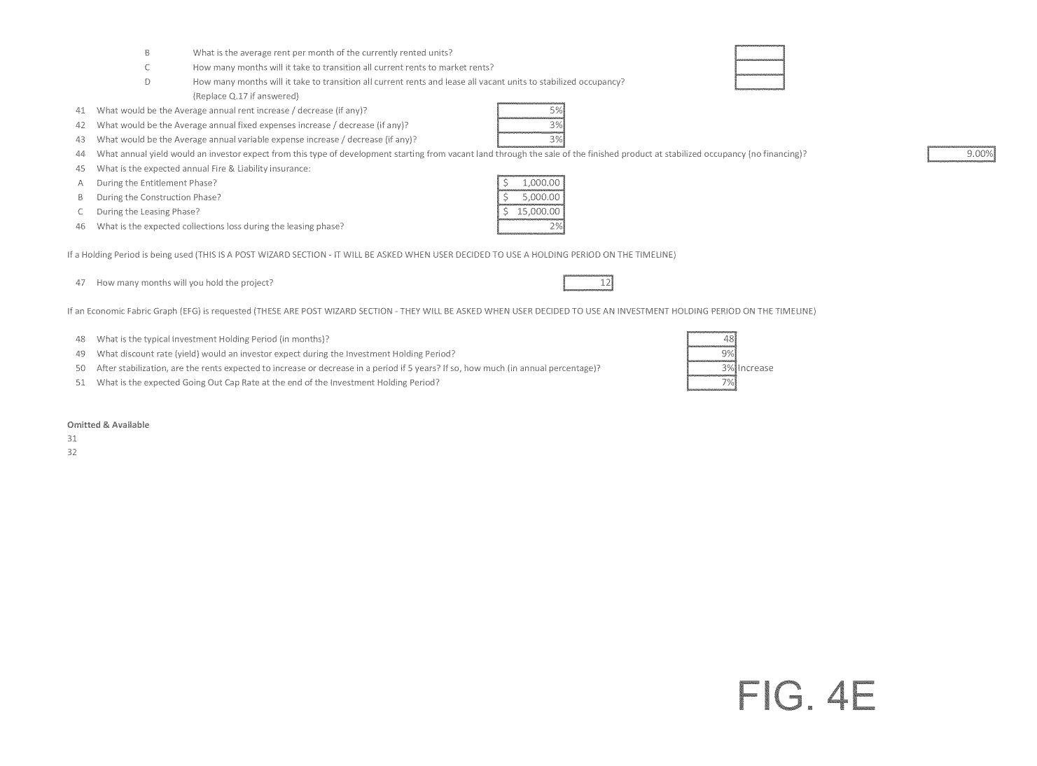

FIGS. 4A-E illustrate one example of wizard questions displayed to a user when a project type is a multi-family apartment development. The wizard questions shown in FIG. 4A-E may be prepopulated with default values in some aspects, or may retain values from a previously entered project in some aspects. After the wizard questions have been answered, or the user selects a user interface control that indicates answers to the wizard questions are complete, the answers to the wizard questions are used to determine “components of value” of the real estate project.

FIG. 5 illustrates one example of a screen displaying components of value resulting from answers to the wizard questions of FIGS. 4A-E. The wizard questions shown in FIGS. 4A-E are numbered and inserted in the component of value boxes (COV) with corresponding numbers. For example, wizard question 41 “Average annual rent increase/decrease,” shown in FIG. 4E, populates component of value box 41, shown in FIG. 5. The COV boxes of FIG. 5 are numbered and are inserted into corresponding discounted cash flows (DCF).

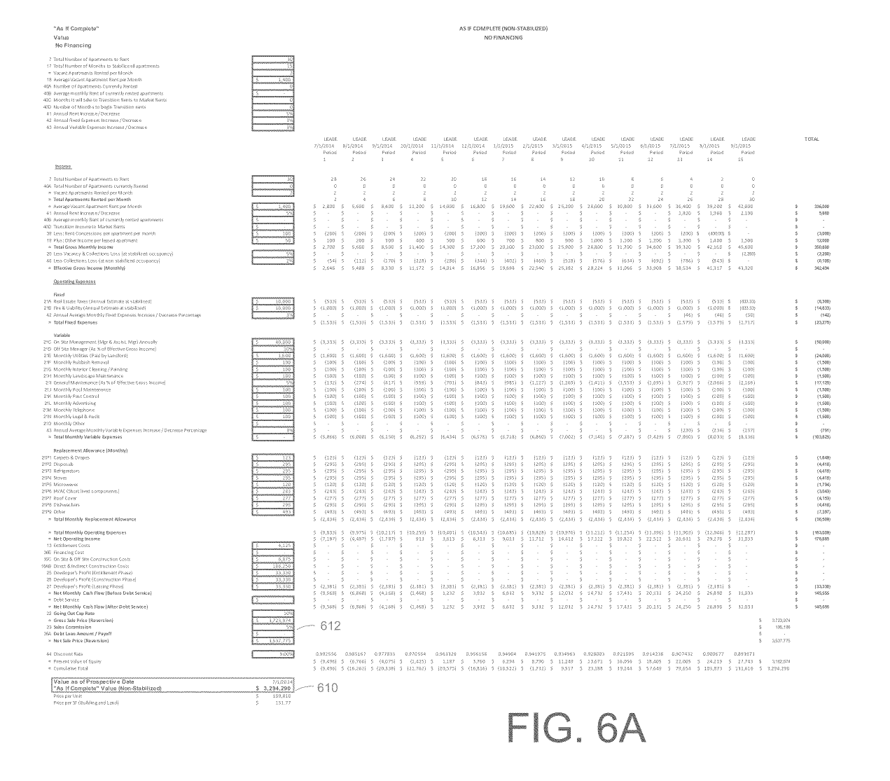

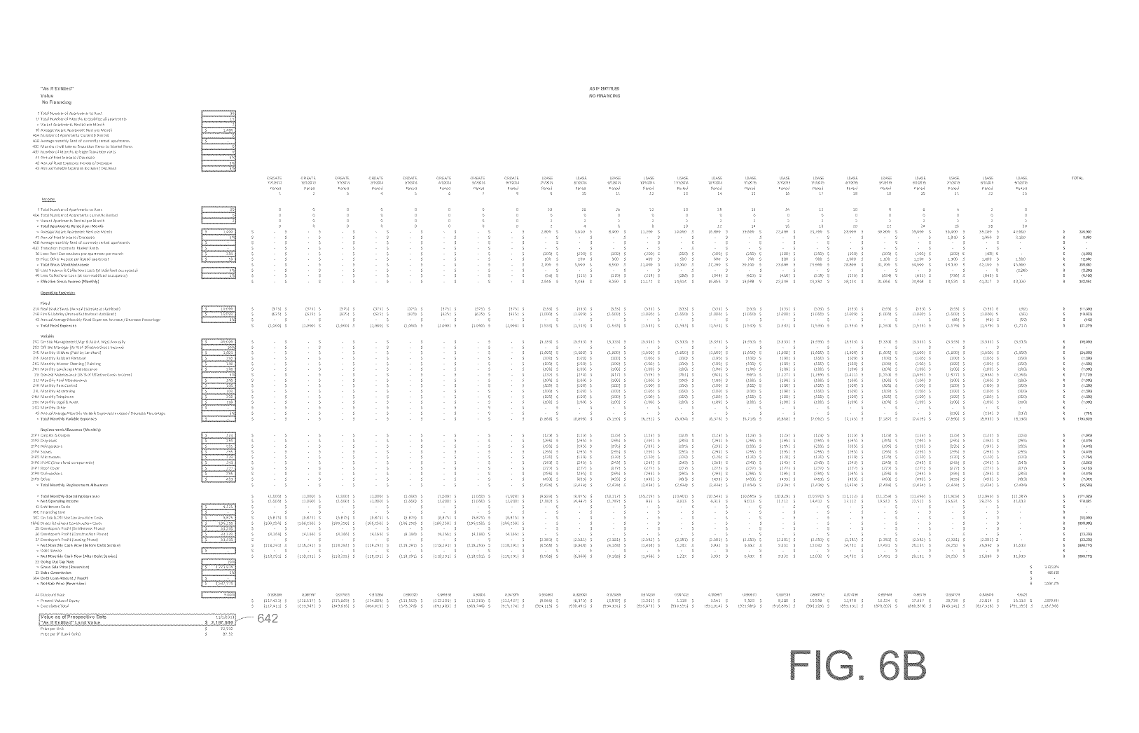

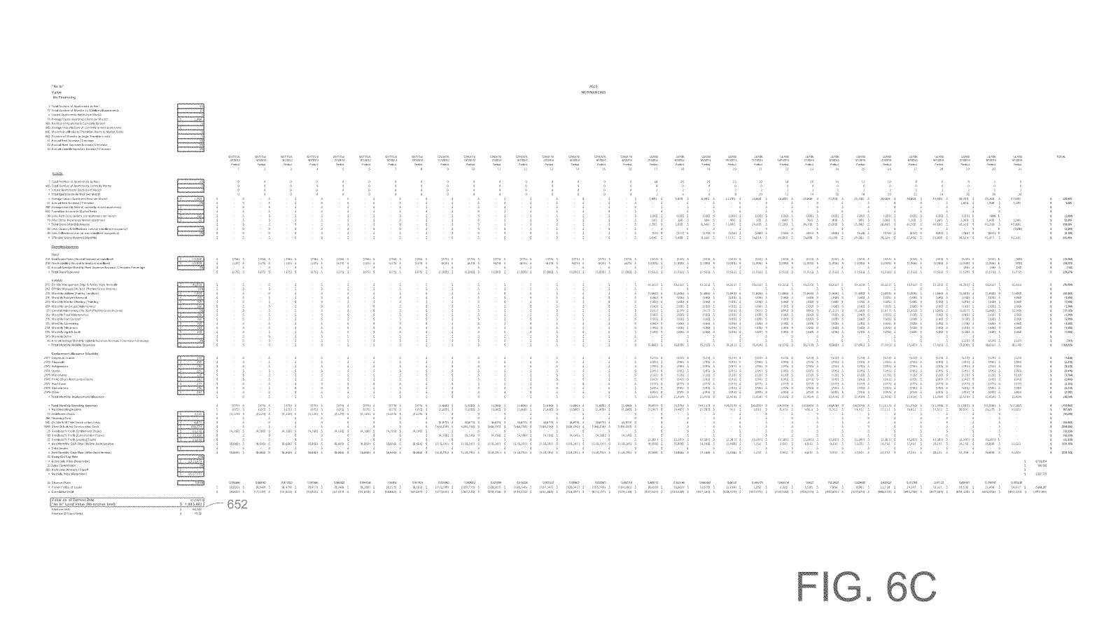

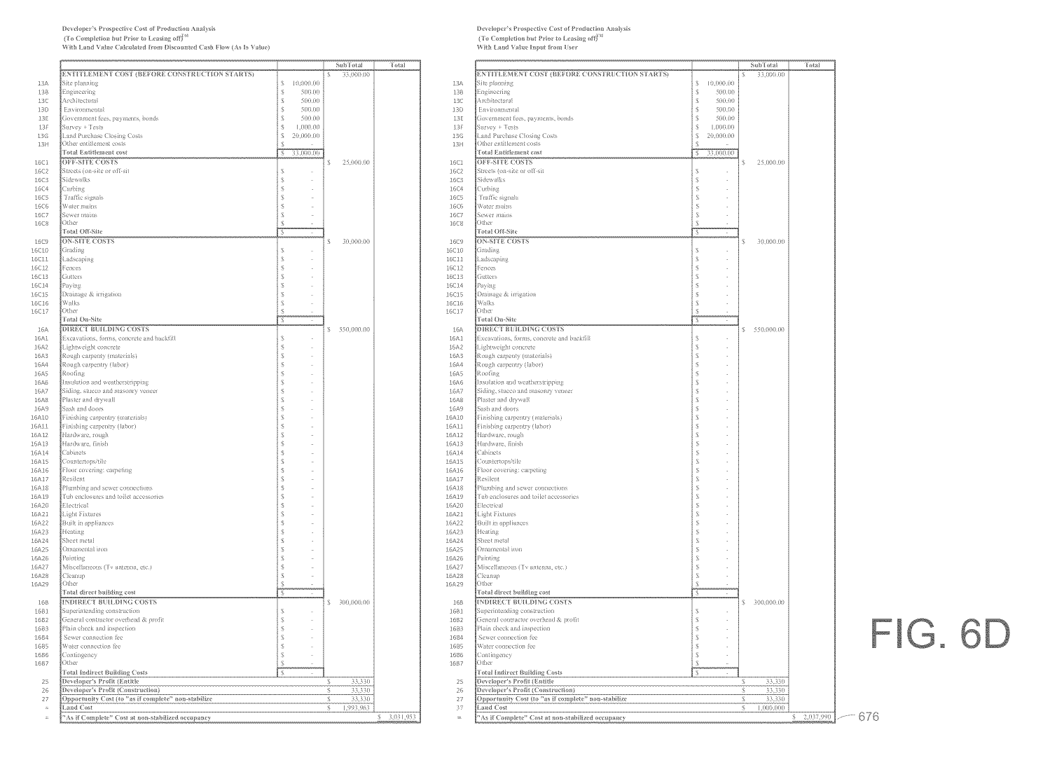

FIG. 6A illustrates a discounted cash flow for a development's prospective “as if complete” value at non-stabilized occupancy or the prospective Bulk/wholesale value if lots or units are sold off in their entirety. The discounted cash flow of FIG. 6A is based on components of value (COV) shown in FIG. 5 and answers to the wizard questions shown in FIGS. 4A-E.

FIG. 6B illustrates a discounted cash flow of a development's prospective “as if entitled” value when the land is fully entitled. The discounted cash flow of FIG. 6B is based on components of value (COV) shown in FIG. 5 and answers to the wizard questions shown in FIGS. 4A-E.

FIG. 6C illustrates a discounted cash flow of a development's “as is” value of the land as of the current date. The discounted cash flow of FIG. 6C is based on components of value (COV) shown in FIG. 5 and answers to the wizard questions shown in FIGS. 4A-E.

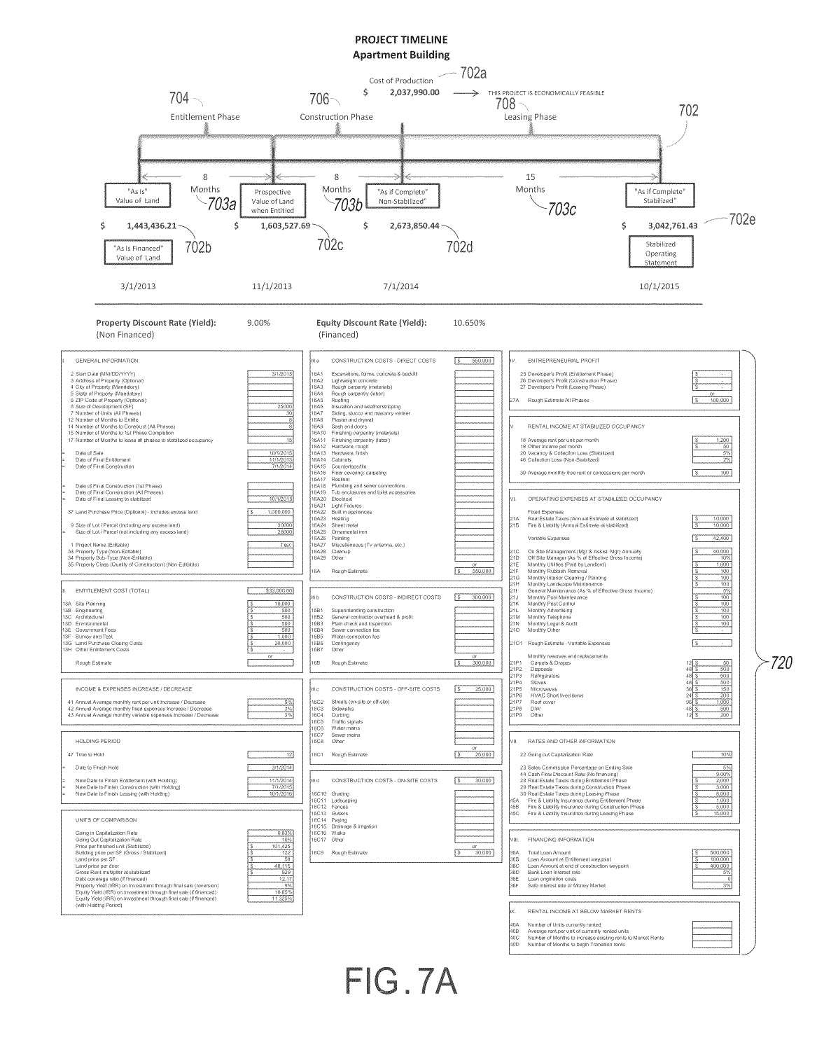

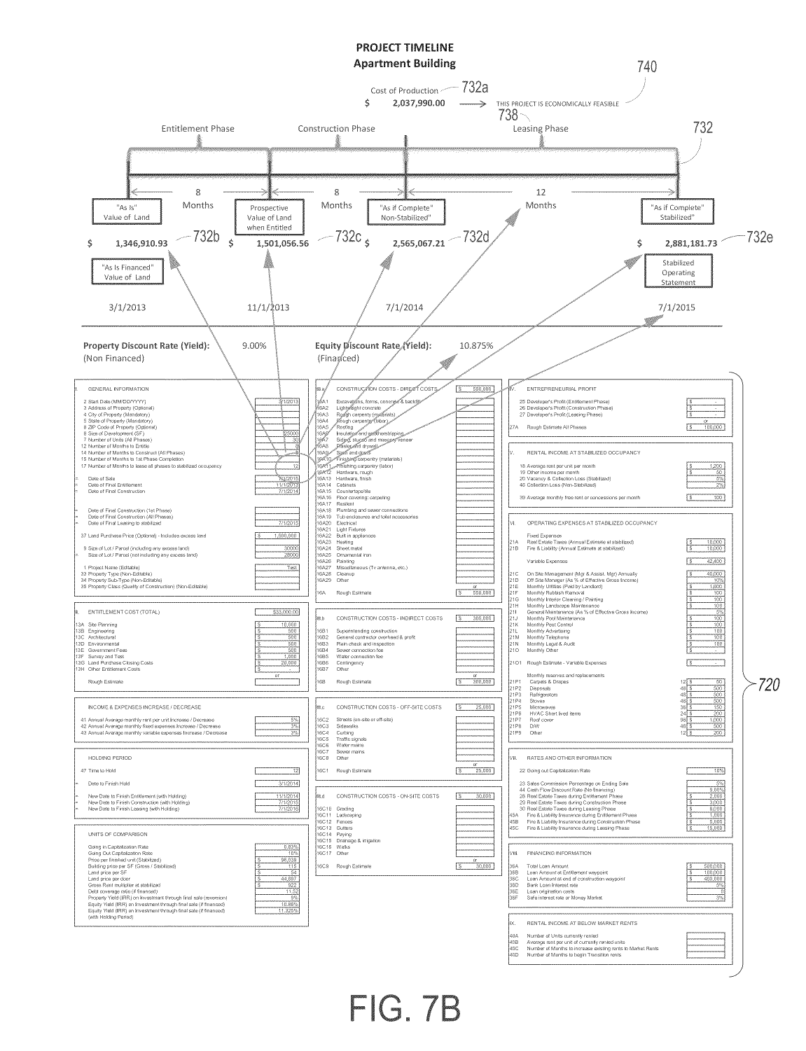

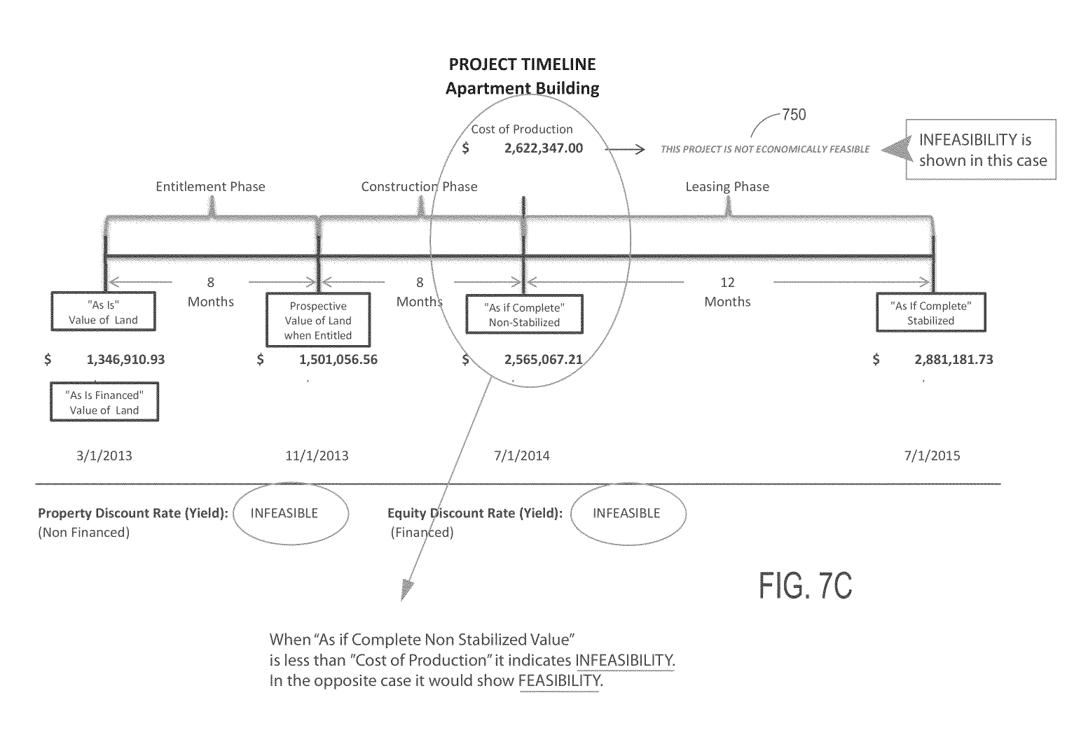

FIG. 6D illustrates determination of a cost of production value for a real estate project. Cost of production is based, at least in part on the “as is” value of the land. The user will then be graphically shown the development timeline with the above value indications and the cost of production on the timeline. This is shown in FIG. 7A, described below.

FIG. 7A is one example of a development timeline. The development timeline shown in FIG. 7A corresponds to development timeline 302a shown in FIG. 3A. However, unlike timeline 302, no reversion value is shown in the timeline 702. In some aspects, the development timeline 702 is presented on a user interface of a computer. The development timeline may be based on one or more of the wizard questions of FIGS. 4A-E, components of value shown in FIG. 5, and the discounted cash flows shown in FIGS. 6A-D. For example, the cost of production 702a displayed on the timeline graph 702 shown in FIG. 7A is determined by the analysis shown in FIG. 6D, and is derived from cell 676 as the “As If Complete cost at non-stabilized occupancy.” The “As Is” value for the timeline 702 is the “as is” value of Land 702b, which is derived from cell 652 of the discounted cash flow shown in FIG. 6C. The “Prospective Value of Land when Entitled” value 702c is derived from cell 642 of the discounted cash flow shown in FIG. 6B. The “As if Complete at Non-Stabilized” value 702d is derived from cell 610 of the discounted cash flow shown in FIG. 6A. The “As if Complete” Stabilized value 702e is derived from cell 612 of the discounted cash flow shown in FIG. 6A.

Time parameters 703a-c on the timeline graphic may be derived from one or more of the wizard questions of FIG. 4A-E. For example, timeline graphic 702 shows an entitlement phase 704 with a duration 703a of eight (8) months, construction phase 706 with a duration 703b of eight (8) months, and a leasing phase 708 with a duration 703c of fifteen (15) months. The duration of the entitlement phase 704 is derived from wizard question 12 shown in FIG. 4A. This duration is also shown in component of value box 12 of FIG. 5. The length of the construction phase 706 is derived from wizard question 14, shown in FIG. 4B. This is also shown in component of value box 14 shown in FIG. 5. The length of the leasing phase 708 is derived from wizard question 17 shown in FIG. 4C. The length of the leasing phase 708 is also seen in component of value box 17 on FIG. 5.

Below the timeline graphic 702, one or more component of value boxes 720 may be presented on the user interface. In some aspects, the component of value boxes 720 may be initially populated with answers to the wizard questions of FIG. 4A-E and/or values derived from the wizard questions of FIG. 4A-E. In some aspects, a user may insert updated values in any of the component of value boxes 720. In response to entry of an updated value, one or more of the values 702a-e and/or length of the entitlement phase 704, construction phase 706, and/or leasing phase 708 may also be updated on the display.

FIG. 7B shows an example of an updated timeline graphic 732. In the example of FIG. 7B, a user has updated component of value box 17 of the component of value boxes 720. The value for the “number of months to lease all phases to stabilized occupancy” in FIG. 7A was fifteen (15) months. In contrast, the corresponding value in FIG. 7B has been reduced to twelve (12) months. The timeline graphic 732 shown in FIG. 7B has also been updated to reflect the shorter leasing phase 738 of twelve (12) months.

As a result of the shorter leasing phase, each of the values 732b-e are also updated relative to values 702b-e shown in FIG. 7A via discounted cash flows as discussed above with respect to FIG. 7A.

Once the user is satisfied with any changes to the COV boxes 720, the final timeline 732 prospective “as if complete” value at non-stabilized occupancy may be equal or greater than the timeline's cost of production for the development to be financial feasible. Financial feasibility is shown in FIG. 7B by indication 740. If the cost of production exceeds the “as if complete” stabilized value, the development is financially infeasible and the entitlement process should not be started. This is shown in FIG. 7C by indicator 750.

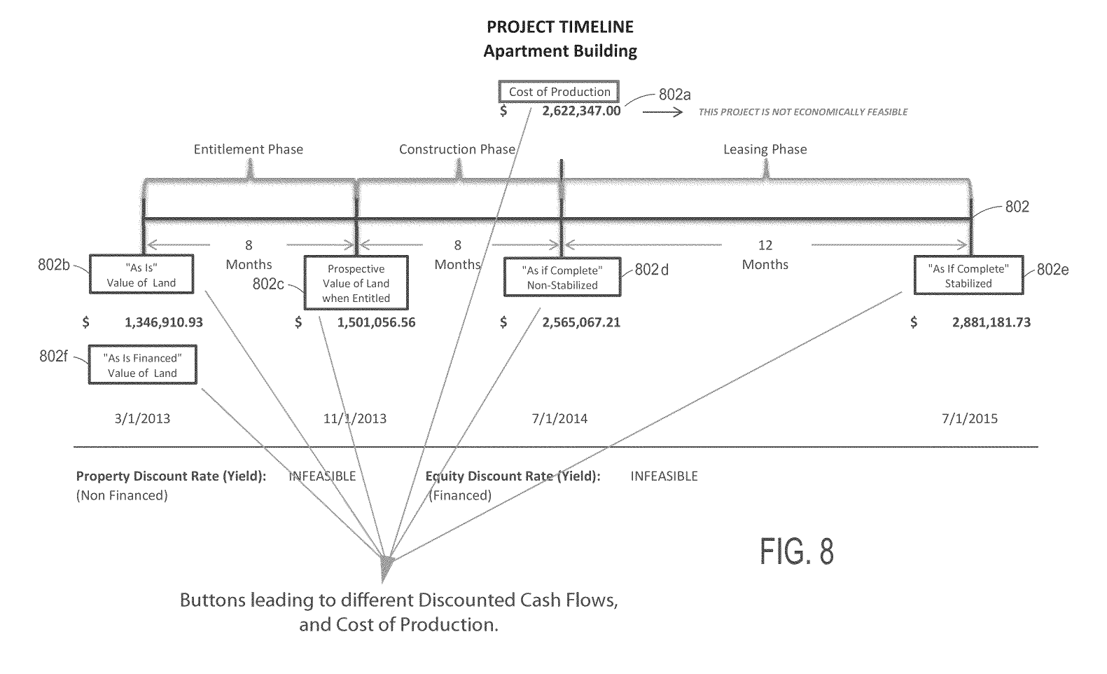

FIG. 8 shows a timeline graphic including user interface controls. In some aspects, if the user wants to see the various DCF models or the COP discussed above, they can select buttons beneath the values or the cost of production to view the corresponding discounted cash flow solving for the value. The discounted cash flow may be displayed on screen or the user may select to individually print the discounted cash flow. The user interface controls that provide for these functions are shown in FIG. 8 as button/controls 802a-f. For example, button/control 802a may open a screen showing a discounted cash flow similar to that shown in FIG. 6D. Button/control 802b may present a screen showing a discounted cash flow similar to that shown in FIG. 6C. Button/control 802c may present a screen showing a discounted cash flow similar to that shown in FIG. 6B. Button/controls 802d-e may present a screen showing a discounted cash flow similar to that shown in FIG. 6A. Note that the timeline graphics 702 and 732 shown in FIGS. 7A-B may also include button/controls as described with respect to FIG. 8, and this concept may be extended to any value displayed on any timeline graphic discussed in this disclosure.

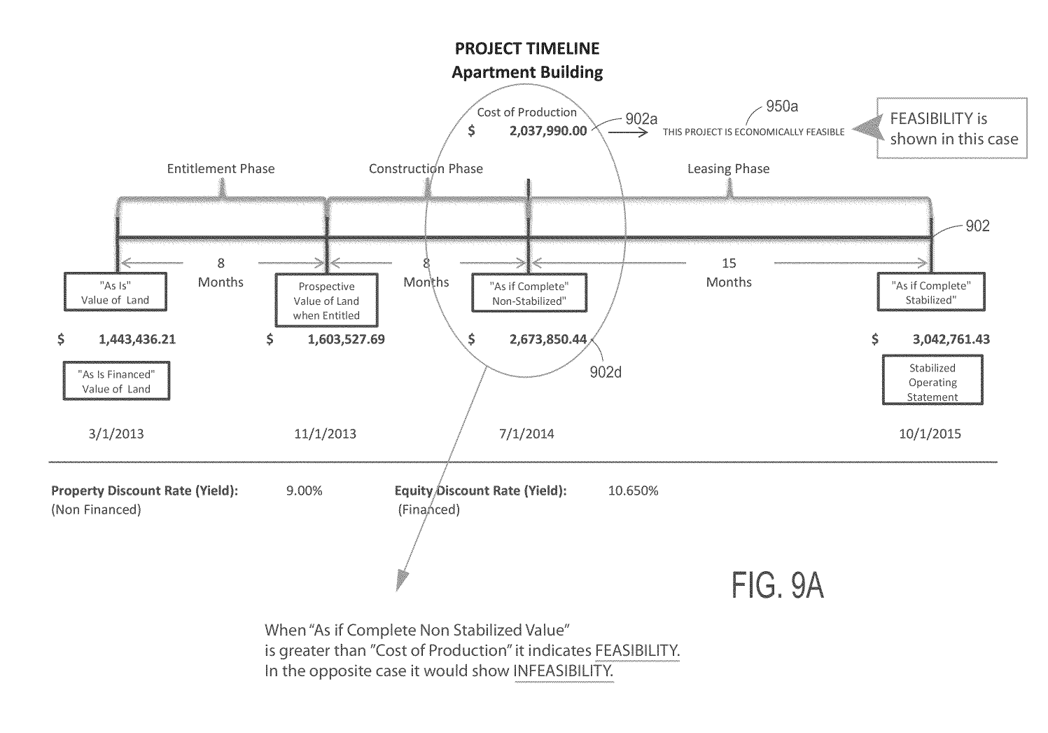

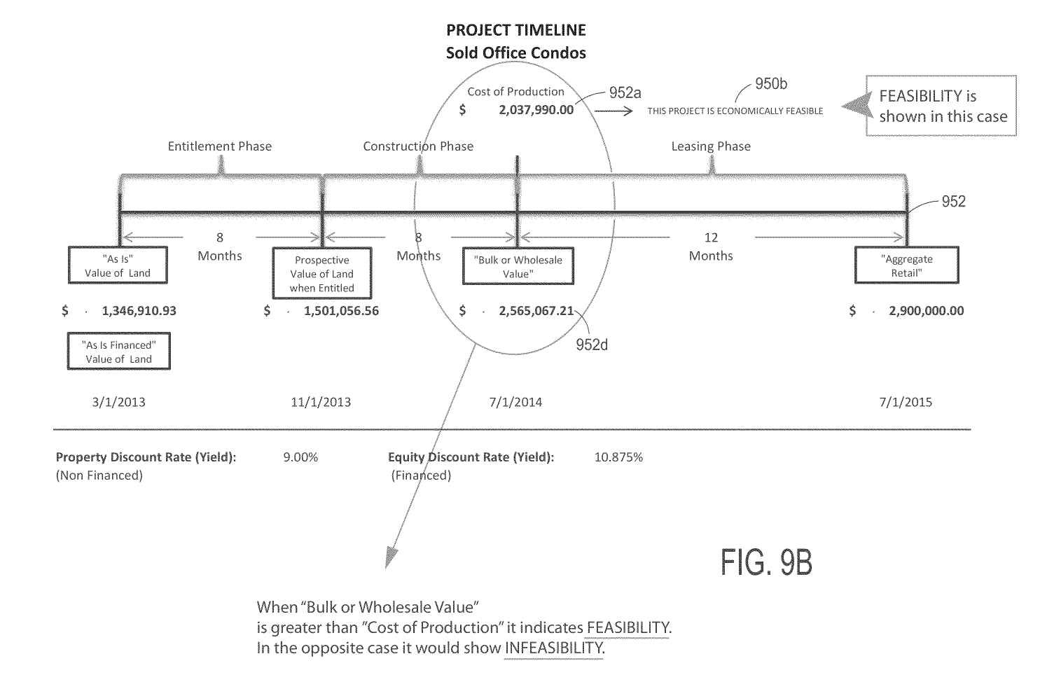

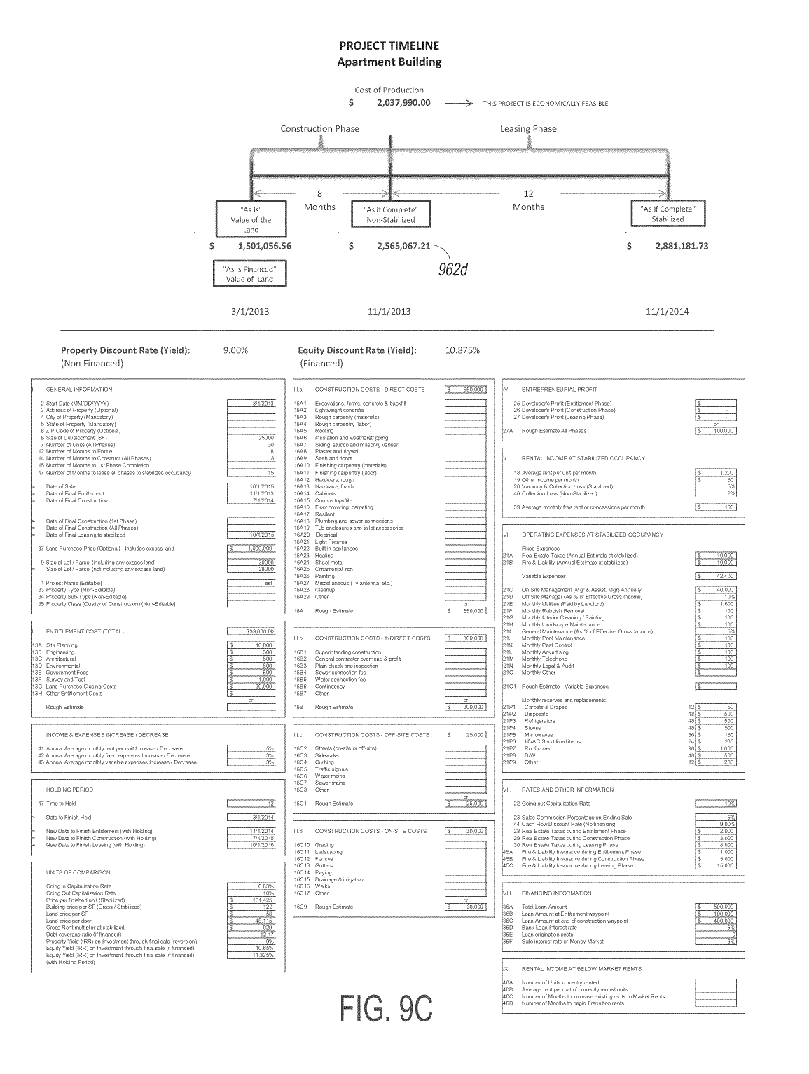

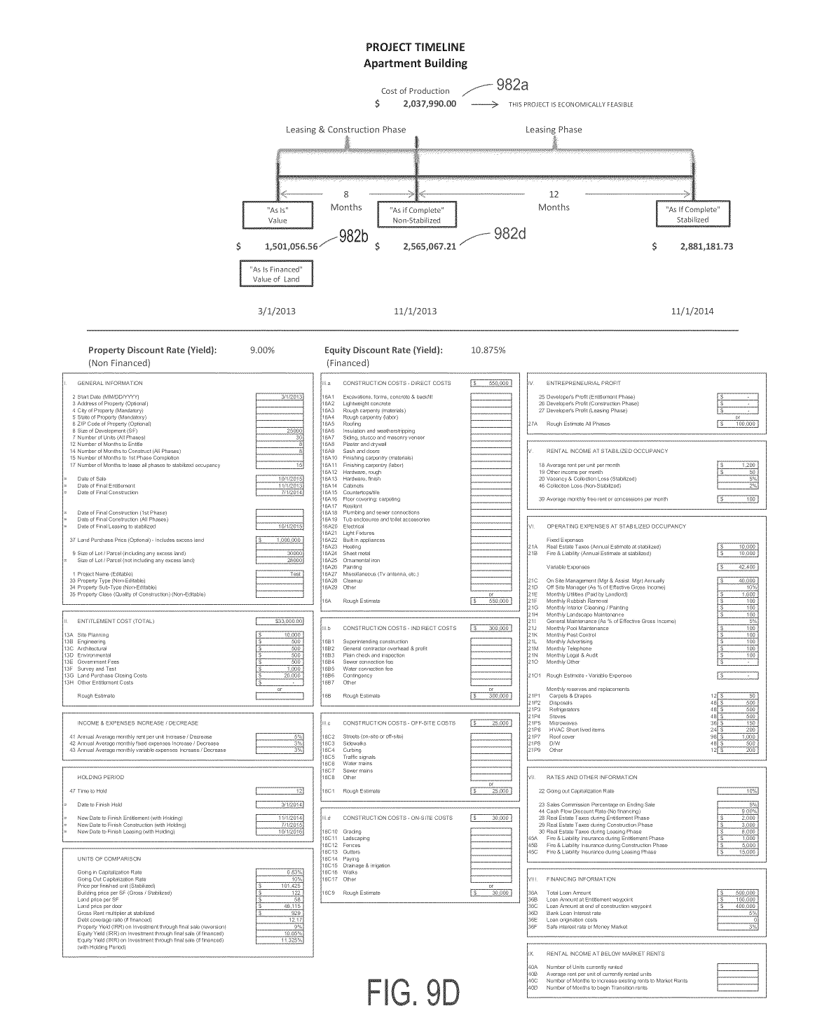

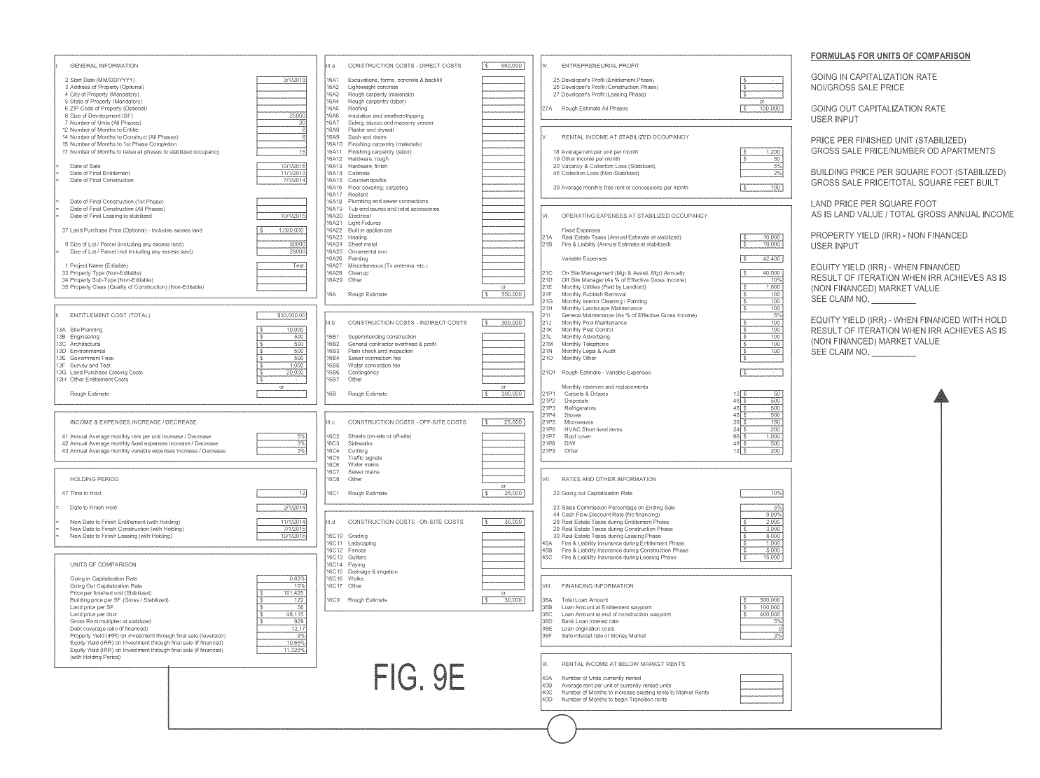

FIG. 9A shows a project timeline 902 and an indication that a proposed development is economically feasible. If the user is proposing to develop a single product (apartments, office, retail, industrial, etc.) to sell, some aspects compare the finished product's prospective “as if complete” value 902d to the development's cost of production 902a to determine financial feasibility. As discussed above, if the value 902d is greater than the cost of production 902a, an indicator 950a may be displayed on the user interface indicating the project is financially feasible. In the prospective “as if complete” value 902d is less than the cost of production 902a, some aspects may display an indicator that the project is not economically feasible.

FIG. 9B shows a project timeline 952 and an indication that a proposed development is economically feasible. If the user is proposing to develop multiple products (office condos or residential condos, lots, etc.) to sell over time until all are sold out, some aspects will compare the finished product's “bulk/wholesale” value 952d to the development's COP 952a to determine financial feasibility. For example, if the bulk value 952d is greater than the cost of production 952, the project may be determined to be economically feasible. In the example of FIG. 9B, since the cost of production 952a is less than the bulk value 952d, the project is determined to be economically feasible, and indicator 950b is consistent with this determination.

FIG. 9C illustrates a project timeline screen constructed from two discounted cash flow models. The timeline screen of FIG. 9C may be displayed when a project type is a partially finished development or a development from a finished lot that does not need an entitlement period. For example, the timeline of FIG. 9C may correspond to timeline 304a of FIG. 3A. A first discounted cash flow model solves for a prospective “as if complete” value at non-stabilized occupancy 962d in the case of a single product development. A second discounted cash flow model solves for an “as is” value of the lot 962b and partially finished building, if applicable.

FIG. 9D illustrates a project timeline based on two discounted cash flow models. The timeline of FIG. 9D may be presented when a project type is a remodel to an existing property. This may correspond to timeline 306a of FIG. 3A. A first discounted cash flow model may solve for a prospective “as if complete” value at non-stabilized occupancy 982d, in the case of a single product development. A second discounted cash flow model may solve for an “as is” value of the unremodeled building and lot 982b. In some aspects, the resulting “as is” timeline value 982d can be compared to the COP 982a for financial feasibility as described above.

The above timeline scenarios will produce Units of Comparison (UOC) for the finished product type at stabilized occupancy. An example is shown in FIG. 9E. Thus, not only do the disclosed systems derive components of value from the wizard questions and, in some aspects, from a comparables database, but the user is also provided with units of comparison. This allows the user to have easy access to multiple metrics to better evaluate their investment.

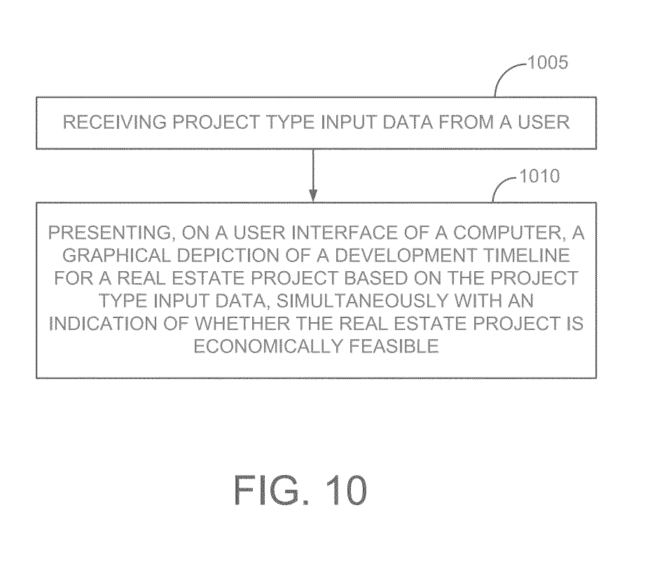

FIG. 10 is a method of displaying values of a real estate project. In some aspects, process 1000 may be performed by the web server 170, shown in FIG. 2A. In some other aspects, process 1000 may be performed by a client device, such as any of client devices 110, 120, 130, or 140 shown in FIG. 1.

In block 1005, project type data is received from a user. In some aspects, the project type data may correspond to the project type data 324a-e shown in FIG. 3D. For example, the project type data may indicate whether the project is developed from raw land, and needs entitlements 324a, whether it is partially finished or developed from a lot (in this case, the project has no income or entitlement period) 304b, whether it is an existing project but needs remodeling 324c, whether the project is not at stabilized occupancy, is below market rents, or both, 324d, or whether the project is an existing project at stabilized occupancy and market rents 324e. The project type data may enable a device performing process 1000 to determine which variation of the project timelines shown in FIGS. 3A and 3B should be applied.

In some aspects, the project type data is received from a user over a network. For example, in some aspects, method 1000 may be performed by one or more server based computers, such as servers 170a-c of FIG. 1, that receive data over an Internet connection from a remote client device. In these aspects, the user may be interacting with the client device, which causes the project type data to be received by the server computer(s). In some other aspects, the project type data may be received from a keyword and/or pointing device of a computer. For example, in some aspects, method 1000 may be performed by a computer directly connected to the keyboard and/or pointing device that generates the project type data.

In block 1010, a graphical depiction of a development timeline is presented on the user interface of a computer. The graphical depiction is based on the project type data received in block 1005. As shown in the examples of FIG. 3A-B or 7A-7B, in some aspects, the graphical depiction of the development timeline includes an entitlement phase portion, a construction phase portion, and a leasing phase portion. In some aspects, one or more of a as is value of land, a prospective value of land when entitled, an as if complete at non-stabilized occupancy value, and a as if complete stabilized value is presented simultaneously on the display of the computer with the development timeline. In some aspects, an indication of the project type, received from the user in block 1005, is also displayed simultaneously with the development timeline.

In some aspects, an indication of whether the real estate project is economically feasible is also presented on the user interface, simultaneously with the graphical depiction of the development timeline. FIGS. 7A-9D show various examples of graphical depictions of development timelines. In some aspects, such as those illustrated in FIG. 3A, the indication of economic feasibility is based on whether an “as if complete” non-stabilized value of the project is greater than a cost of production of the real estate project. In some other aspects, such as those of FIG. 3B, the indication is based on whether a bulk/wholesale value is greater than a cost of production of the real estate project. In these aspects, the “as if complete” non-stabilized value, cost of production, and/or bulk/wholesale values are derived from data received from the user.

In some aspects, the indication of economic feasibility is a character string, in some cases a partial or complete sentence, indicating whether the project is financially feasible. In some aspects, the indication of financial feasibility may be based on a present value of the cash flows and reversion of the real estate project, given discount and yield rates provided by the user as shown in FIGS. 4A-E.

As described above, for example with respect to FIGS. 4A-E, in some aspects, after the project type data is received, one or more wizard questions may be displayed to a user of a computer. In some aspects, displaying the wizard questions includes transmitting data indicating the questions over a network to a remote computer that actually displays the questions, receives answers, and transmits data representing the answers to the questions back to a computer performing process 1000.

In some aspects, process 1000 may include receiving additional project data after the graphical depiction of the timeline is presented. For example, as discussed above, a user may be able to perform “what if” analysis by entering updated values into one or more of the component of values boxes, for example, as shown with respect to component of value boxes 720 of FIG. 7A-7B. In some aspects, after one or more of component of value boxes 720 are updated, an electronic processor performing method 1000 may then re-compute the discounted cash flows necessary to re-present an updated project timeline based on the updated values. An updated indication of whether the project is now economically feasible may also be presented, simultaneously with the re-presented development timeline. This process may be performed iteratively until the user is satisfied with the information displayed on the timeline.

Financially Infeasible plus Holding

Existing financial feasibility methodologies of net present value (NPV) and comparing cost of production (COP) to the “as if complete” value at stabilized occupancy market rent (in the case of a single property development) or the “as if complete” bulk/wholesale value (in the case of a multiple property development) cannot solve for “as is” land development if deemed infeasible. For example, generally, NPV methodologies utilize a price paid for a property in order to calculate the total cost of production. However, a sales price or a developer's cost basis of the land may not be a good indicator of an “as is” value based on the highest and best use. “As Is” value should instead be based on the highest and best use of the property in order to accurately estimate whether or not a potential development is economically feasible.

The disclosed methods and systems represent improvements in these methodologies by allowing the user to automatically expand the development timeline if the proposed development shows financial infeasibility. This allows the user to experiment with delivering the “as if complete” product later to the marketplace by the amount of time indicated by a received holding period. By delivering the finished product later in the marketplace results in possibly higher price points (higher lease rates or higher unit sale price of condos, etc.) and possibly a faster absorption (faster lease-up velocity or faster sales volume for condos, etc.) When financial feasibility is found with a holding period, the discounted cash flow models may be automatically recalculated showing new timeline value including a new “as is” value when property is not ready for immediate development.

This new technology allows the user to quickly support the highest and best use of the “as is” property value by indicating the highest value that is legally permissible, physical, possible, financially feasible and maximally productive. In some aspects, a proposed development is deemed financially infeasible if the “as if complete” value at non-stabilized occupancy is less than its cost of production (COP), in the case of single product development.

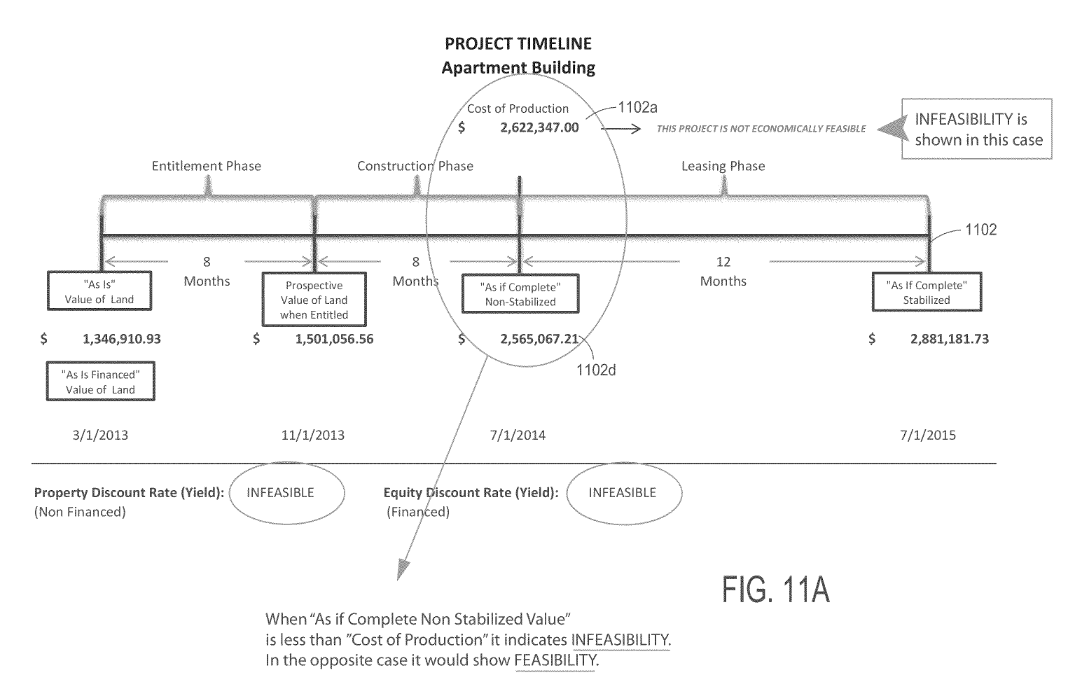

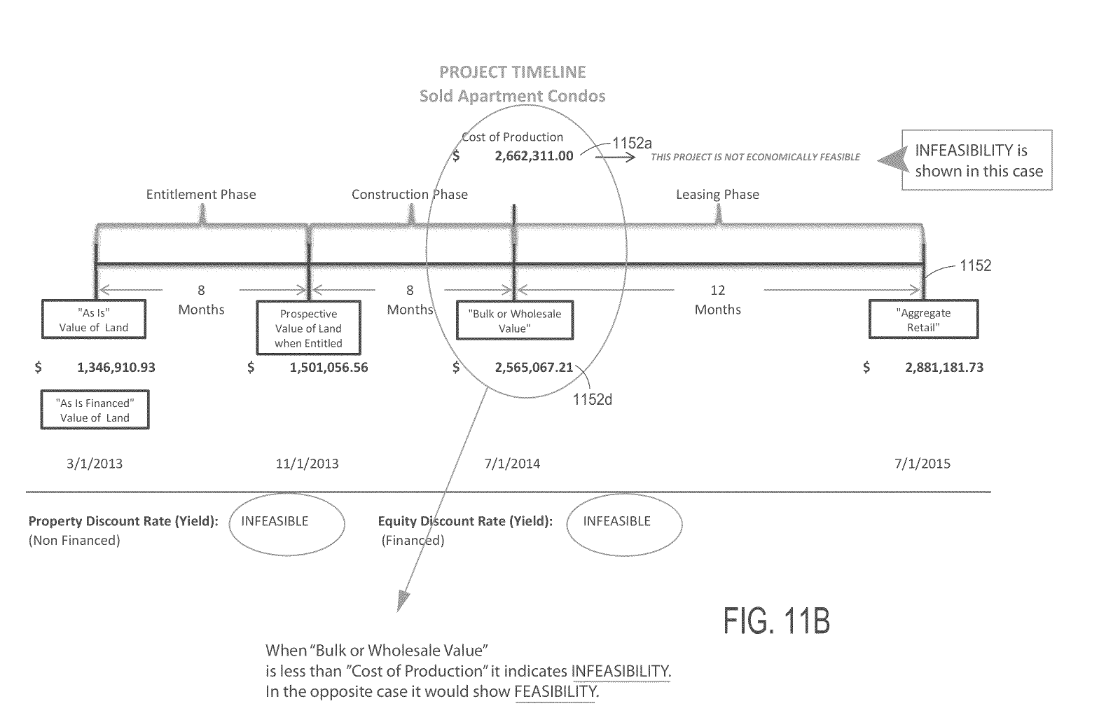

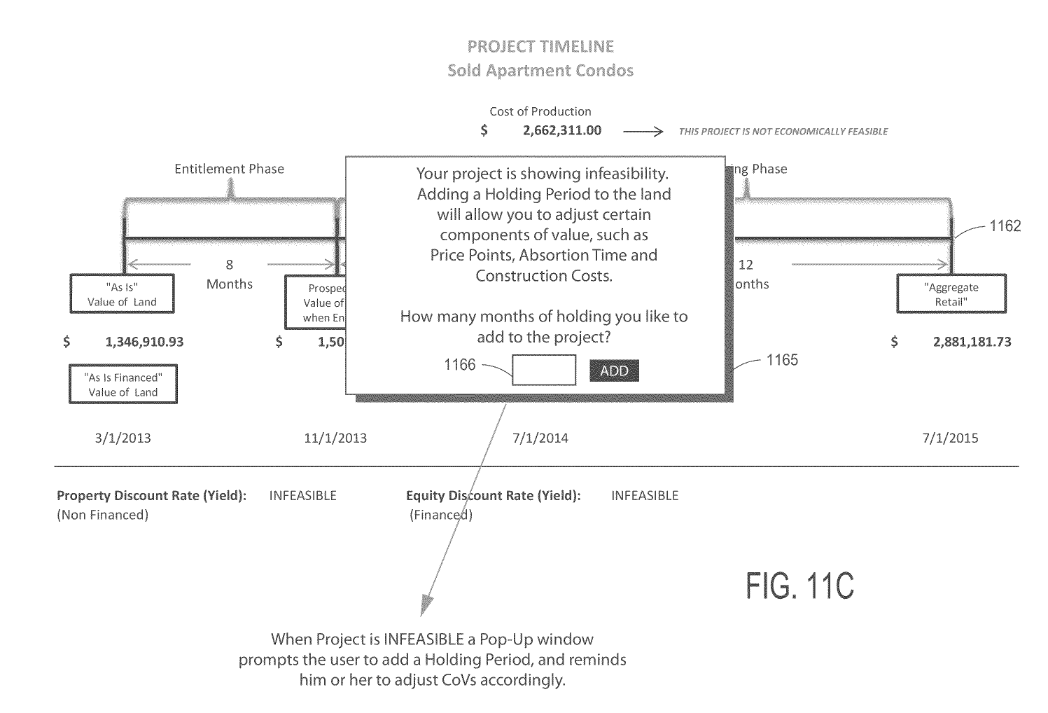

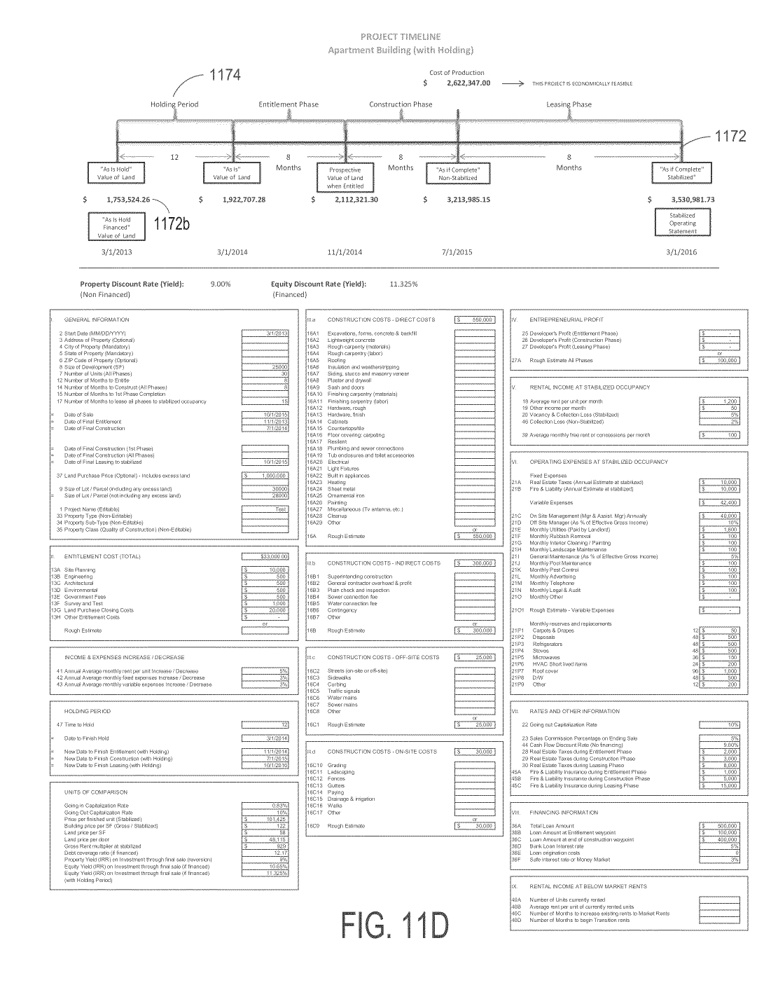

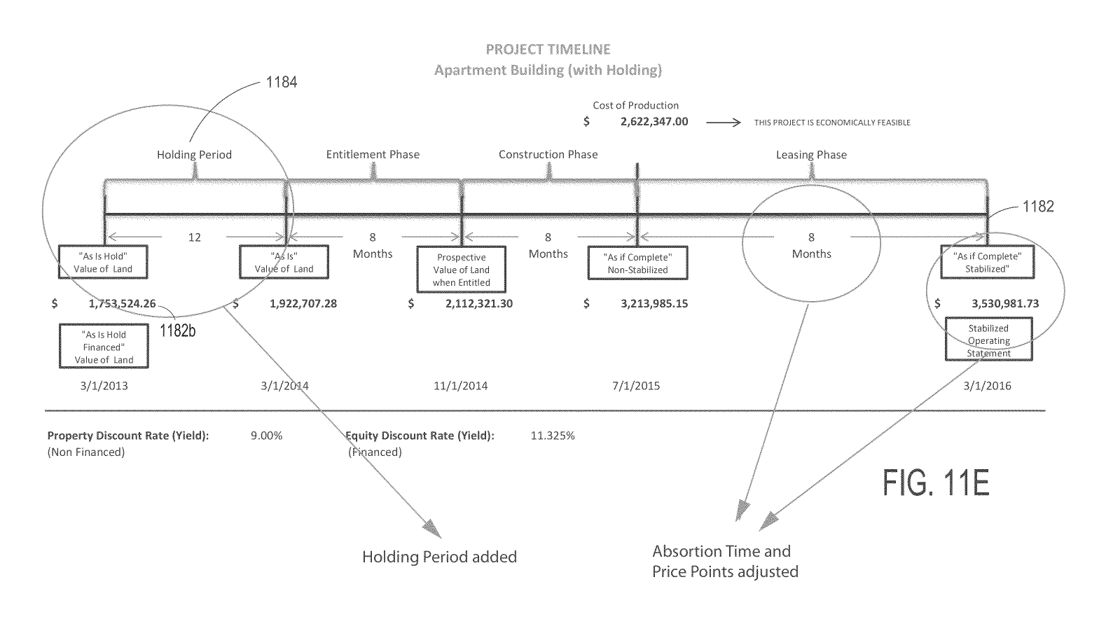

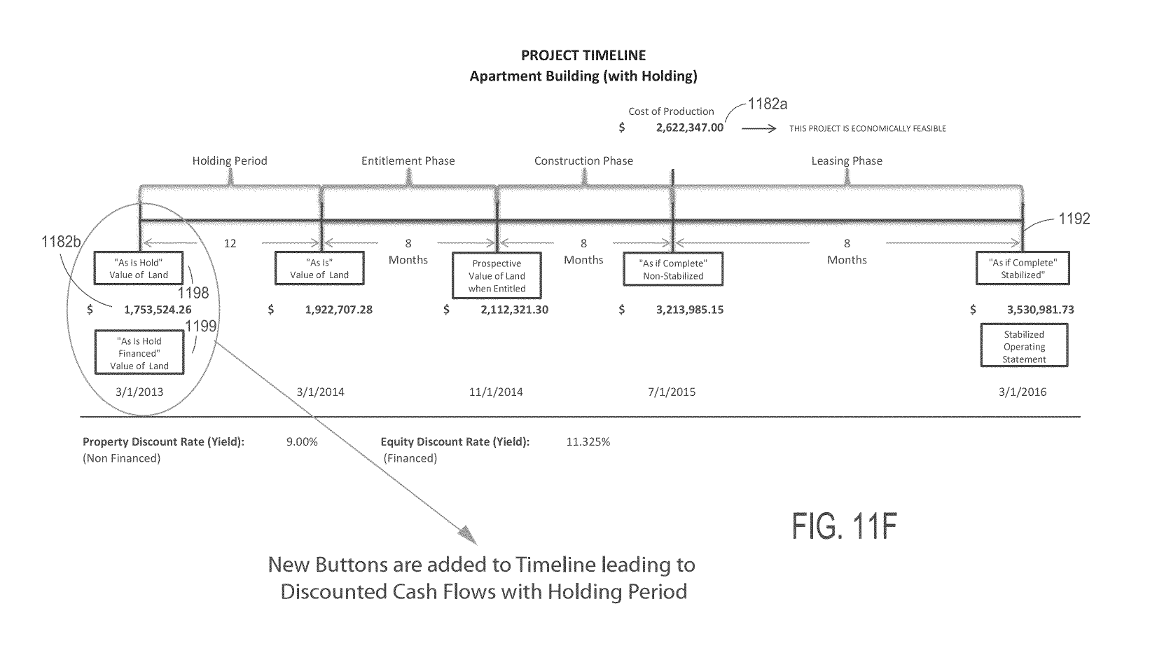

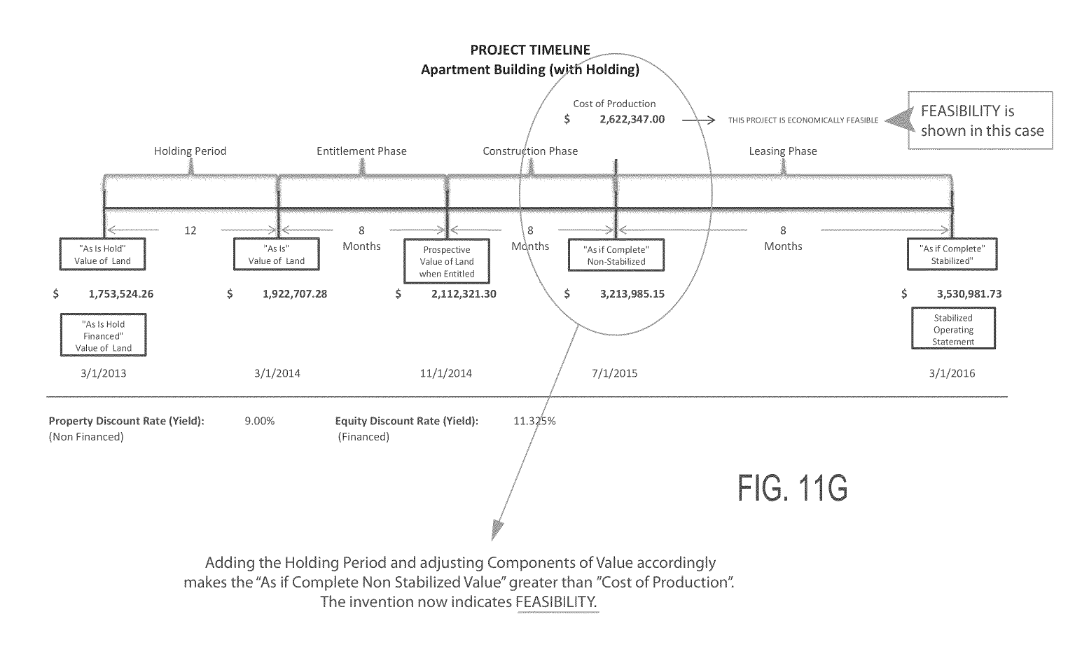

FIG. 11A shows a timeline 1102 for a project that is not economically feasible. FIG. 11A is indicating financially infeasibility via indicator 1150a. This indication may be based on the cost of production 1102a exceeding the “As if Complete” non-stabilized value 1102d. The project type for the timeline of FIG. 11A may correspond to one or more of the timelines of FIG. 3A.

FIG. 11B shows another example of a project that is financially infeasible. In FIG. 11B, a multi-product development has a “Bulk/Wholesale” value 1152d that is less than the cost of production (COP) 1152a. The project type for the timeline of FIG. 11B may correspond to the timelines of FIG. 3B.

FIG. 11C shows an example of a holding period dialog 1165. In some aspects, if financial infeasibility is indicated, the dialog 1165 may be presented on the user interface of a display asking the user if he/she would like to add a holding period to the development timeline 1162 and rethink the product's price points and absorption timing. The holding period provides a finished product to the marketplace at a later time. This later time may have a better market for the product than an earlier delivery time. This may provide for higher price points and perhaps faster absorption for leasing or selling multiple products, i.e., condo, lots, etc.

After this holding period 1166 is entered into the dialog, up to four DCF models may be generated based on the holding period. The first three DCF's may be similar to the DCF's shown in FIGS. 6B-D, with the fourth DCF accounting for the addition of the holding period. The project timeline may then be re-presented to the user so as to include the holding period.

FIGS. 11D-E show project timelines 1172 and 1182 that include respective holding periods 1174 and 1184. A fourth DCF may be used to generate the current “as is hold” value 1172b and 1182b of the property when it is ready for immediate development. The results of this fourth discounted cash flow may be displayed on the project timeline as shown in FIGS. 11D-E.

FIG. 11F shows user interface controls that may be present in some aspects of development timelines that include holding periods. User interface controls 1198 and 1199 may display details of a discounted cash flow that includes the holding period present in the project being modeled in FIG. 11F. In some aspects, component of value boxes may be displayed below the timeline (not shown). As discussed above with respect to other timeline examples, the component of value boxes may allow the user to update one or more components of value of the project modeled by the timeline of FIG. 11F. By modifying one or more components of value, the user can play “what if” with the resulting timeline values and COV boxes until financial feasibility is achieved. While FIGS. 11A-B, show that the project is economically infeasible, FIGS. 11E-G show that the addition of the holding period has resulted in a project that is economically feasible.

### Determination of Value Based on a User Forecast

Existing financial feasibility methodologies of net present value (NPV) and comparing cost of production (COP) to the “as if complete” value at stabilized occupancy/market rent (in the case of a single property development) or the “as if complete” bulk/wholesale value (in the case of a multiple property development) cannot solve for the “as if complete” value at non-stabilized if the proposed development if deemed financially feasible.

The “as if complete” value at non-stabilized occupancy is an important value in determining financial feasibility and also for lenders that make loans on development projects. Lenders need to know all the values along the timeline, i.e. “as is” land value; “as if” entitled land value; “as if complete” value at non-stabilized occupancy; and the “as if complete” value at stabilized occupancy. In some aspects, in the case of a multi-property development, the “as is complete” value at non-stabilized will be replaced with the “as if complete” bulk/wholesale value.

The disclosed methods and systems provide access to all timeline values, via the timeline graphic, which enables lenders to manage their construction management accounts more efficiently. For example, a timeline graphic including the various values associated with the phases of construction make it easier for a lender to prevent lending outside the loan-to-value limits for each stage of development timeline. Also, many developers sell their developments at different waypoint values along the development timeline. The disclosed timeline enables a lender to see the values that may be realizable at each phase of construction.

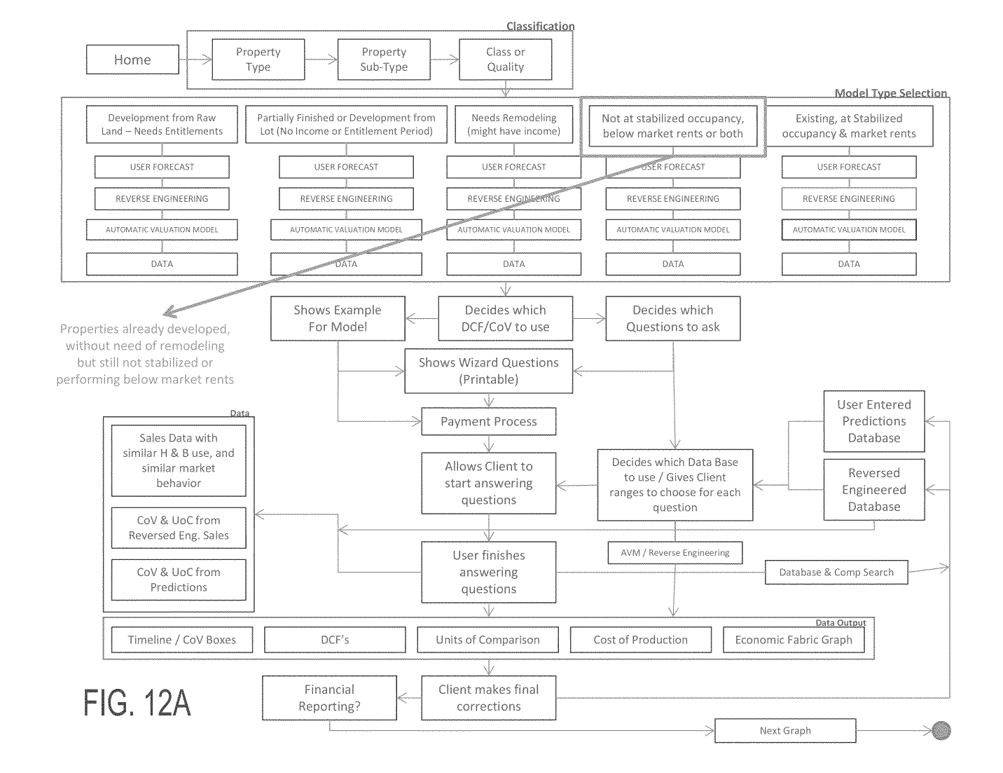

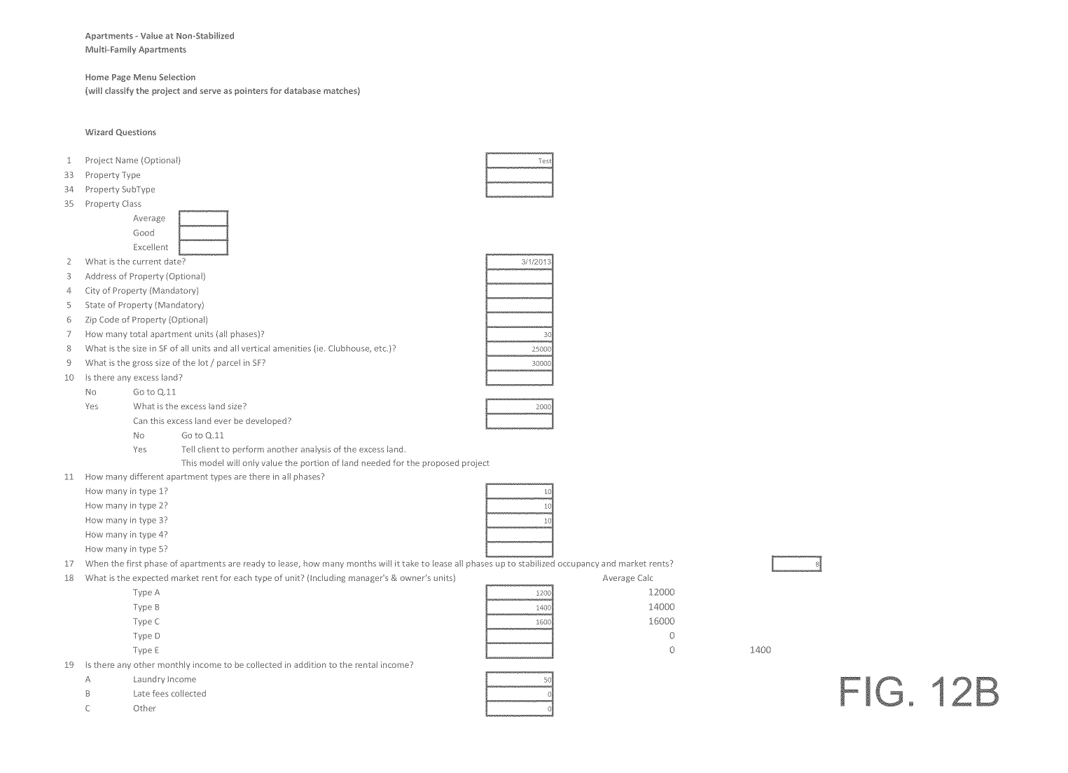

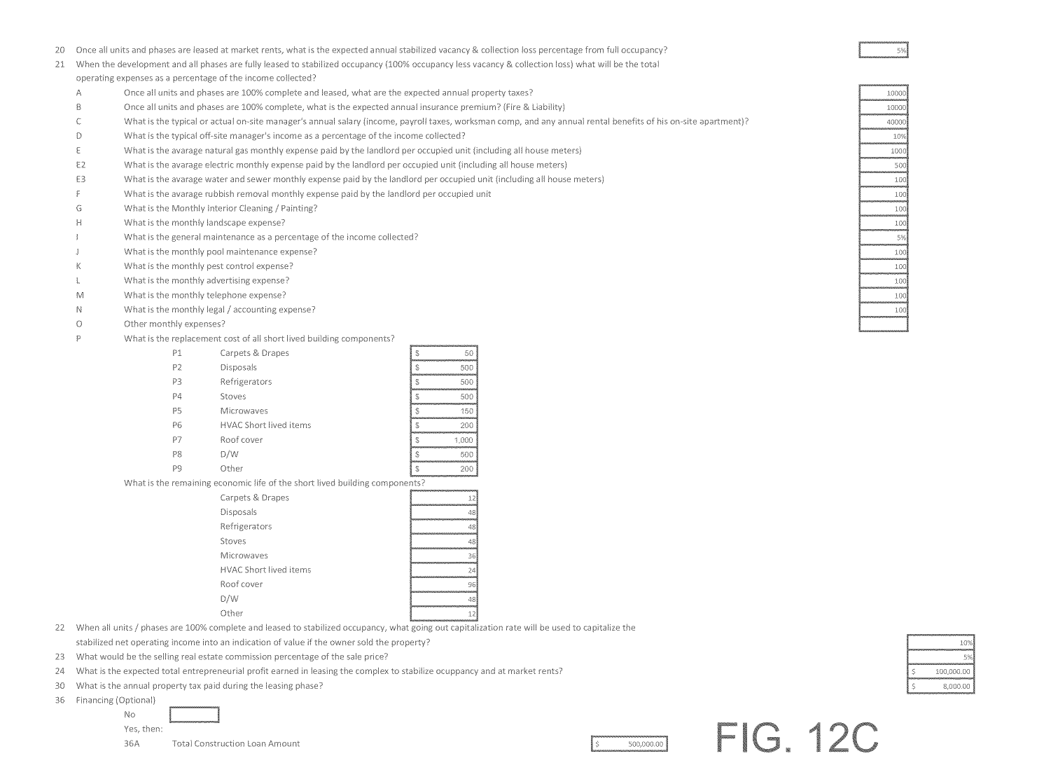

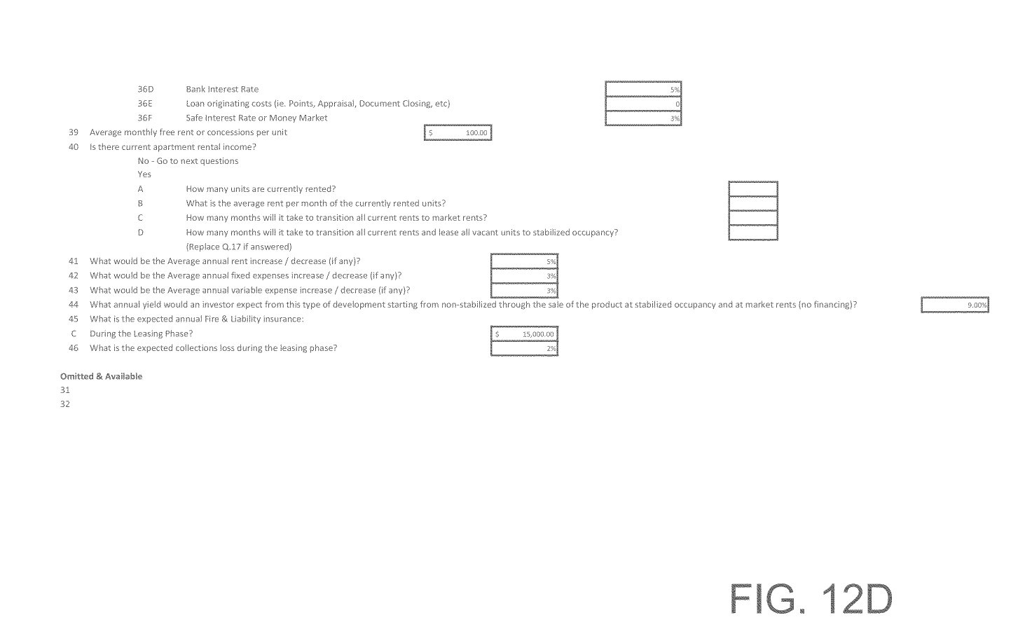

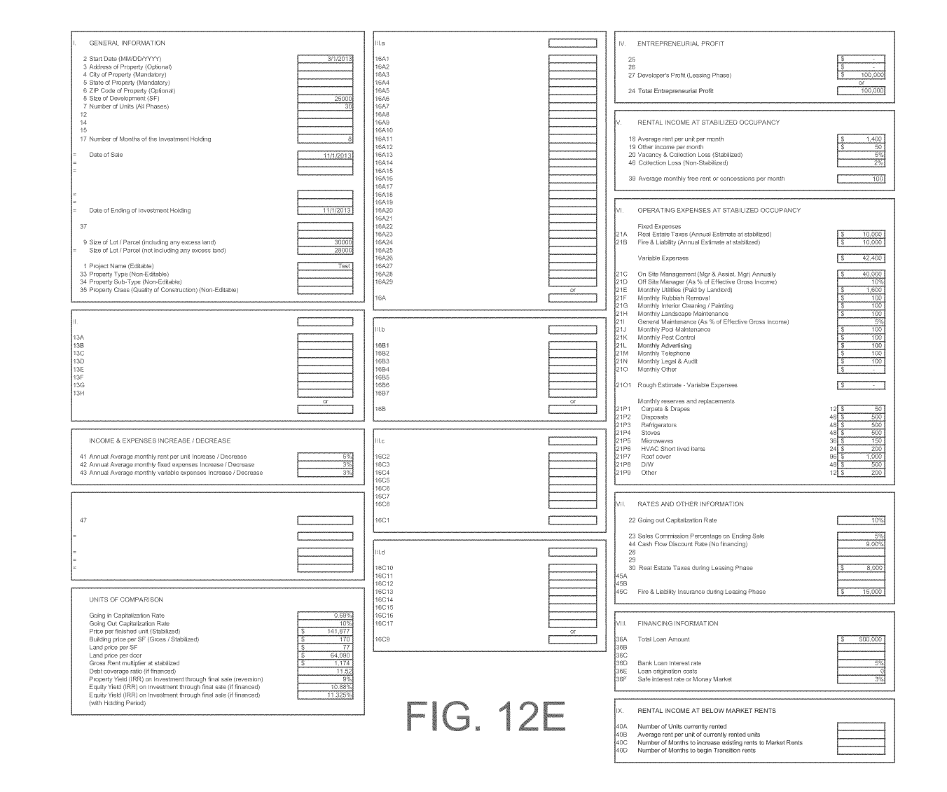

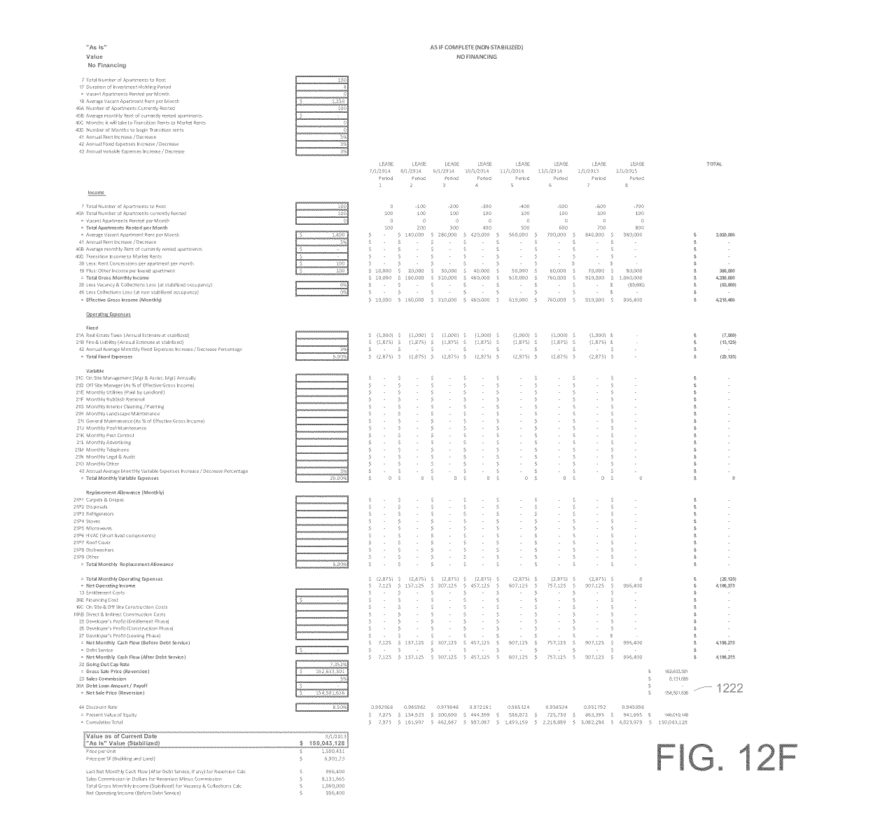

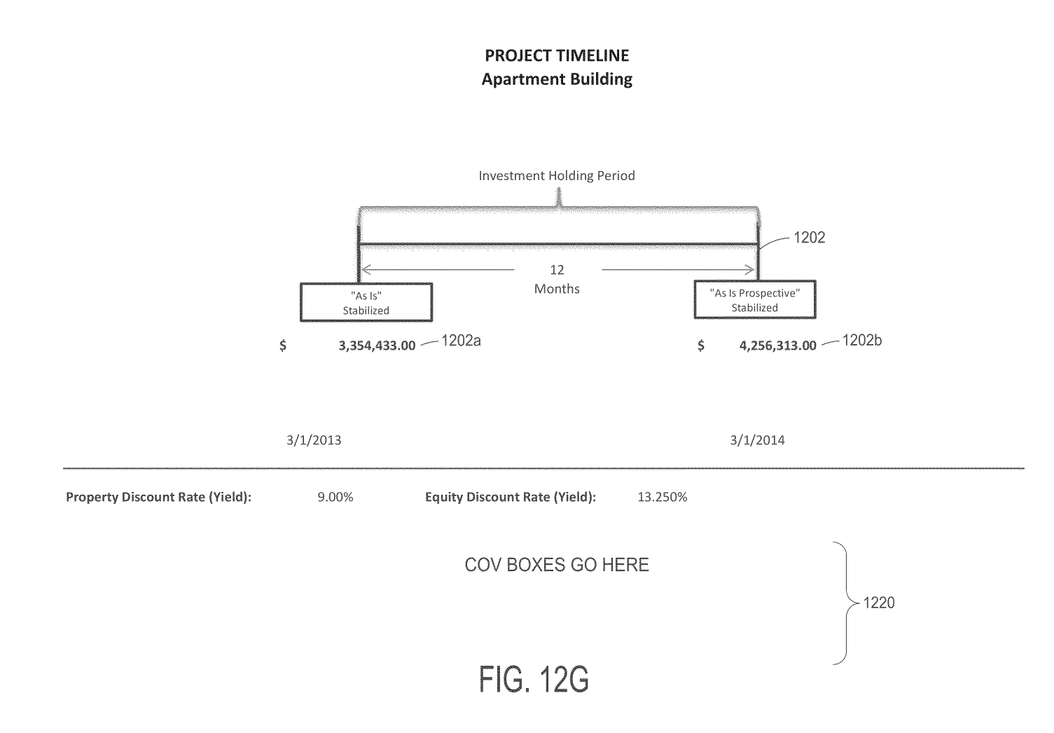

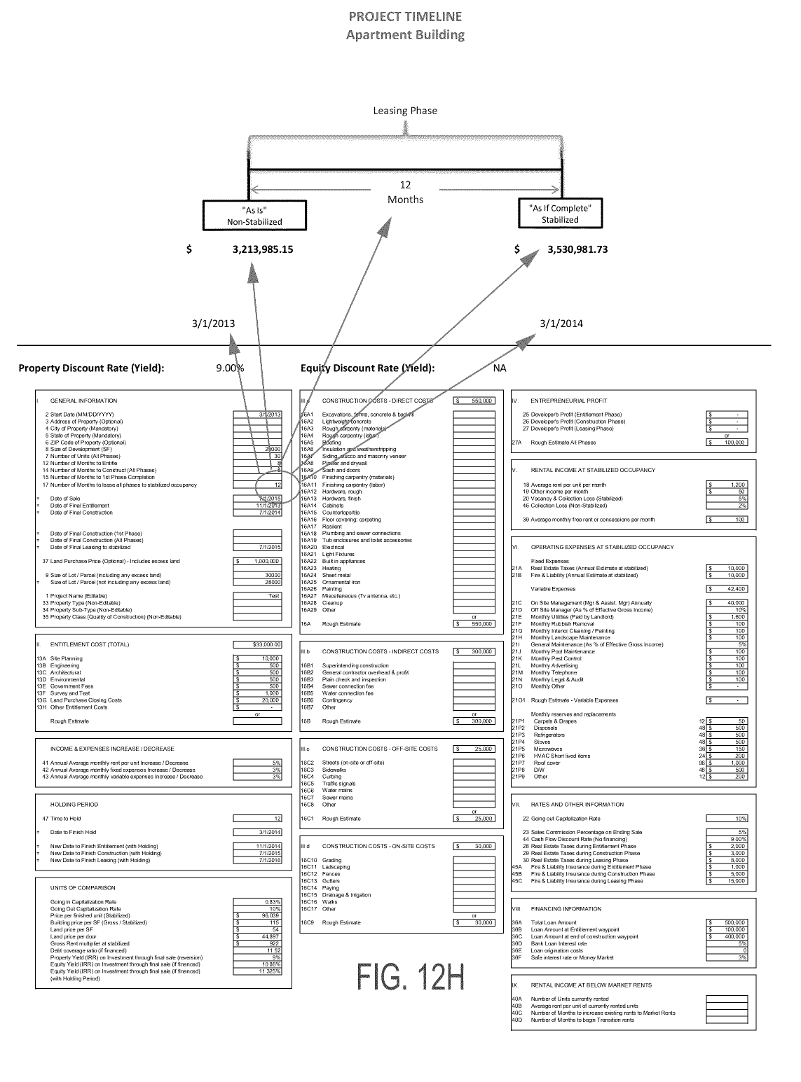

FIG. 12A shows the selection of a project type indicating an existing property that has already been developed and does not need remodeling but has not reached stabilized occupancy and/or stabilized market rent. The timeline used for valuation modeling in this scenario corresponds to timeline 308a shown in FIG. 3A or 308b of FIG. 3B. Selecting this model is shown by choice 324d shown in FIG. 3D. After the project type is selected, wizard questions are presented on a display, as shown in the example of FIGS. 12B-D. Some aspects may display only a portion of the wizard questions shown in FIGS. 12B-D. Answers to the wizard questions may be transferred and/or used to generate component of value boxes. An example of COV boxes is shown in FIG. 12E. COV values may be subsequently transferred to a discounted cash flow, an example of which is shown in FIG. 12F. The example discounted cash flow of FIG. 12F solves for the current “as is” value of the property.

FIG. 12G shows an example of a timeline graphic 1202 that may be presented on the user interface of a computer based on at least a portion of the wizard questions shown in FIGS. 12B-D. As shown, the “as is” non-stabilized value 1202a is derived from cell 1222 of FIG. 12F. By inputting/updating data in COV boxes 1220 displayed on FIG. 12G, (for example, any portion of the COV boxes of FIG. 12E may be presented in region 1220), the user can play “what if” by changing values in the displayed COV boxes. This results in changes to the timeline 1202 as described above with respect to, for example, FIG. 7B. An example of a “what if” scenario is shown in FIG. 12H. FIG. 12H shows the number of months to lease to stabilized occupancy is changed to twelve months. As a result of this change to the component of value box, both the “as is” non-stabilized value 1202a and the “as if complete” stabilized value 1202b are updated relative to FIG. 12G.

### Stabilized Properties

Current methodologies in valuing an existing property at stabilized occupancy capitalize the property's first year's expected net income into an indication of value. Capitalization divides a capitalization rate into the property's first year's stabilized net operating income (gross income less all fixed and operating expenses). The result is that market forecasts for the subject property may be hidden within this one capitalization rate. The slightest change in this rate can result in tens of thousands if not hundreds of thousands of dollars in changes to forecast values.

In some aspects, this reliance on a single capitalization rate can allow a user to input the capitalized value and release all the market's forecasts that are inherit in the capitalization rate and the resulting value indication. This can be accomplished by using the inventions reversed engineered feature or solving for the users own stabilized value by inputting his own forecasts.

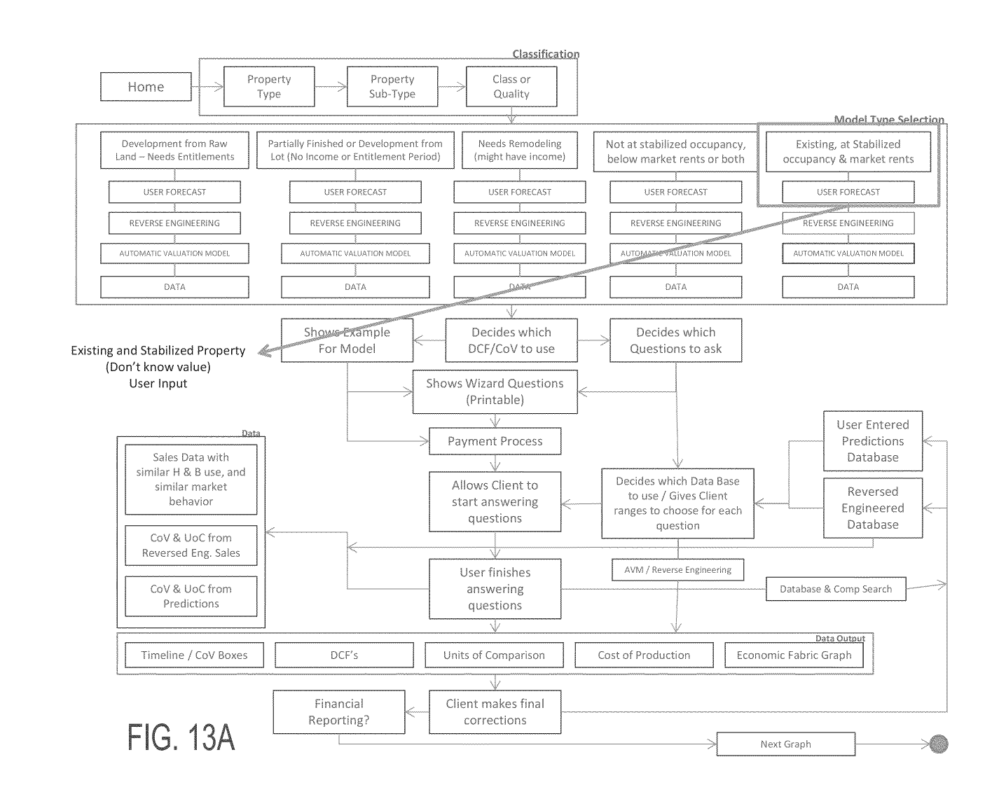

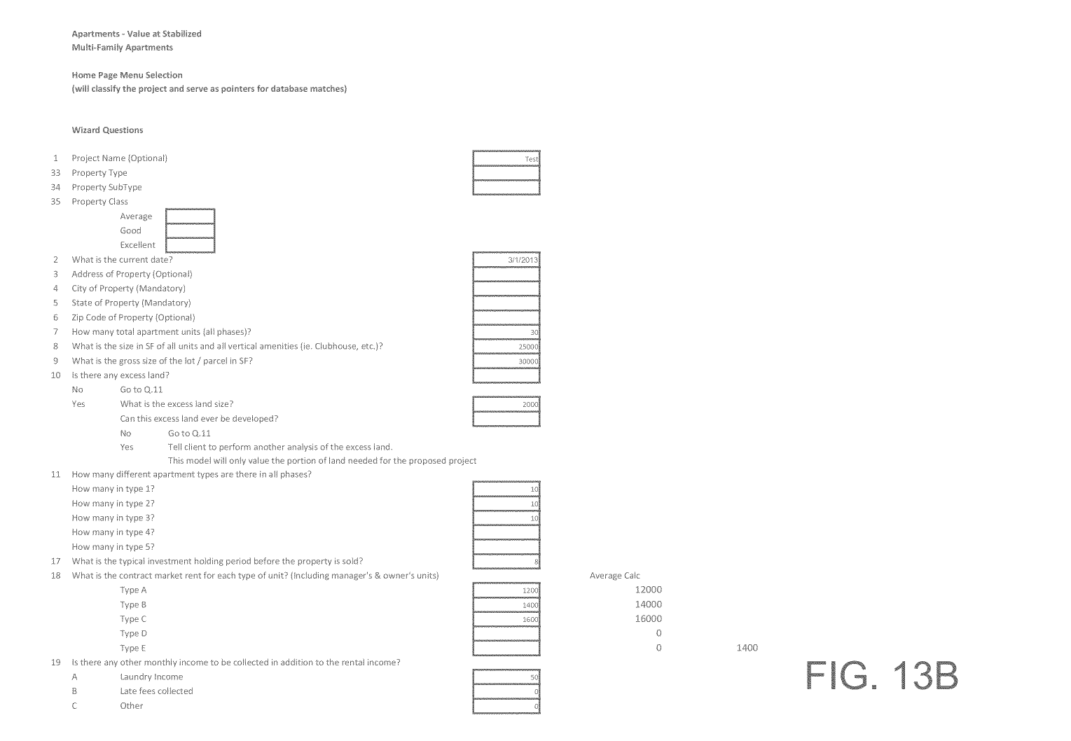

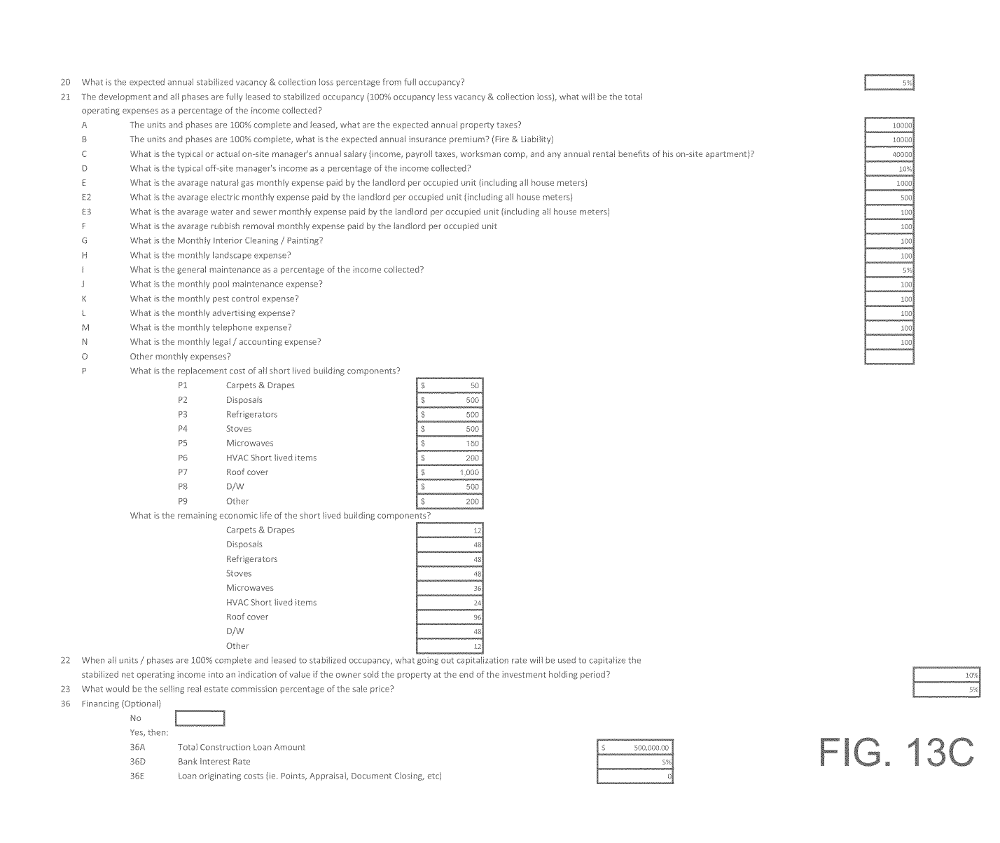

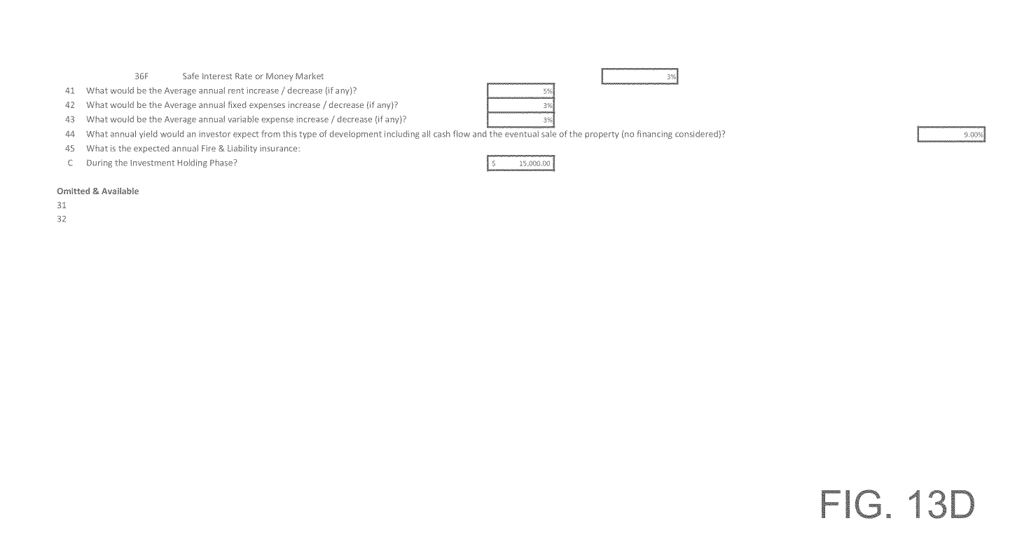

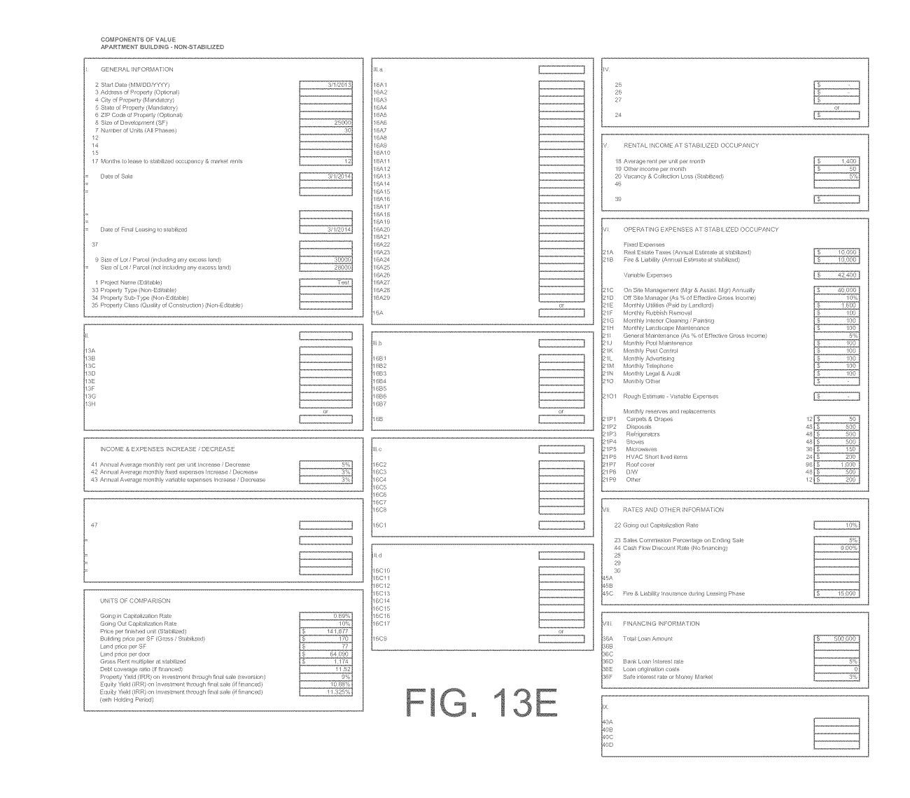

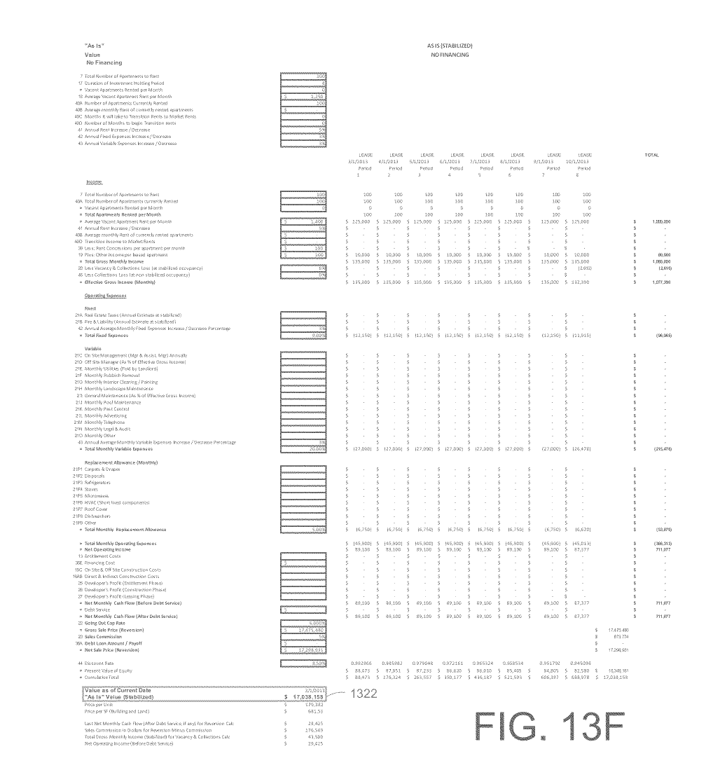

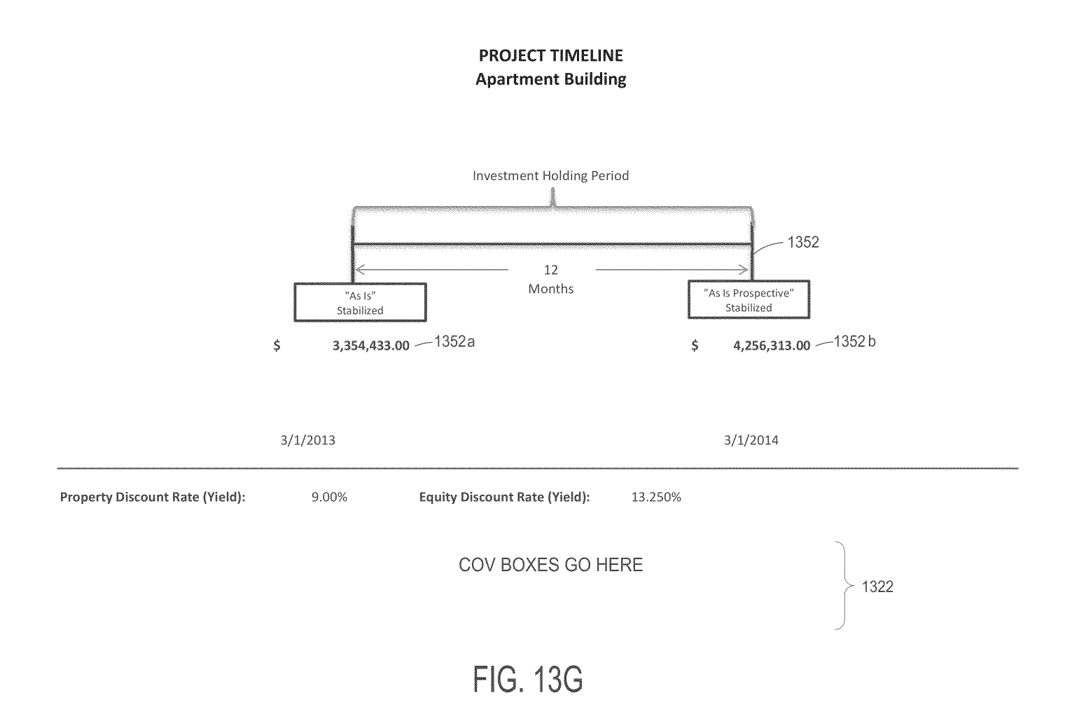

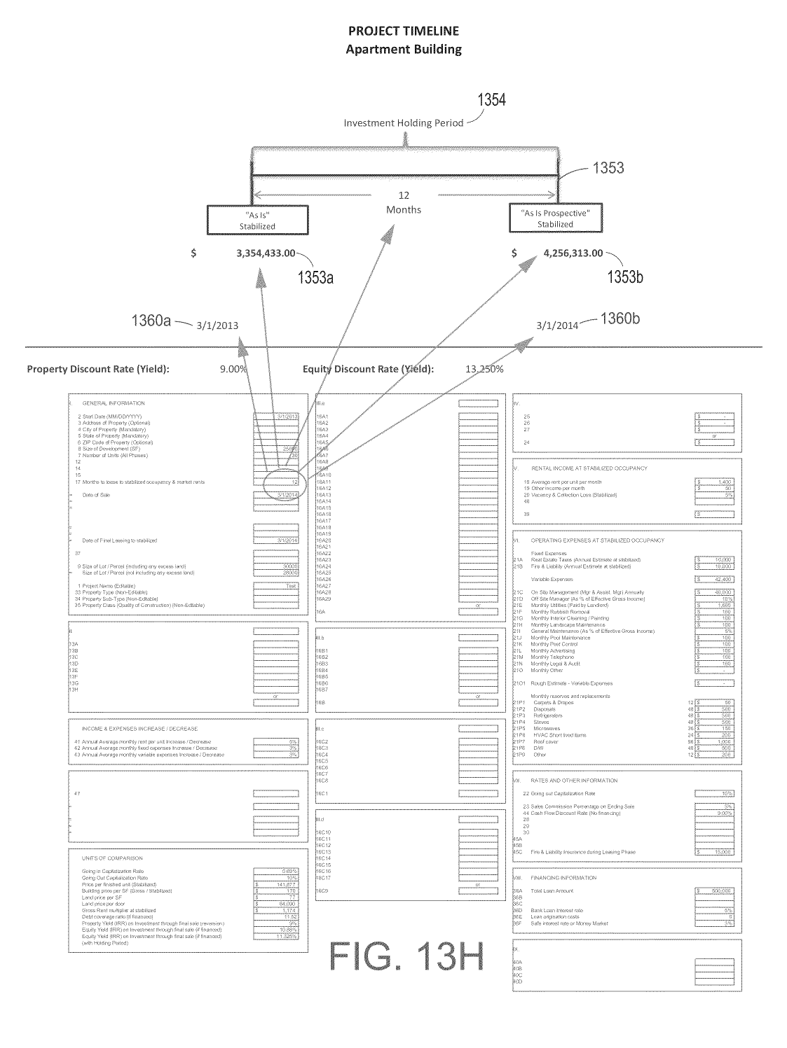

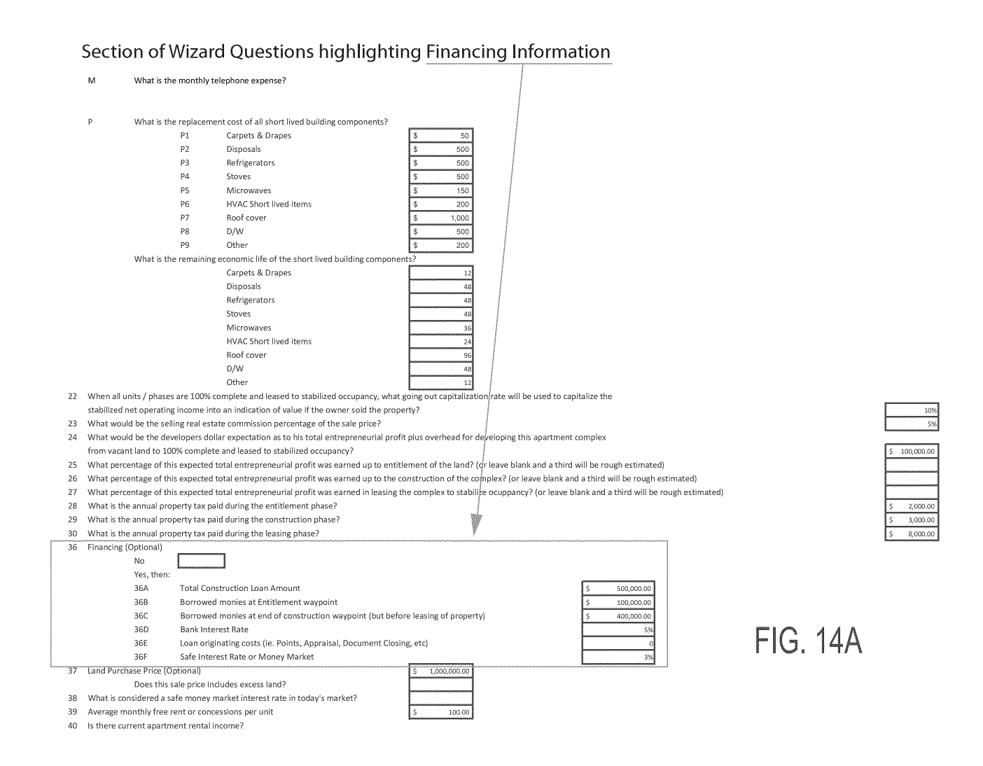

FIG. 13A shows the selection of a project type indicating the property that is already developed and does not need remodeling and has reached stabilized occupancy and stabilized market rents. This choice corresponds to selection 324e of FIG. 3D. In some circumstances, a user may not know a value of a property but can provide their own forecast to assist with a determination of value. In some aspects, wizard questions may be determined based on the project type selection. Examples of wizard questions for this project type are shown in FIGS. 13B-D. Various aspects may provide only a subset of the example wizard questions of FIGS. 13B-D, and may optionally provide additional wizard questions not shown.

Similar to the other project types discussed above, answers to the wizard questions may be transferred to or used to derive COV boxes, an example of which is shown in FIG. 13E. A discounted cash flow model, such as the one shown in FIG. 13F may be generated based on responses to the wizard questions of FIGS. 13B-D and the components of value in FIG. 13E. The example DCF model of FIG. 13F solves for a current “as is” value of the property, shown by cell 1322.

FIG. 13G shows an example timeline graphic 1352 that may be presented on a user interface of the user's computer. The “As Is” stabilized value 1352a shown on timeline 1352 is derived from cell 1322 of FIG. 13F. In some aspects, the “As is Prospective” Stabilized Value 1352b is derived from a direct capitalization of net operating income by the going out capitalization rate In some aspects, COV boxes, such as those shown in FIG. 13E, may be presented below the timeline graphic in region 1322 with the user's answers to the wizard questions displayed in the COV boxes. The user can play “what if” by changing the COV boxes in region 1322 which will subsequently change the timeline values, as discussed above with respect to other embodiments.

In some aspects, the user can change the “as is” stabilized value 1352a to another value. In response to receiving this input, the disclosed methods and system will iterate using the reversion value (initially $4,256,313), until the discounted cash flow generating the value 1352a equals the new inputted value. Iterating the reversion value is accomplished by changing the going out capitalization rate until the reversion value determined by the current iterating going out cap rate results in a discounted cash flow that produces the “as is” stabilized value 1352a that equals the new inputted value.

FIG. 13H illustrates modification of a COV box and its effect on the timeline graphic 1352 of FIG. 13G. As shown, the number of months of investment holding value is updated to twelve (12) months. This modification of the COV value causes the timeline display 1353 to update as well. One or more of the investment holding period 1354, and/or the “As Is” stabilized value 1353a and/or the “As Is Prospective” Stabilized value 1353b may be updated. The starting and/or ending dates for the holding period 1360a-b may be updated as well.

### Financing Scenarios

Market value should be analyzed based on a cash basis. Different financing scenarios and special tax benefits to an individual should generally not be considered in forming a property's market value. Once market value is estimated, the disclosed methods and systems provide for different financing and special tax benefits to the individual. This allows the user to understand whether the financing enhances the equity yield (financed) as opposed to the property yield (non-financed).

Some existing methods co-mingle financial scenarios into financial models to manipulate the property's market value. The disclosed methods and systems do not allow the user to co-mingle financing or special tax consideration into the DCF models. However, once all cash values are found, users are allowed to try different financing scenarios. The systems and methods automatically calculate a user's equity yield (the annual yield to equity invested when financed). In some aspects, this equity yield is displayed side-by-side with the property yield for easy comparison. This calculation does not change the property's value but instead iterates the DCF until equity yield is found based on the all cash basis value.

If the equity yield is below the property yield the loss in interest will impact the entrepreneurial profit (if a development project) which can render a development financially infeasible. Alternatively, the increased risk of the project may result in a lack of a competitive yield on the property (based on the type of risk being taken). In some aspects, the methods and systems will present a warning to the user indicating the presence of these negative impacts. The indications may take many forms. For example, a partial or complete sentence may be displayed on the project timeline indicating the equity yield is below the property yield. In some aspects, indications may be in color. For example, a green icon may be shown in proximity to the property yield and/or equity yield on the timeline graphic when the property yield is lower than the equity yield, while a red icon is displayed when the equity yield is lower than the property yield. In some aspects, text and color may be combined to indicate the condition.

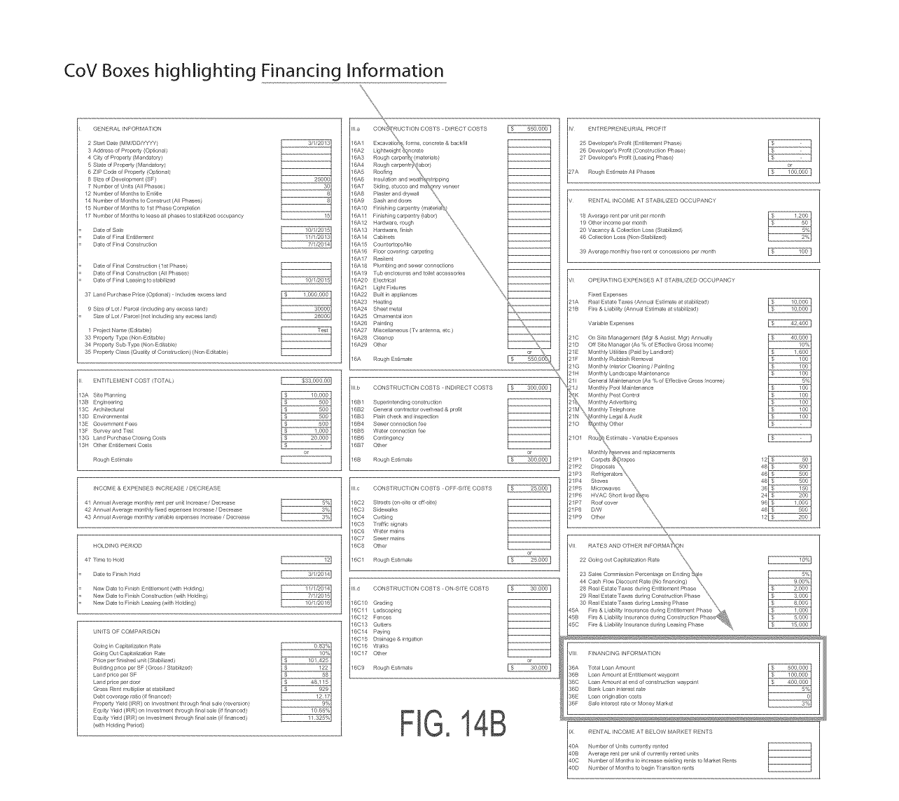

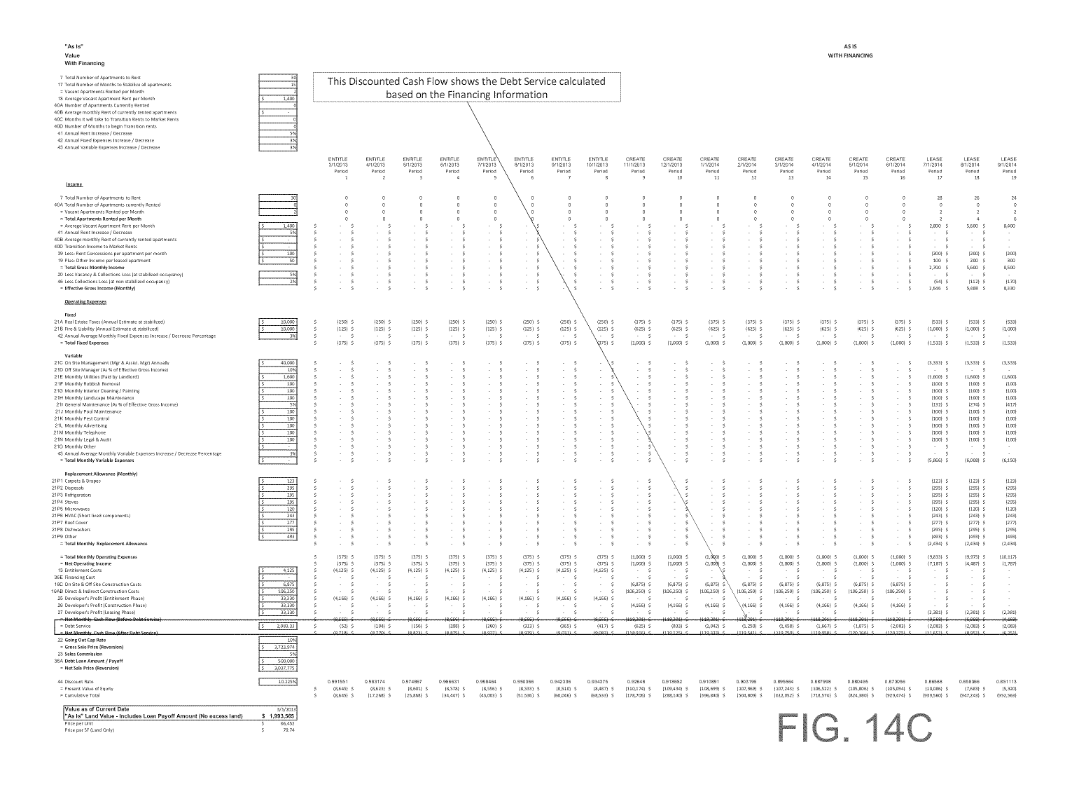

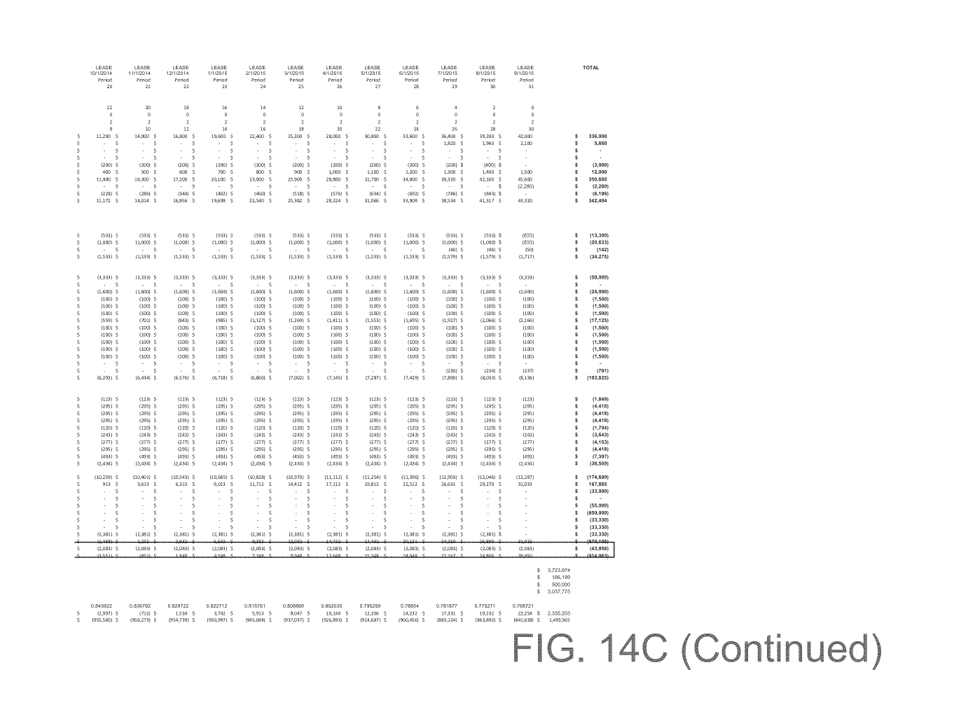

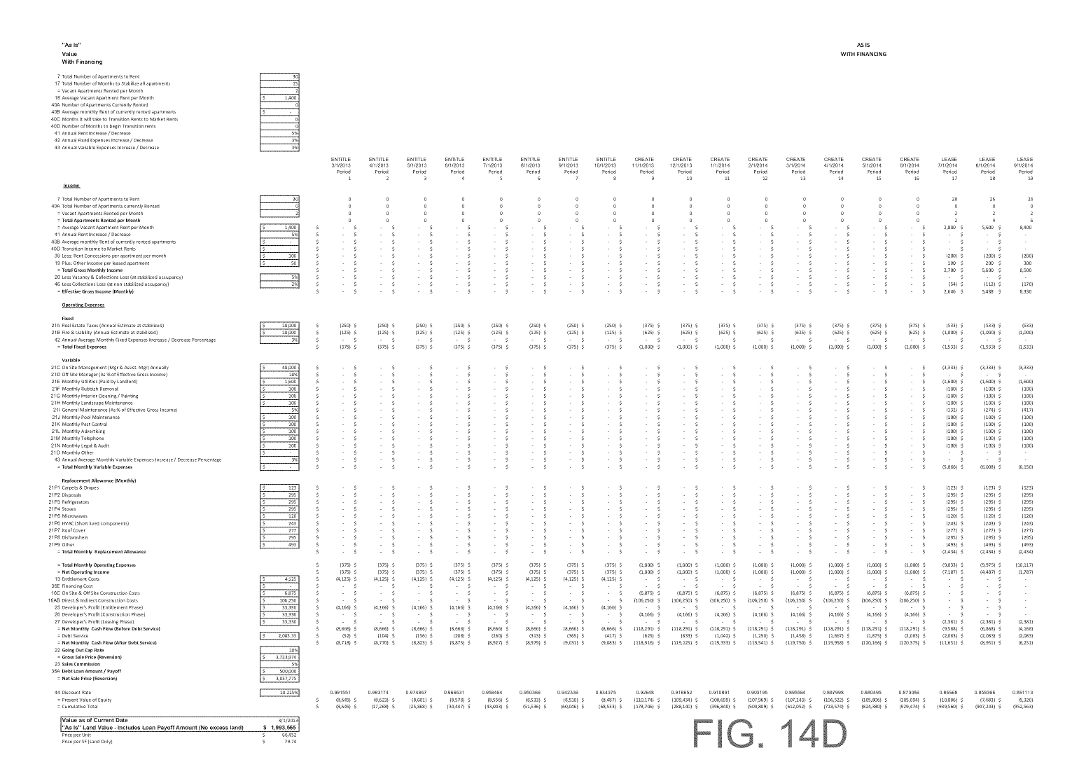

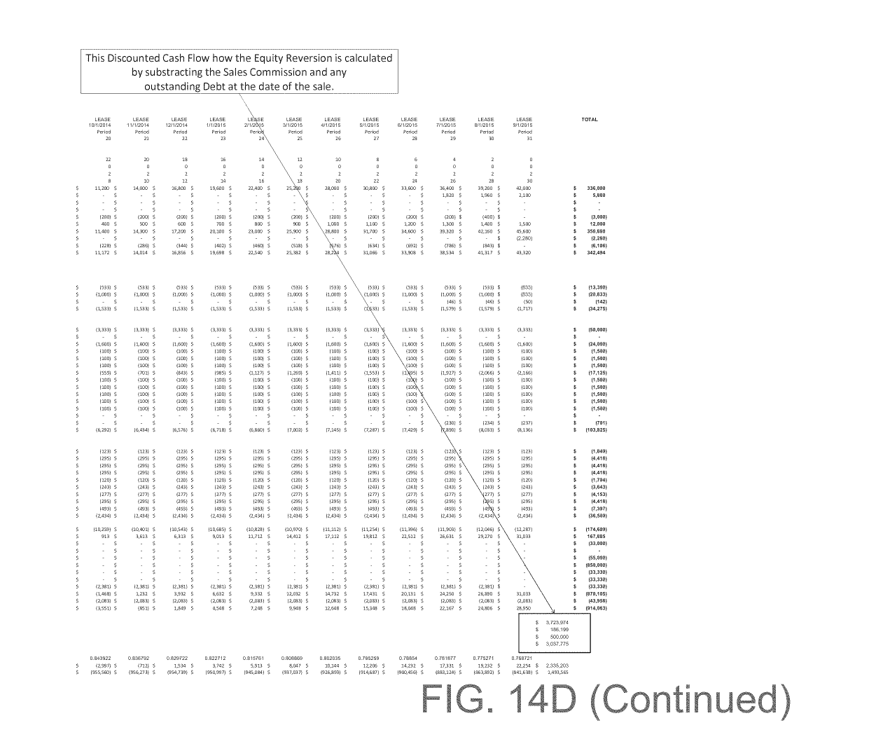

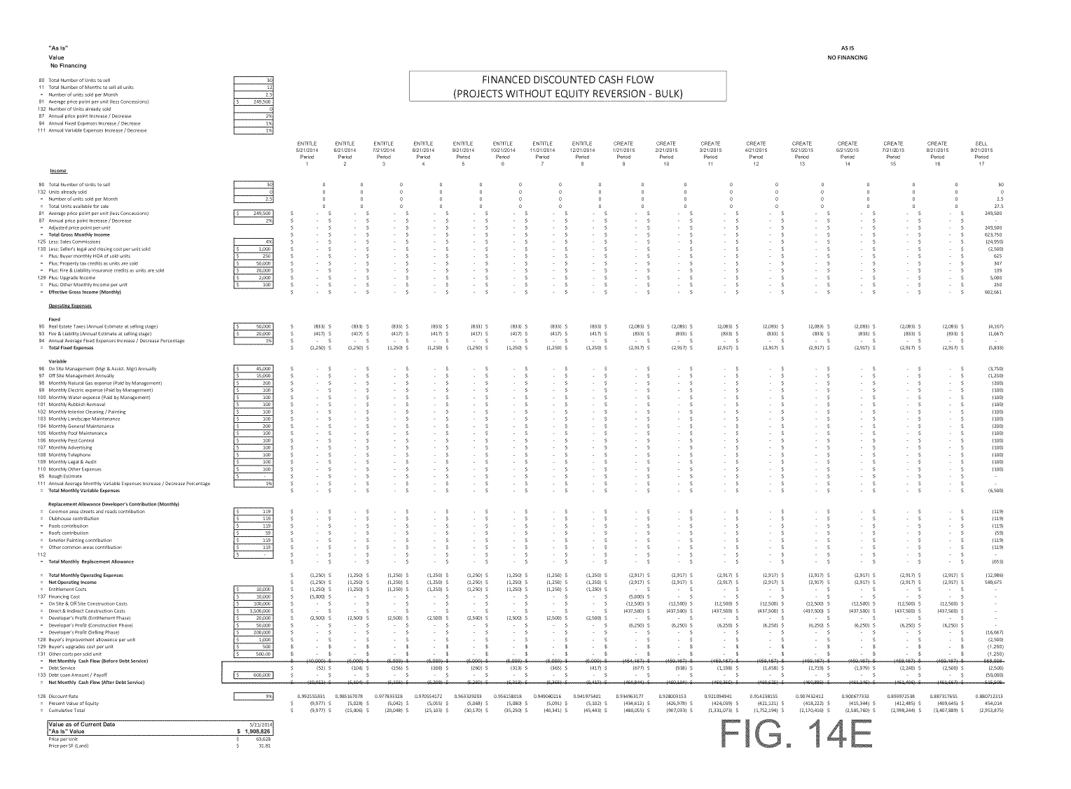

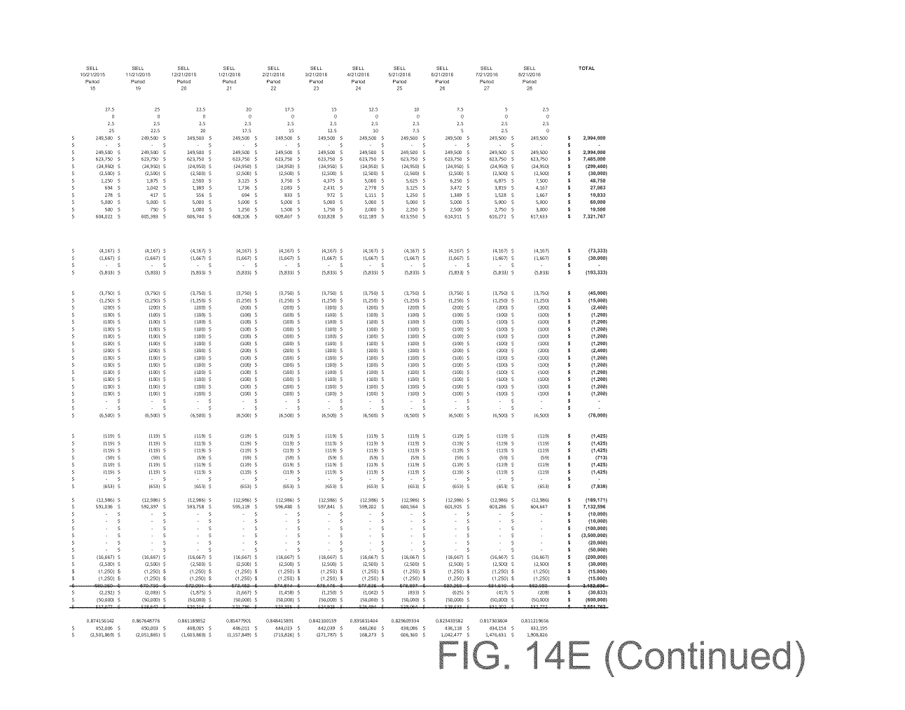

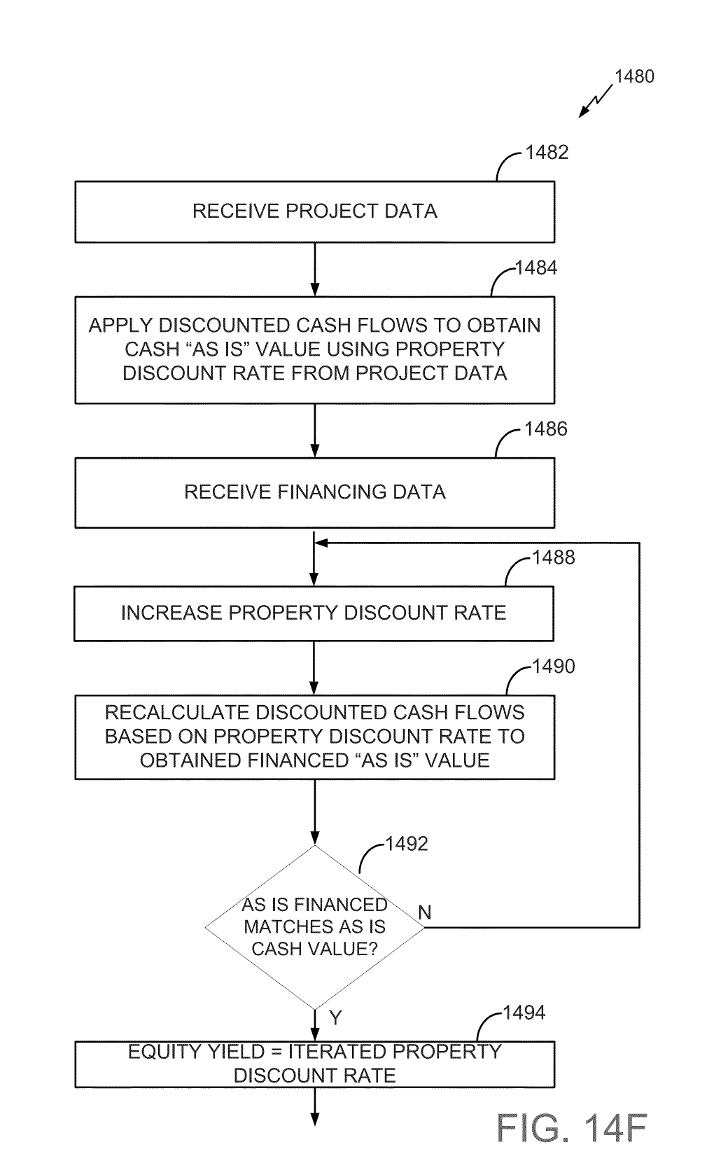

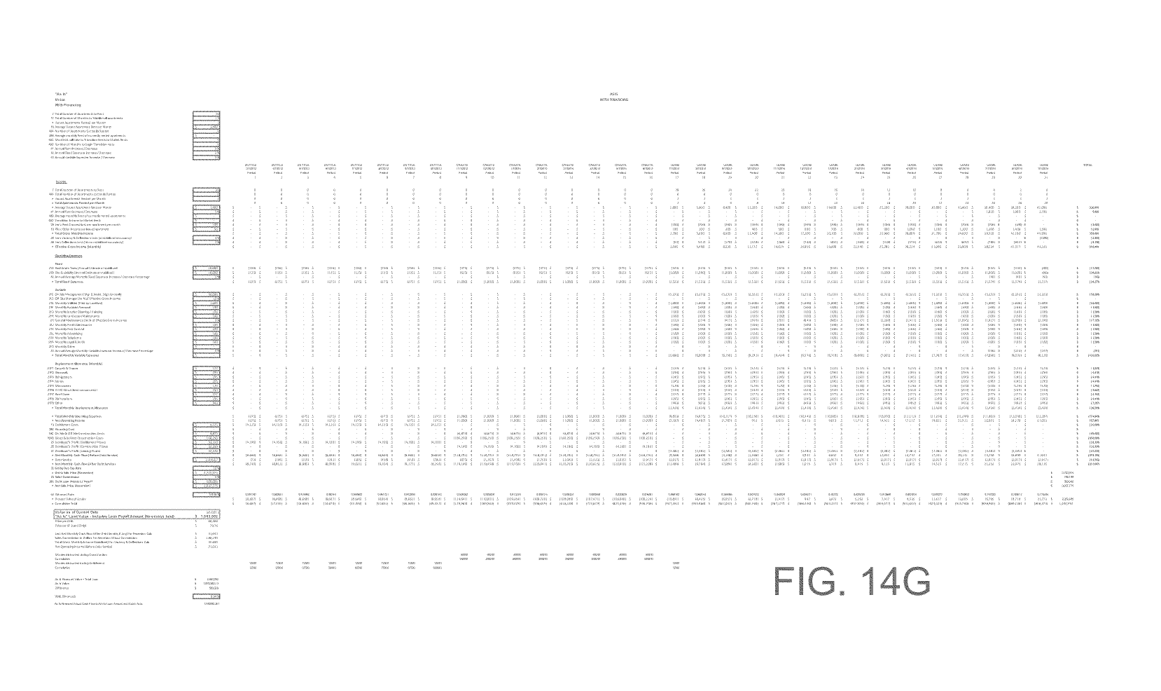

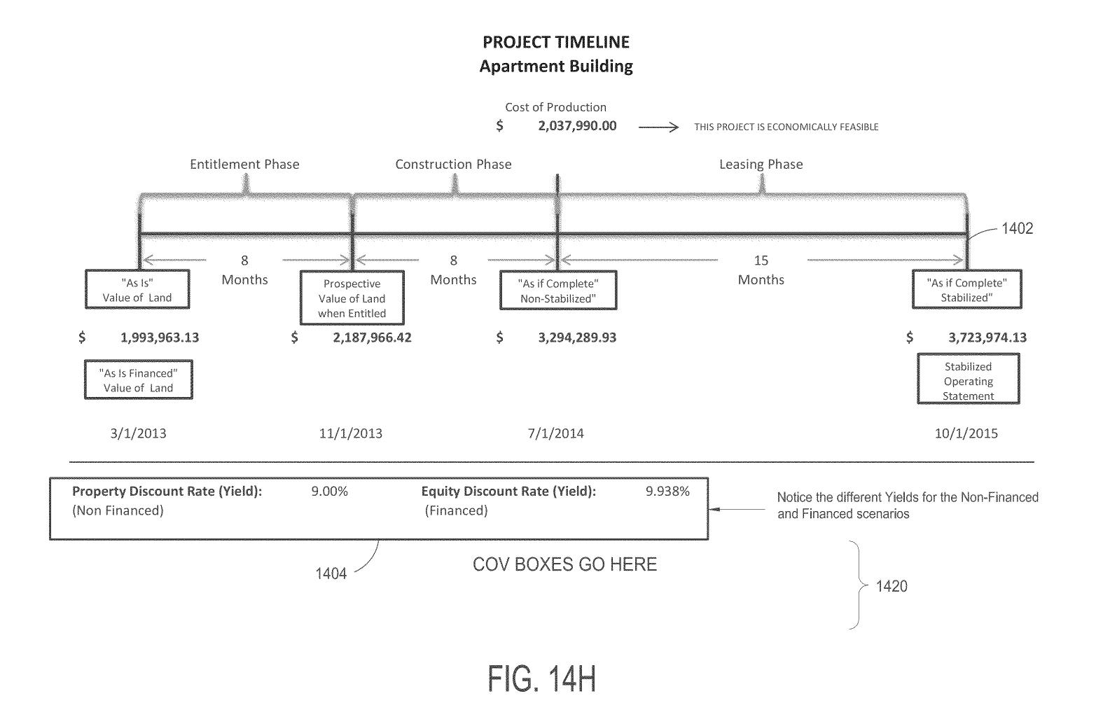

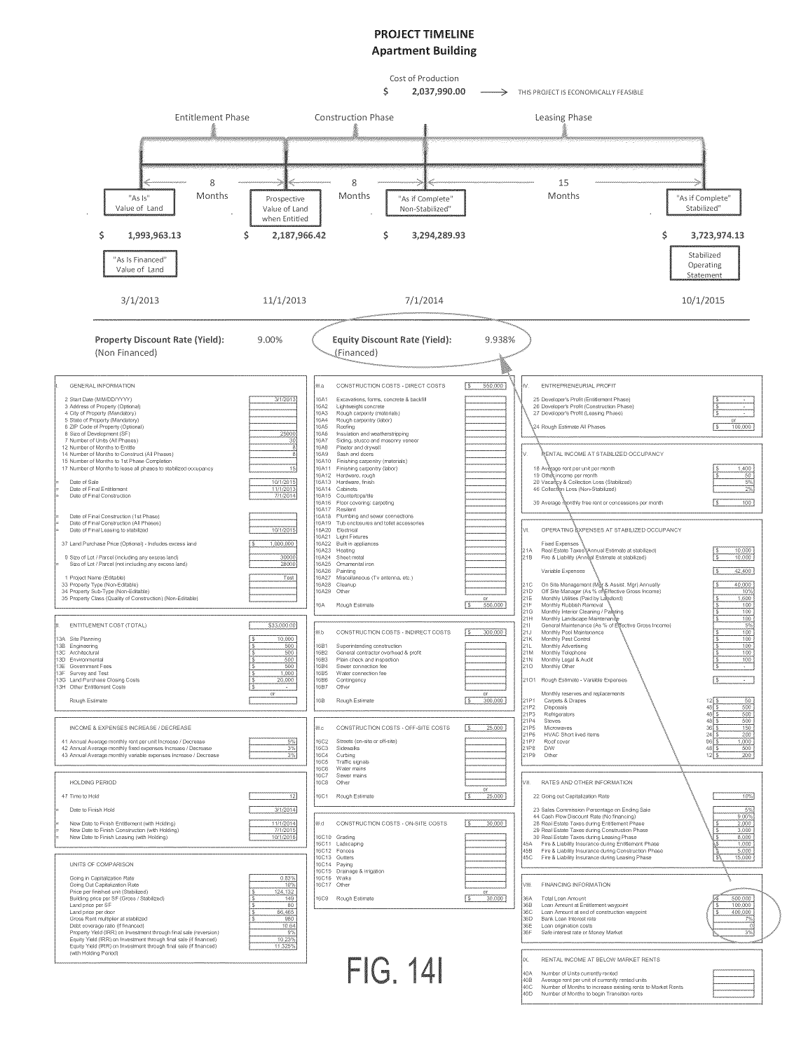

FIG. 14A highlights wizard questions previously shown in FIGS. 4A-D that receive input data relating to financing of the real estate project. In some aspects, the disclosed methods and systems allow the user to interject financing scenarios by answering financial wizard questions, such as those highlighted in FIG. 14A. The aspects described above may solve for values based on cash or cash equivalent (non-financed). The purpose of financing a property may be to increase the yield on equity invested. As in the aspects discussed above, answers to the financial wizard questions of FIG. 14A may be transferred to COV boxes, as shown in FIG. 14B, that are subsequently transferred to a DCF model, an example of which is shown in FIG. 14C. The DCF model of FIG. 14C inserts debt service payments after net operating income indicating a cash flow annuity. Remaining debt is subtracted from a single property ending sale price (reversion) indicating the equity received after loan balance payoff, as shown in the example of FIG. 14D. In the case of a multi property development (condos, lots, etc.), the outstanding debt may be paid off proportionately as the individual properties are sold off during the absorption period, an example of which is shown in FIG. 14E.

Once the equity cash flow annuities and the equity reversion cash flow are established, in the case of a single property type, the equity yield is iterated based on the non-financed property value established earlier.

FIG. 14F illustrates one example of a method of determining equity yield. In some aspects, the method 1480 may be performed by the web server(s) 170a-c.

In block 1482, initial project data is received. The initial project data may be received via the methods discussed above. For example, the user may select a project type and be presented with wizard questions that prompt the user to enter data about a subject property.

In block 1484, a discounted cash flow is determined to solve for an “as is” value of the project on a cash basis. The discount rate used in block 1484 may be obtained from a user via wizard questions or in some aspects a default discount rate value may be used.

The “as is” value referenced in block 1484 and generally in process 1480 may vary based on the valuation model being applied. Generally, with reference to FIG. 3A, the “as is” value is the left most value for the particular valuation model/module being applied. For example, in module 1 of FIG. 3A, the “as is” value is the “as is” value of the unentitled land. When using module 2, the “as is” value referenced in block 1484 would be the “as is” value of the land at entitlement. When valuation module 4 is used, the “as is” value of block 1484 would be the “as is” complete non-stabilized value. With valuation module 5, the “as is” value of block 1484 would be the “as if Complete” at stabilized occupancy value.

With reference to the modules of FIG. 3B, the results are similar, except when using valuation module 4, the “as is” value is the “bulk” or “wholesale” value of the developed property, as shown in timeline 308b.

In block 1486, financing data is received. The financing information received in block 1486 may include any of the financing information shown in FIGS. 14A-B. In block 1488, the discount rate is increased relative to the discount rate used in block 1484. The amount the discount rate is increased in block 1488 may vary by embodiment. Smaller increases will result in closer matches between the as is financed value and the cash value in decision block 1492 below. Larger increases will reduce the number of iterations necessary to achieve a matched value. Note that the size of the discount rate increase in block 1488 may be tuned in concert with the “match” function in decision block 1492, in that larger discount increases require more tolerance in defining a match between the “as is” financed value and the cash value.

In block 1490, discounted cash flows are determined using the increased discount rate of block 1488. The discounted cash flows of block 1490 solve for an “as is” financed value. As discussed above, the “as is” value depends on the module (from FIG. 3A-B) being used for valuation modeling. In block 1492, the “as is” financed value determined in block 1490 is compared to the “as is” cash value determined in block 1484. If the “as is” financed value matches (or is within a numerical range) of the “as is” cash value, then the equity yield is determined to be the current discount rate. If the “as is” cash value and the “as is” financed value do not match, method 1480 returns to block 1488 where the discount rate is increased. The discounted cash flows are determined again in block 1490, and process 1480 iterates until a discount rate that causes the “as is” cash value to “match” the “as is” financed value is found. The equity yield determined by process 1480 may be presented on a display. For example, the equity yield determined by process 1480 is shown below with respect to FIG. 14H. However, the method of determining an equity yield shown in FIG. 14F is not limited only to FIG. 14H but may be used with any embodiment disclosed herein that displays an equity yield.

The equity yield presented to the user may indicate the present value of the cash flows plus the initial loan balance that will equal the non-financed value, as shown in FIG. 14G.

The yield spread between the property yield (non-financed) and the equity yield (financed) will indicate to the user the risk/benefit of financing the property based on the terms of the lender. An example timeline 1402 showing the yield spread 1404 is shown in FIG. 14H. In some aspects, component of value boxes, such as those shown in FIG. 14B, may be presented below the timeline shown in FIG. 14H. In some aspects, the COV boxes are displayed in region 1420 of FIG. 14H. The COV boxes allow a user to enter updated values for particular components of value. In response to the entry of new data, the methods and systems disclosed will automatically update the timeline values dependent on the modified components of value. This allows the user to perform “what if” scenarios, trying different financing scenarios that instantly change the equity yield on the timeline graphic. An example “what if” scenario is shown in FIG. 14I. When satisfied, the user can print the DCF model that incorporates financing.

### Economic Fabric Graph (EFG)

Current methodology endorsed by the CCIM (Certified Commercial Investment Member) and the Appraisal Institute give an example of how to calculate intrinsic value of an income producing property with an asking price of $1,000,000. The investor is able to find an alternative investment of similar risk yielding 7% annually (also used as the discount rate). The property will be held for four years and then sold. The net operating income (cash flow) for each year and the expected ending sale price (reversion) is illustrated by the CCIM as follows:

| Year | Cash Flow |
|---|---|
| Initial Investment (asking price) | ($1,000,000) |
| 1 | -0- |
| 2 | $50,000 |
| 3 | $60,000 |
| 4 cash flow + sale proceeds | $1,800,000 |
| Net present value (NPV) | $1,468,861 |

This illustration suggests the property has an intrinsic value of $1,465,861 and is advising the investor to purchase the property for $1,000,000 because the purchase price is below the intrinsic value and “looks like a good value opportunity.” This methodology is misleading and offers poor advice in purchasing the property. This is because the methodology is basing its recommendation on a faulty intrinsic value. This example hides the last year cash flow with the ending sale price proceed. If you allocated this last year proceeds, logic would dictate the 4th year's cash flow would be $70,000 (2nd year $50,000, 3rd year $60,000). Subtracting $70,000 from 4th years total proceeds of $1,800,000 leave $1,730,000 as the ending price sale proceeds. Consequently this ending sale price of $1,730,000 indicates a going out capitalization rate of 4.046 (cash flow divided by ending sale price). This ending sale price is simply a guess by the analyst and consequently over states the intrinsic value when discounting the cash flow and the ending sale price by the investor's discount or risk rate of 7%.

The disclosed methods and systems do not guess at the ending sale price but instead capitalize the 4th years $70,000 cash flow by the discount or risk rate of 7%. Using this new methodology indicates an ending sale price of $1,000,000 ($70,000/0.07 cap rate). Calculating the present value of the cash flow and the present value of the reversion at the 7% discount rate indicates an intrinsic value of $908,952 not $1,465,861.

Present Value

| | | |
|---|---|---|
| 1^{st} Year | | -0- |
| 2^{nd} Year | $50,000 × 0.87344 = | $43,672 |
| 3^{rd} year | $60,000 × 0.81630 = | $48,978 |
| 4^{th} year | $70,000 × 0.76290 = | $53,402 |
| 4^{th} year | $1,000,000 × 0.76290 = | $762,900 |
| Intrinsic Value (current) = | | $908,952 |

The buyer should now be advised he is buying the property for $1,000,000 but the intrinsic value is $908,952.

If the current market value for this property is $1,000,000 the buyer is paying, than the market is anticipating the ending sale price at $1,118,958 based on the buyers risk estimate of 7% annual yield on this property. The present value of the annuity (2 year $50,000, 3rd year $60,000, 4th year $70,000) and the present value of the ending sale price of $1,118,950 at a 7% discount rate equals $1,000,000 or the property's current market value. Also, the present value of the same cash flows and the present value of the intrinsic value ending sale reversion price $1,000,000 also indicates a 7% annual yield.

In the CCIM's estimate of intrinsic value of $1,465,861, the only way this could occur is if the 4th year cash flow was $118,000. Using the 7% capitalization rate on this 4th years cash flow indicates an intrinsic ending value (reversion) of $1,685,714 ($118,000/0.07). Consequently, calculating the present value of the cash flows and the present value of the reversion at the 7% discount rate indicates an intrinsic value of $1,465,861 only if the 4th years flow is $118,000.

Present Value

| | | |
|---|---|---|
| 1^{st} Year | | -0- |
| 2^{nd} Year | $50,000 × 0.87344 = | $43,672 |
| 3^{rd} year | $60,000 × 0.81630 = | $48,978 |
| 4^{th} year | $117,805 × 0.76290 = | $89,889 |
| 4^{th} year | $1,683,214 × 0.76290 = | $1,284,124 |
| Intrinsic Value (current) = | | $1,465,861 |

Therefore for the intrinsic value to be $1,465,861, as the current methodology suggests, the 4th year cash flow has to $118,000. This 4th cash flow is not consistent with years 2 and 3 cash flow of $50,000 and $60,000 respectively. However if $118,000 cash flow is the 4th years cash flow and the buyer can purchase the property now for $1,000,000, he would be well advised to buy this property.

The disclosed systems and methods calculate intrinsic value on a consistent basis by always using the yield rate as the going out capitalization rate. In contrast, current methodologies allow the analysis to use any going out capitalization rate to manipulate the ending sale price (reversion). These current methodologies can be misleading to the user of the analysis.

In some aspects, the disclosed systems and methods present a graph of an economic fabric of a property under review on a user interface of a computer. In some aspects, the economic fabric graph may be displayed for single properties at stabilized occupancy and market rent. Existing or proposed finished commercial or residential properties that are introduced into the market place are entering specific markets where they are built. A property's specific market is made up of users that will use the property for whatever use satisfies demand for that market. The ability of users to pay rent for properties in a specific market is not necessarily determined by the costs of the building and land but instead by the tenant's ability to pay rent based on the demographics personal income (residential) and personal business income generated by retail, office or industrial tenants (commercial). This means each specific market has an economic fabric that is based on property users demographics, supply and demand, and the ability of the specific market to generate business income from within and outside the specific market. If rent is determined by specific market demographics and the resulting rentals determine property values, than property value should follow the economic fabric of the property's specific market. Many times this is not the case. Property values can significantly detach from the economic fabric of its specific market because market participants (buyers and sellers) have overly optimistic future benefit expectations for the properties. Although comparable sales confirm market values for these properties, the hidden risks of property sale prices detaching from their market economic fabric can go unnoticed until it is too late, as we saw happen in the mid 2000's in the United States and Europe. Market values that detach from their markets economic fabric are entering a bubble phenomenon.

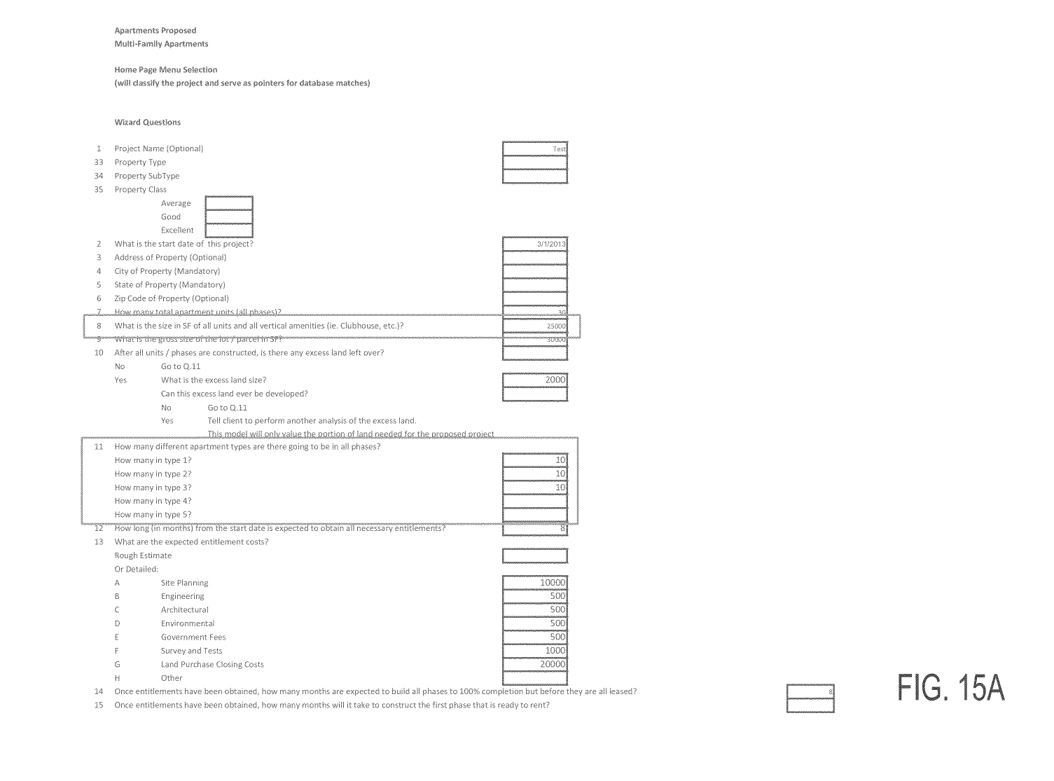

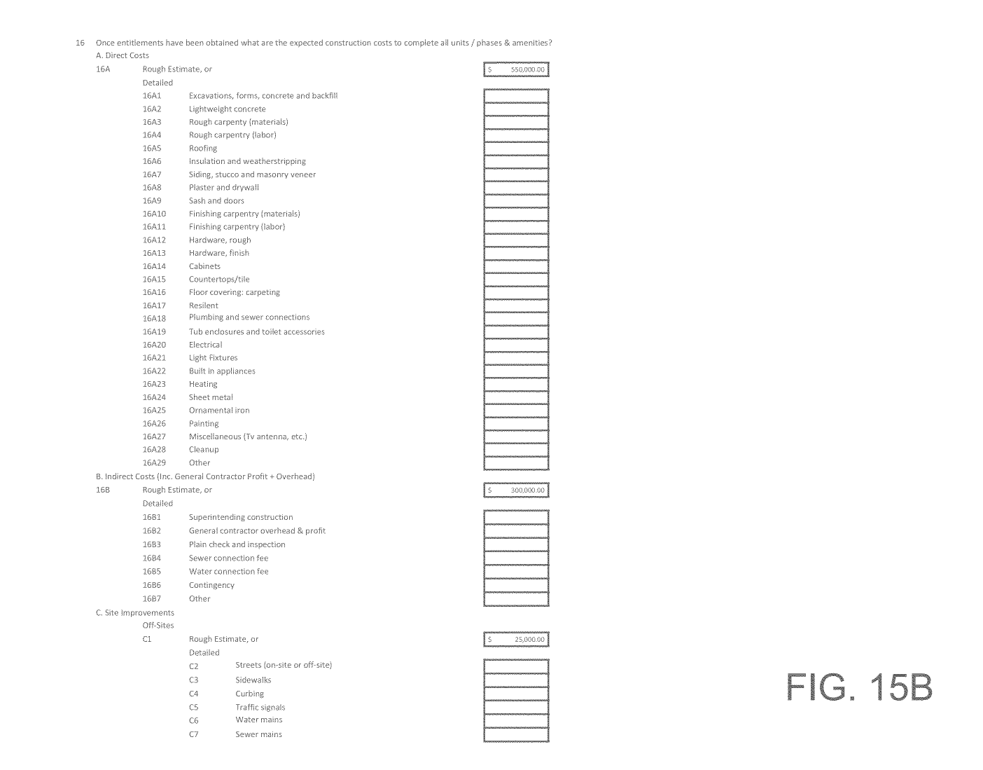

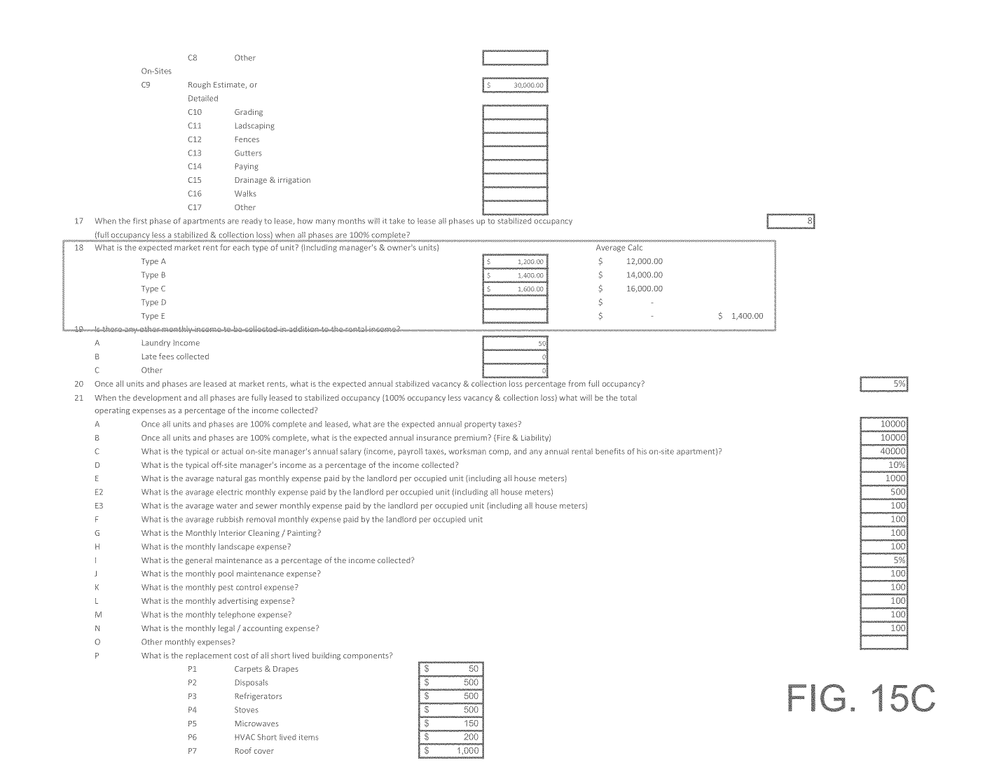

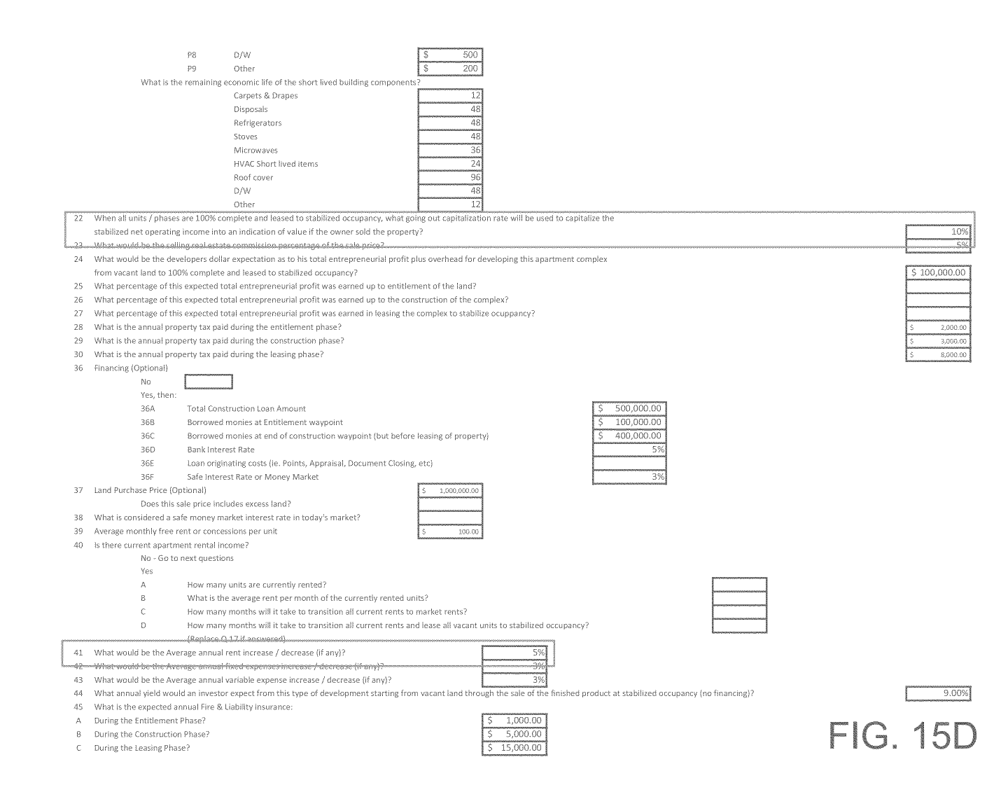

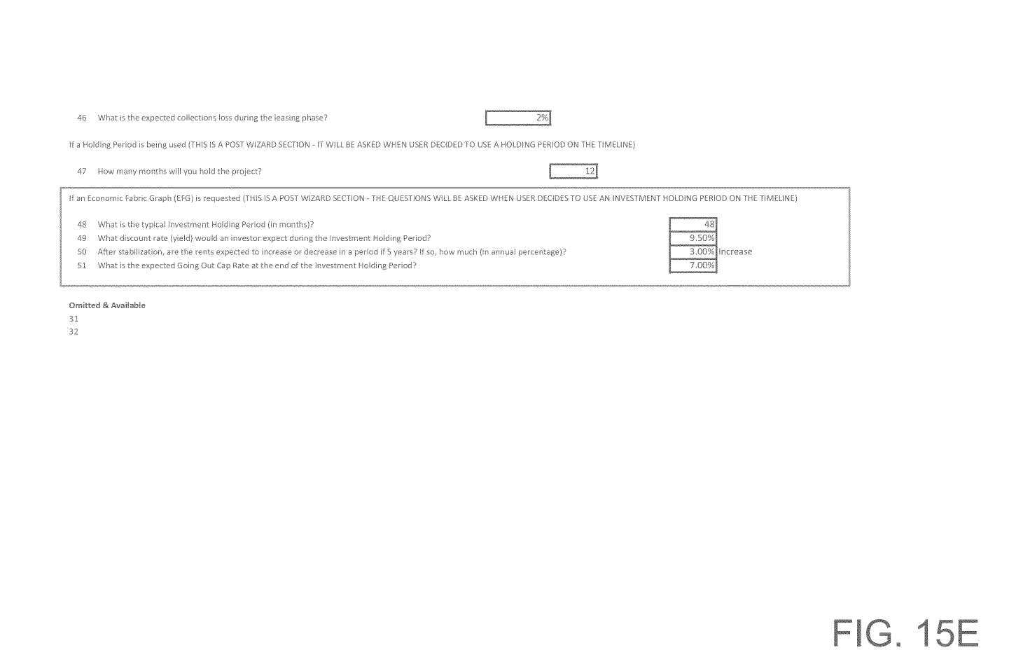

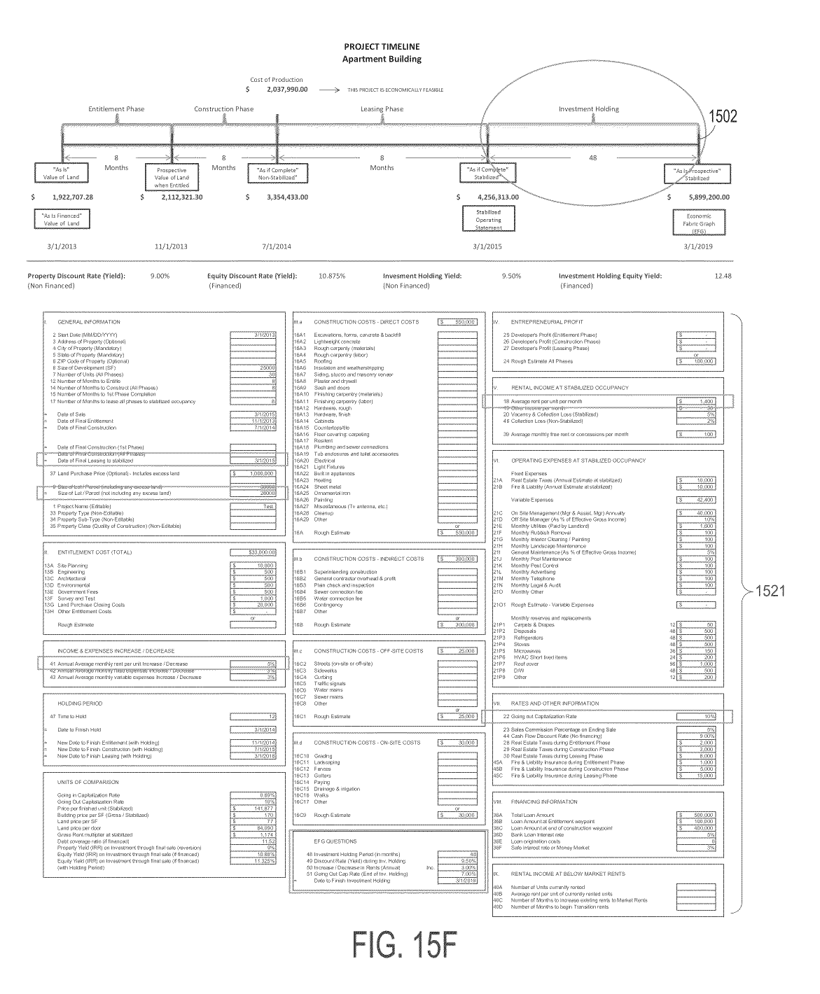

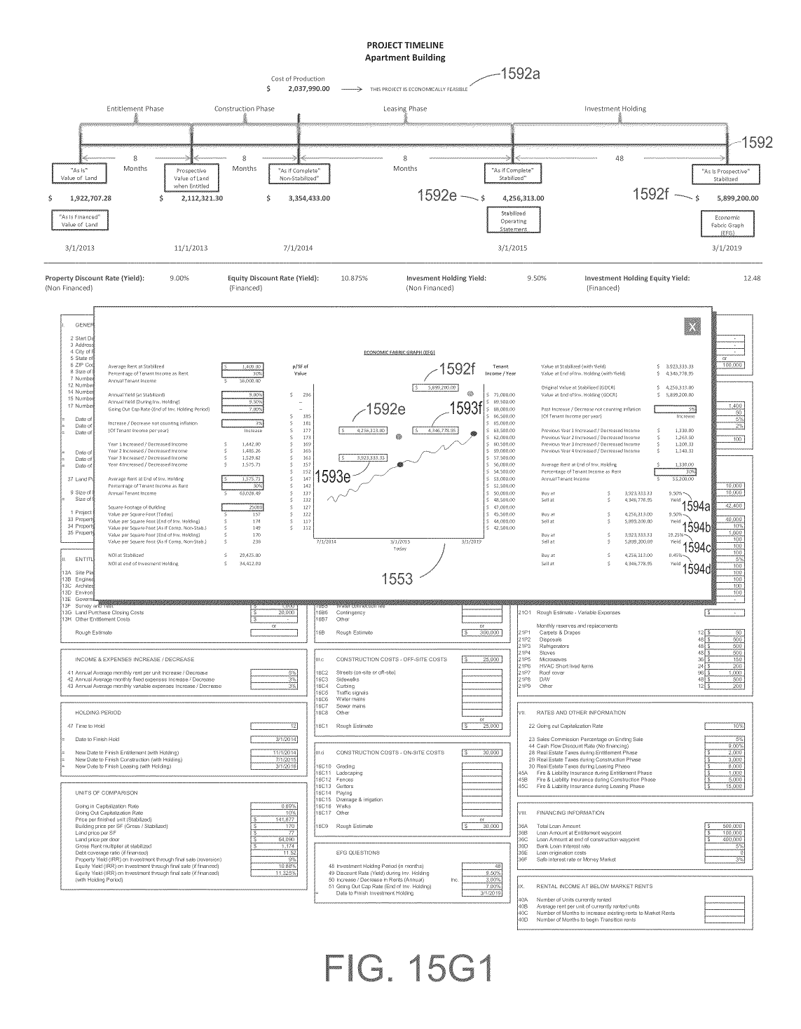

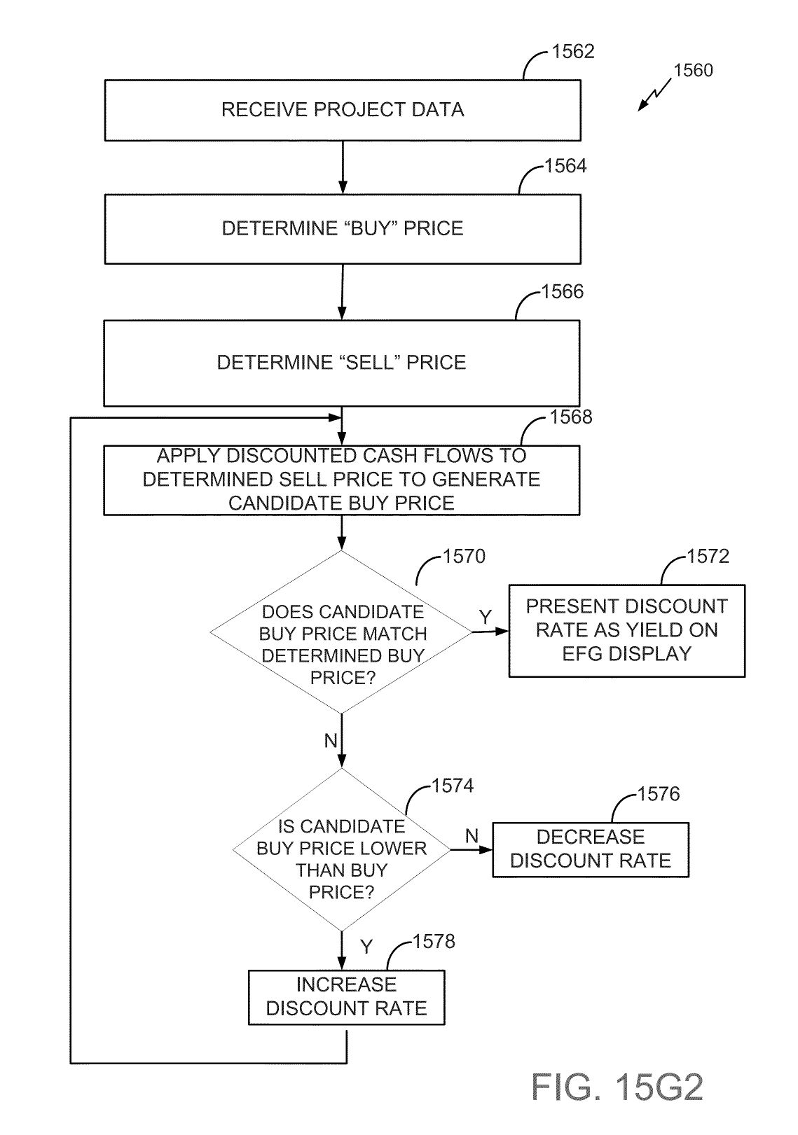

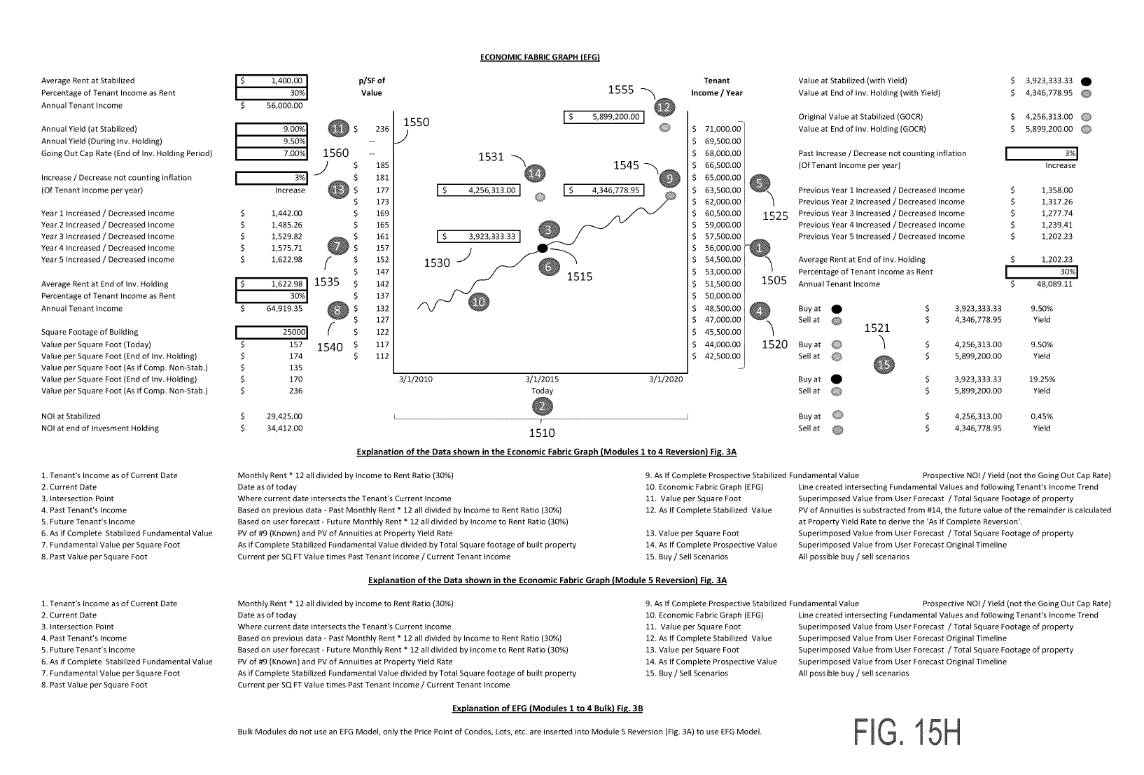

Some aspects disclosed display indications and/or a graph of an economic fabric for a property's specific market. First, as discussed above with respect to FIG. 3D, users will indicate the property type and current state of development. As discussed previously, wizard question may be determined based on the property type. Example wizard questions are shown in FIGS. 15A-E. Wizard questions that may be used to construct the economic fabric graphic are shown in FIGS. 15A-E. After answers to the wizard questions are received, a timeline value graphic and the economic fabric graphic may be presented on a user interface of a computer.

FIG. 15F shows an example timeline graphic 1502. Component of value boxes 1521 are shown in FIG. 15F below the timeline graphic 1502. FIG. 15F highlights at least some individual wizard questions/answers that may be applicable to an economic fabric graph via the use of boxes.

FIG. 15G1 shows one implementation of an economic fabric graph 1553 presented on a user interface of a computer. For modules 1-4 (FIG. 3A), the far right value or “as if complete” value at stabilized occupancy is inserted into the EFG model at 1531. This value at 1531 will have a reversion value at the end of a five year (in the illustrated aspect) investment holding period 1555. The value at 1555 is determined in some aspects by subtracting the PV of the expected annuity that occurs during the investment holding period between the years Mar. 1, 2015 and Mar. 1, 2020. After the PV subtraction occurs from the “as if complete” stabilized value 1531, the future value of the remainder is calculated at the users imputed property yield rate (9.5%) which derives a reversion value at 1555. Next, the intrinsic reversion value is determined 1545 by capitalizing the last annual net operating income as of Mar. 1, 2020 by the user's previously imputed property yield rate (9.5%). Lastly, the “as if complete” intrinsic value at stabilized 1530 is calculated using the present value of the annuity that occurs between the five year investment period (Mar. 1, 2015 to Mar. 1, 2020) applying the user's property yield (9.5%) estimate and the present value of the intrinsic value reversion 1545 at the user's property yield rate (9.5%). The total of these two present value calculations will indicate the “as if complete” intrinsic value 1530.

Drawing a line between value points at 1530 and 1545 indicates the economic fabric or equilibrium line for the subject property's specific market during the investment holding period (Mar. 1, 2015 to Mar. 1, 2020). FIG. 15G1 also illustrates that one or more yield values 1594a-d may be displayed with an EFG. The yield values 1594a-d correspond to four combinations of buying price (being either the current natural or as is” values, and selling price (being either the reversion of the current market price or the reversion of the current natural value). To obtain the yield for each combination, discounted cash flows based on the applicable reversion value (market “as is” value reversion or natural value reversion” are iterated using a changing discount rate until the target “sales” price (“as is” value or natural value) is obtained.

FIG. 15G2 is a flowchart of a method for determining yield values on an economic fabric graph. Method 1560 may be performed, in some aspects, by one or more of the web server(s) 170a-c. In some aspects that do not utilize a web based model to provide the user interfaces presented herein, method 1560 may be performed on a desktop or personal computer or tablet being run by a user, as discussed above.

In block 1562, project data is received. For example, in some aspects, project data may be received via one or more of the wizard questions relating to a subject property as shown in FIGS. 15A-E. In block 1564, a “buy” price for the yield determination is determined. As discussed above, in some aspects, yields may be determined for a buy price equivalent to the market value determined via the components of value, such as value 1592e, or the yield may be based on a buy price equivalent to the natural value at the time the sale is contemplated, such as value 1593e. In some aspects, the natural value(s) are determined based on wizard questions and/or data received in block 1562. For example, a current property rent and/or an expectation of future rental income growth may be used to determine the natural value(s).

In block 1566, a sale price for the calculated yield is determined. As discussed above, yields may be calculated for a sale price equivalent to the reversion of the “as is” value, such as value 1592f, or based on a sale price equivalent to the reversion of the natural value, such as value 1593f. As discussed above, the “as is” value that may be used as a sell price in block 1566 varies based on the valuation model/module being applied. Generally, with reference to FIG. 3A, the “as is” value of block 1566 is the left most value for the particular valuation model/module being applied. For example, in module 1 of FIG. 3A, the “as is” value is the “as is” value of the unentitled land. When using module 2, the “as is” value referenced in block 1566 would be the “as is” value of the land at entitlement. When valuation module 4 is used, the “as is” value of block 1566 would be the “as is” complete non-stabilized value. With valuation module 5, the “as is” value of block 1566 would be the “as if Complete” at stabilized occupancy value.

With reference to the modules of FIG. 3B, the results are similar, except when using valuation model/module 4, the “as is” value of block 1566 is the “bulk” or “wholesale” value of the developed property, as shown for example in timeline 308b.

In block 1568, discounted cash flows are determined to obtain a candidate sell price. The discounted cash flows are based on the determined sell price of block 1566 and a discount rate.

In block 1570, the candidate sell price determined from the discounted cash flow is compared to the determined buy price. If the two values match (are within a range), then the discount rate used in block 1568 for the discounted cash flow determination of a candidate buy price is presented as a yield for the determined buy and sell prices on an EFG display. For example, in some aspects, process 1560 may be invoked four separate times to generate each of yield values 1594a-d in some aspects.

FIG. 15H shows one implementation of an economic fabric graph (EFG). In the example of FIG. 15H, the user indicates the property is a 25 unit garden apartment complex (25,000 SF) currently rented for $1,400/month/unit and at stabilized occupancy and stabilized market rent. The user indicated the rents have been increasing 3% annually for the past five years and are expected to increase 3% annually for the next five years. This increase may be due steady personal income increases of apartment renters. Alternatively, a wealthier apartment user may be penetrating the specific market, perhaps due to its good location. Some aspects determine tenant income based on rental income. For example, some aspects may determine rental cost commonly reflects a percentage of total income, for example 30%. In these aspects, a $1,400/mo/unit rental for the subject property indicates household income in this specific market is $56,000 annual or 30% of the household's annual income ($1,400×12 mos./0.30=$56,000). Therefore, the right side 1505 of the EFG or the tenant personal income is created. The date of value is Mar. 1, 2015 with five years on either side of this date creates the date timeline portion of the EFG 1510. The intersection of the tenants income ($56,000/and the date of value (Mar. 1, 2015) is plotted as point 1515. The past personal tenants income has been growing at 3% annually for the past five years. This means the tenants income was $48,500 five years ago.

The intersection of the $48,500 right hand portion of the EFG and the retrospective date of Jul. 1, 2014 is the starting point of the economic fabric line 1520. Conversely, the tenant's income is expected to rise 3% annually for the next five years to $65,000. The intersection of the $65,000 and the Mar. 1, 2019 date is the ending point of the economic fabric line 1520

The “as if complete” stabilized intrinsic value as of Mar. 1, 2015 1530 is calculated using the present value of the annuity that occurs between the five year investment holding period (Mar. 1, 2015 to Mar. 1, 2020) at the user's property yield (9.5%) estimate and the present value of the intrinsic value reversion 1545 also at the user's property yield rate (9.5%). Consequently, the present value result of this “as if complete” stabilized intrinsic value indicates $3,923,333 1530 or $157/sf 1535. This $157 price per sf is plotted on the right hand side of the EFG directly across from the right side of graph indicating $56,000 in personal tenant income (FIG. 1535). Next, the disclosed methods and systems calculates what the rent would have been in Mar. 1, 2010 or $1,208/mo/unit. This rent and it's 3% increases to Mar. 1, 2015 brings the market rent to $1,400/mo/unit as of Mar. 1, 2015. This starting rent of $1,208/mo/unit indicates a starting point of the intrinsic value equilibrium line indicating tenant personal annual income of $48,500 1520 on the right hand side of the EFG graph and $132/sf of approximate property value on the left side of the EFG graph 1540 as of the Mar. 1, 2010 date. Consequently, the $1,400/mo/unit rent as of Mar. 1, 2015 is expected to increase 3% annually until the end of the five year investment period ending on Mar. 1, 2020. The “as if complete” intrinsic value reversion on that date is calculated by dividing the net operating income on the date and dividing (capitalizing) by the user's 9.5% property yield rate 1545 resulting in the intrinsic reversion value of $4,336,779 1545. Now the economic fabric line and it's trajectory drawn starting at the $132/sf date of Mar. 1, 2010 1540 and extending thought the intrinsic value points at Mar. 1, 2015 date 1515 and Mar. 1, 2020 date 1545.

The complete EFG model now indicated two values 1530 and 1531 as of “todays” date Mar. 1, 2015 1510). These two values represent the “as if complete” stabilized intrinsic value 1530 and the “as if complete” stabilized value 1531. Also, each of these two values have a reversion value of what the property is to be sold for at the end of the five year investment holding period 1545—intangible, reversion) and 1555—value reversion). In both valuation scenarios, the user expected annual property yield rate of 9.5% will be achieved once the property is sold at the fifth year. The user can now see if the property is purchased for $4,256,313 1531 and sold for $5,899,200 1555 he will achieve a 9.5% annual property yield. He can now see the addition risk he might be taking when compared to receiving the same property yield of 9.5% if he had purchased the property at the intrinsic value of $3,923,333 1530 and sold at the intrinsic value reversion of $4,346,779 1545. Value tends to gravitate toward equilibrium or intrinsic value over typical business cycles. The farther away the purchase price 1531 drifts from it's intrinsic purchase price 1530 adds additional unrecognized risk to the user property yield expectation of 9.5% in this example. To quantify this additional risk, the EFG iterates the 9.5% property yield rate in the DCF model using the intrinsic purchase price of $3,923,333 1530, the reversion value of $5,899,200 1555, and the annuities received during the investment holding period. This iteration of the property yield indicated the user should receive a 19.25% annual property yield 1521 to compensate for the undetected additional risk

Reverse Engineered Sale Prices (when Sale Price for a Property is Known)

Current methodologies rely on valuation experts to perform expensive and time consuming market studies for each component of value (COV). Valuation experts are reluctant to perform market studies due to increasing liability and time consumption, which the market is not willing to pay for.

The disclosed methods and systems automatically derive COV's from existing sale properties. This relieves valuation experts and the general public from performing expensive and time consuming market studies. The reversed engineered COV's may then be used by valuation experts to support their appraised subject property market value. These experts can further support their selection of comparable sales as having similar highest and best use as the property being appraised. The general public or other users of valuation analysis can see the specific COV or “bets” associated with a property that has sold or is listed for sale. The disclosed methods and systems provide this type of user with the ability to input their own risk tolerance by changing any of the COV's. The user can then observe how these changes will impact the sale or listing price.

From the user interface map 300 of FIG. 3D, a user may select choice 324e, corresponding to an existing property at stabilized occupancy and market rents. From that project type selection, a user may choose to reverse engineer a known sales price for a subject property.

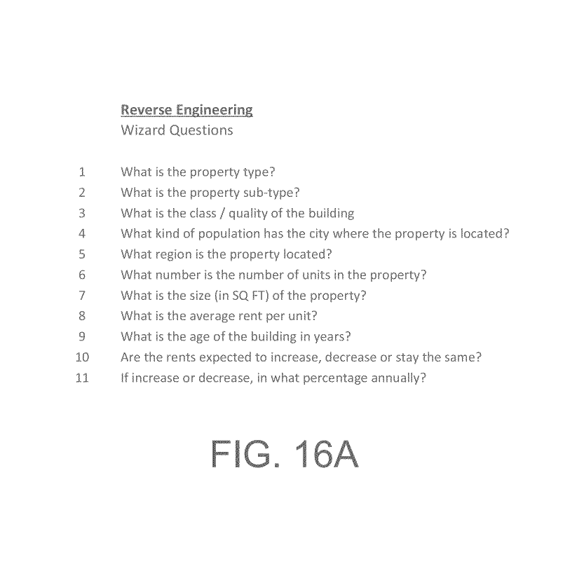

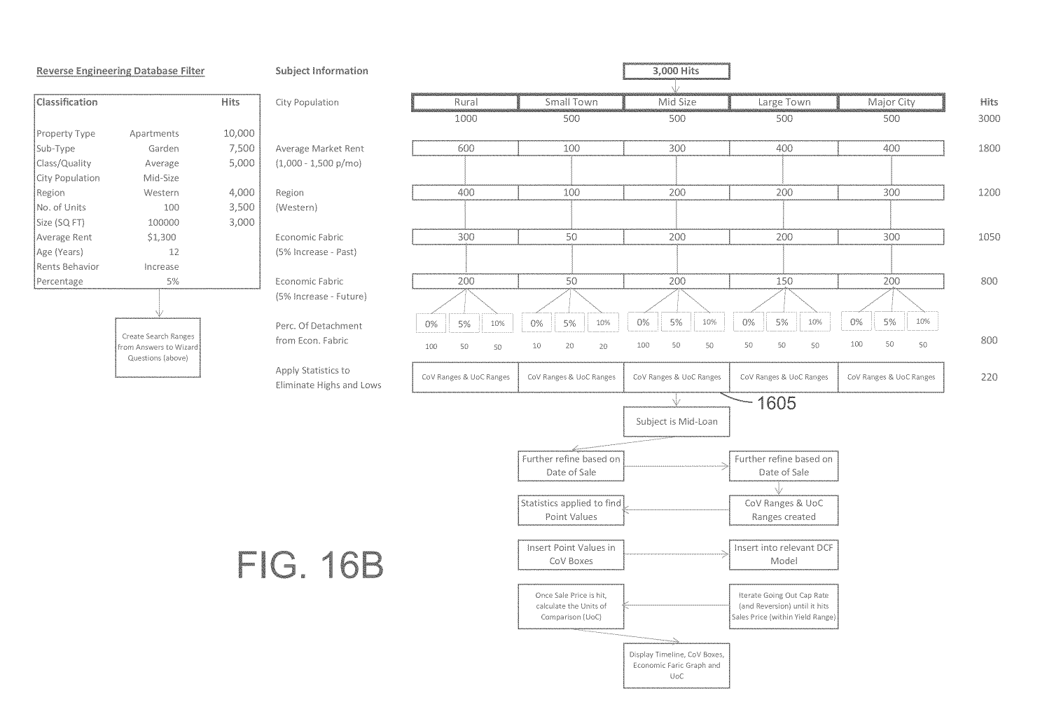

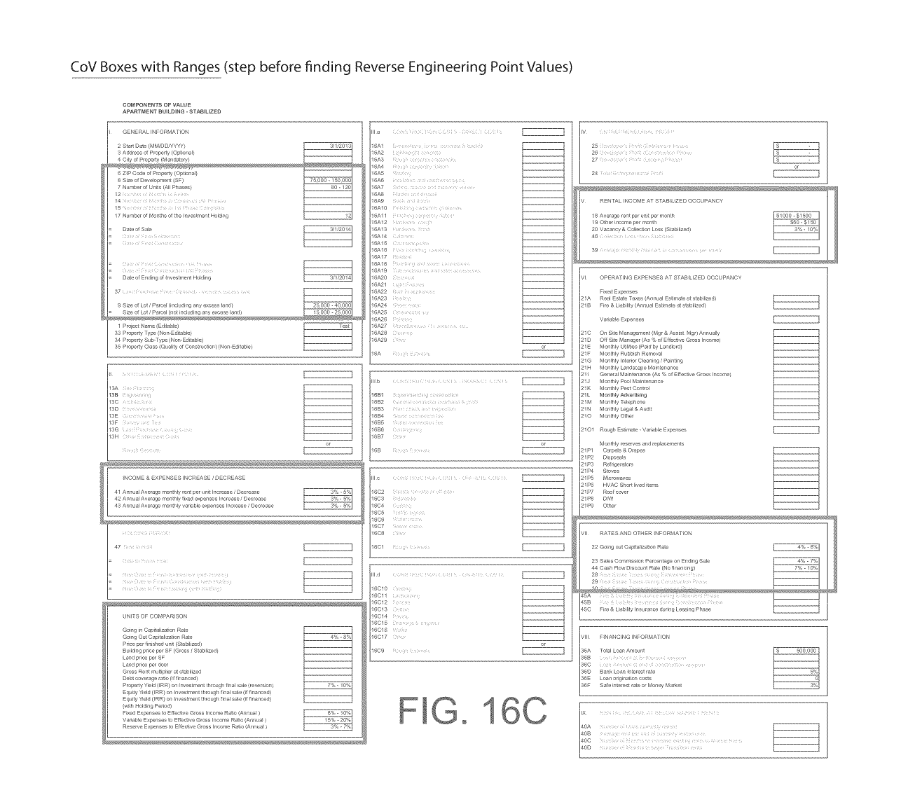

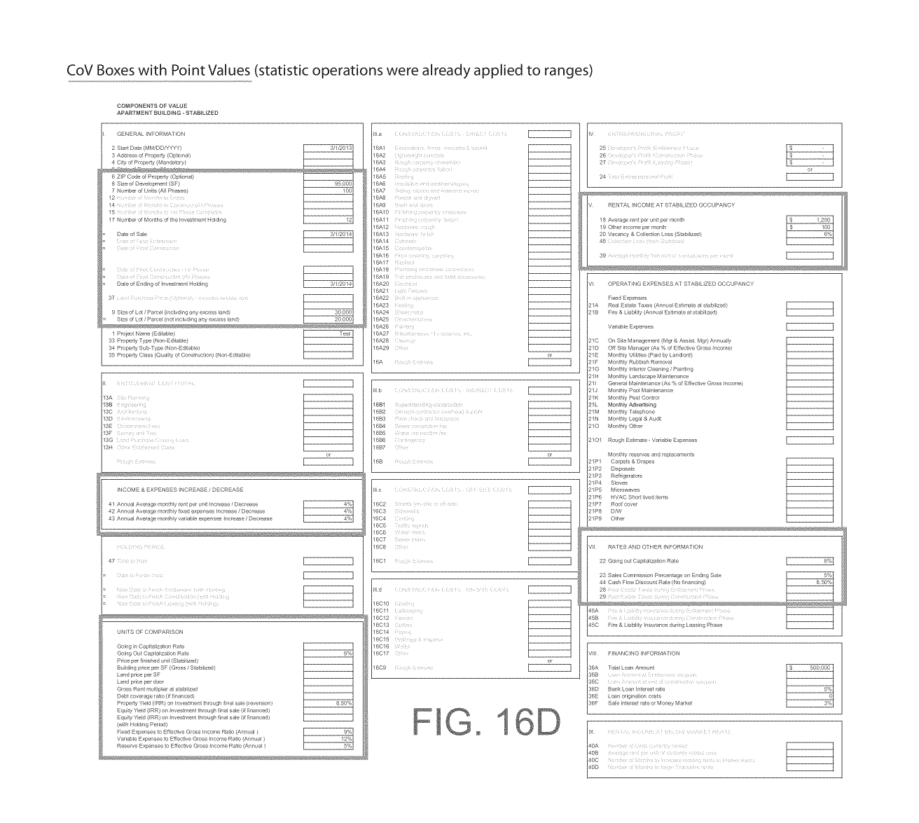

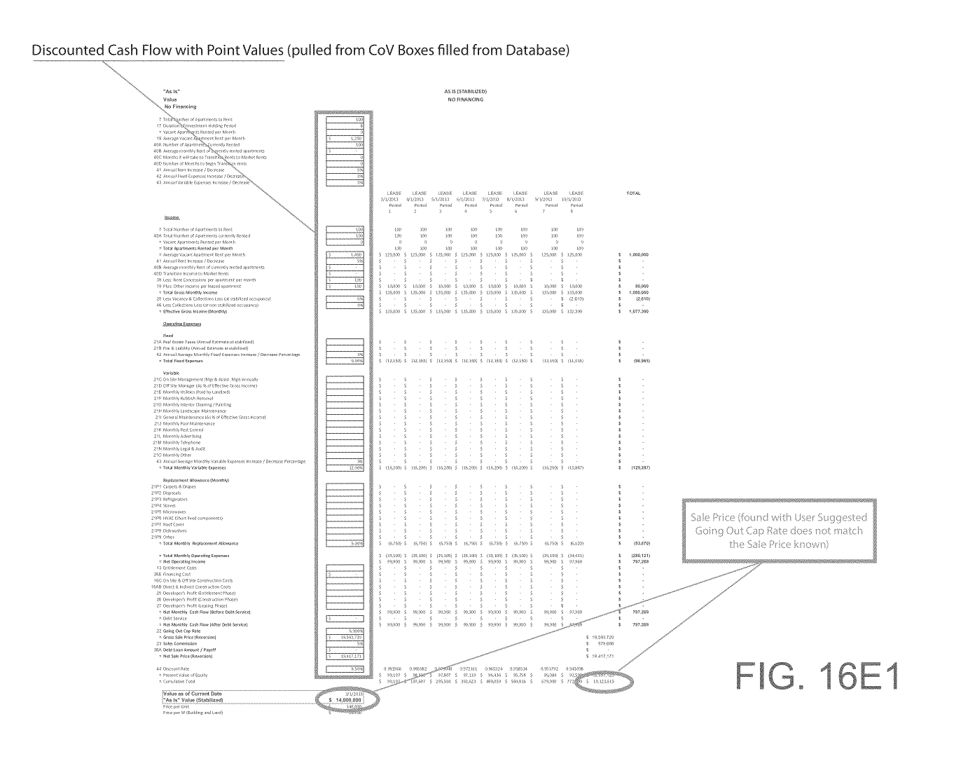

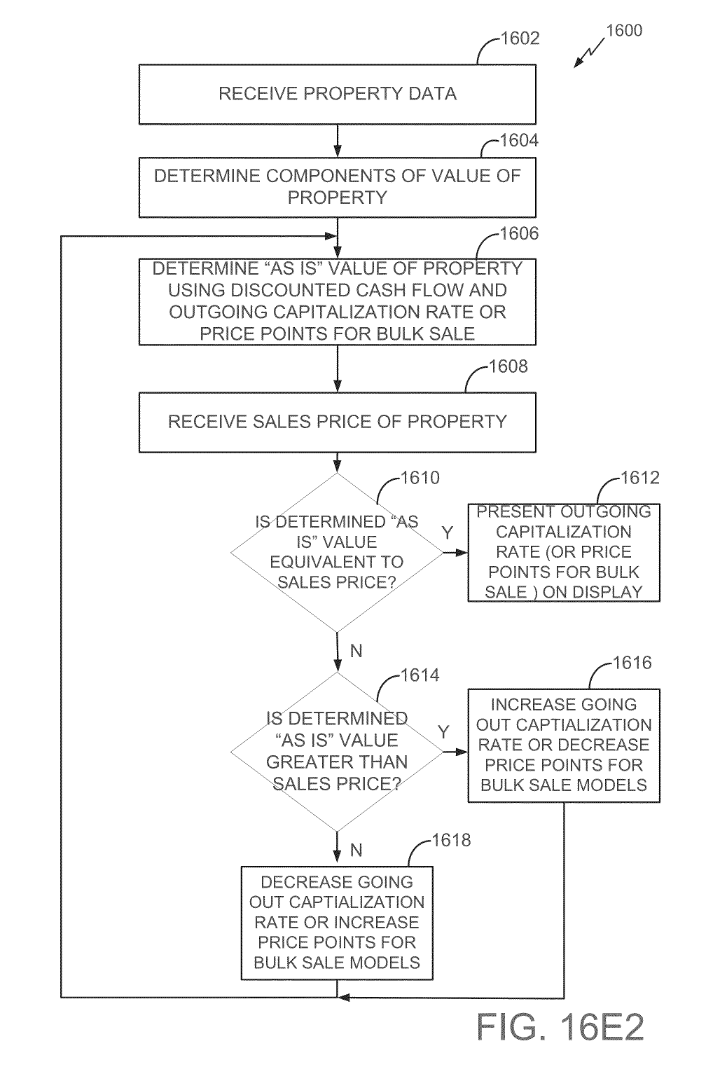

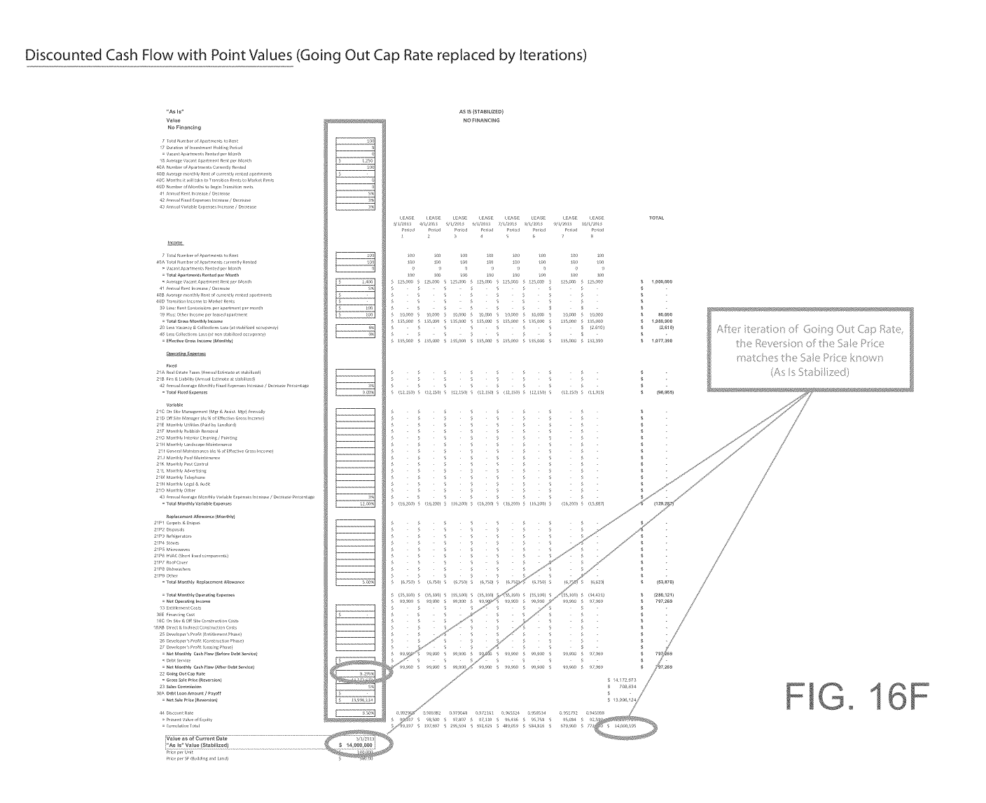

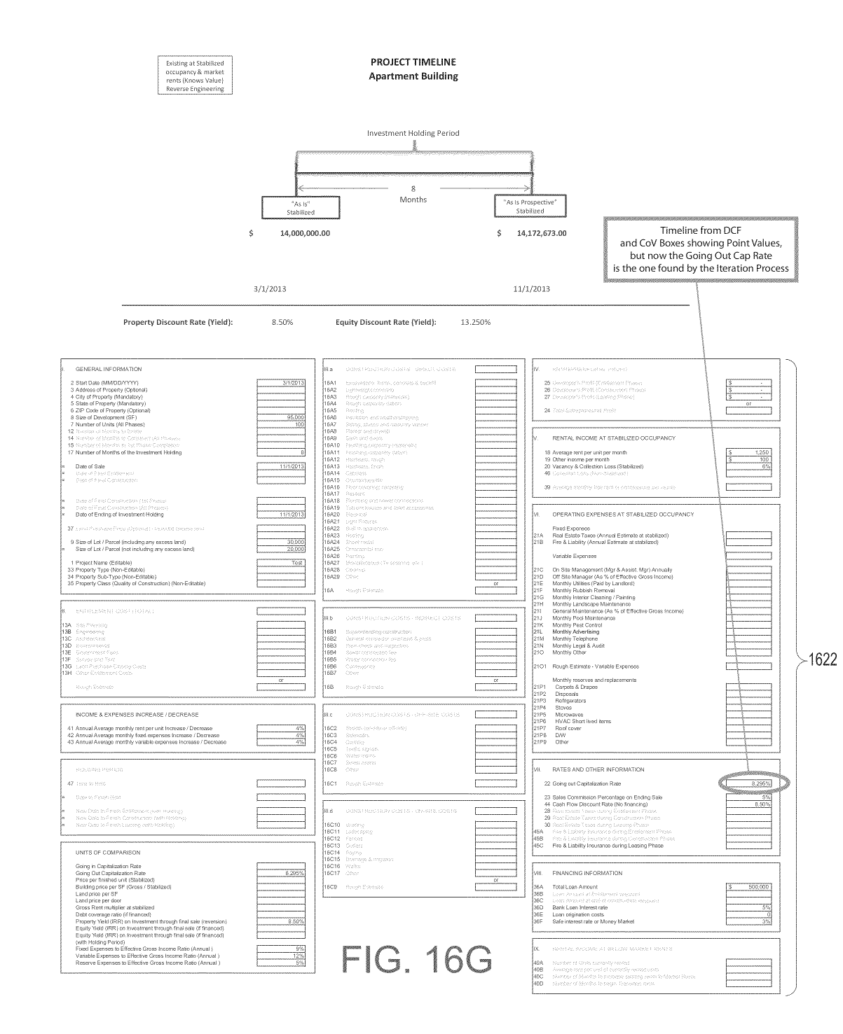

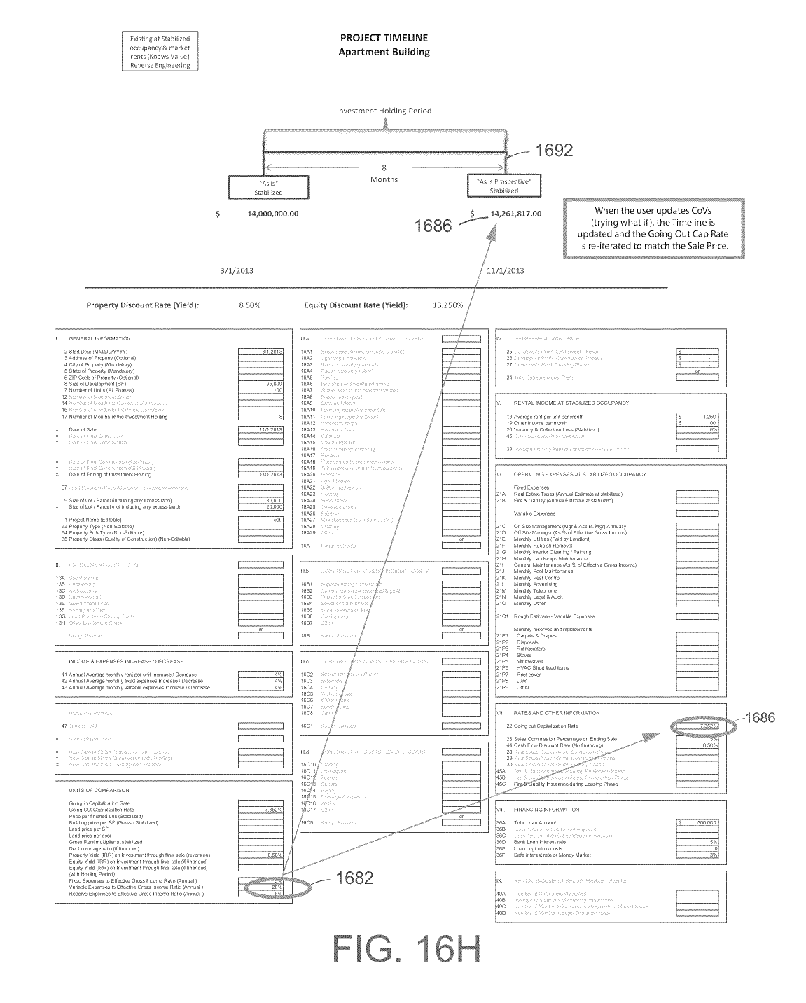

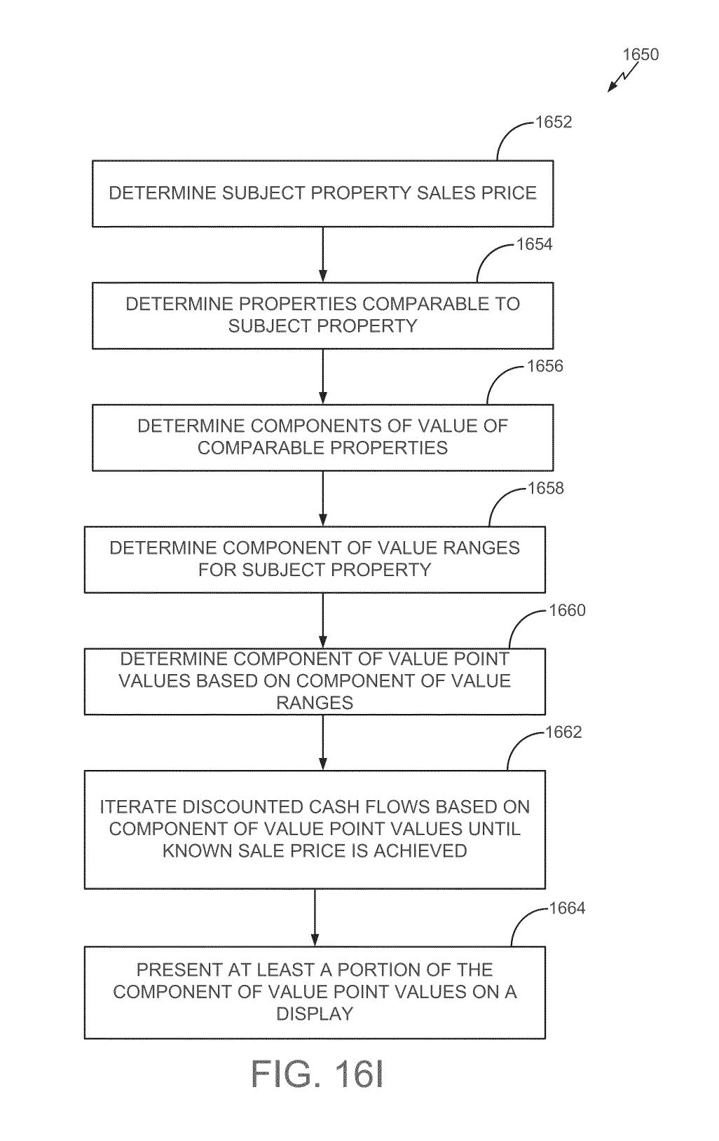

FIG. 16A illustrates one implementation of wizard questions for reverse engineering components of value for a property based on a known sales price. The property can be any property at any stage of development with a sale price. Depending on the property type and sub-type, and stage of development, some aspects may produce wizard questions for the user to answer, examples of which are shown in FIG. 16A. Once answers to the wizard questions are received, the disclosed methods and systems will search for similar property sales from a sales database. For example, properties that have similar city populations, average market rents, regions, expected rental growth rates, past rental growth rates, percentage detachment from their economic fabric (absolute or relative difference between sales values and values derived from market rents) may be identified as similar to the subject property. Similar characteristics may be those within a value range of a characteristic of the subject property. The sales found in the database that have similar economic and specific market traits may be further refined.

FIG. 16B shows refinement of example database search results. An initial search of the database results in this example in approximately 3000 matching properties. Of the 3000 properties, 1000 hits are located in rural areas, while small town, mid-size, large town, and major cities each show 500 properties. Each of these hits can be further filtered by average market rent, region, and properties with economic fabric parameters similar to the subject property. In this example, the subject property is in a mid-size region, so the component value ranges from the mid-size demographic properties may be used to find properties comparable to the subject property. Component of value ranges are selected from the mid-size demographic, shown in FIG. 16B as 1605.

FIG. 16C shows example component of value ranges found during the database search of FIG. 16B. FIG. 16D shows example component of value point values identified from the component of value ranges of FIG. 16C.

FIG. 16E1 illustrates an example discounted cash flow based on the component of value point values identified based on comparable properties (that of FIG. 16D). The sale price of the subject is already known so the DCF model will iterate using different reversion values until the known sale price is achieved. An example of this process is described below with respect to FIG. 16E2.

Once the sale price of each comparable property is achieved through iteration, values of the current project may be determined from the comparables. In the example shown in FIG. 16E1, a sales price determined based on a user's suggested going out capitalization rate does not match the actual known sales price. This indicates the user's suggested going out capitalization rate is too high for market conditions.

FIG. 16E2 is a method of determining a going out capitalization rate based on a known sales price. The method 1600 may be performed, in some aspects, by one or more of the web server(s) 170a-c.

In block 1602, property data is received. As discussed above, in some aspects, the property data may be received via one or more answers to wizard questions as shown in FIG. 16A. In block 1604, components of value of the property are determined. As discussed above with respect to FIGS. 16B-D, components of value of the property may be determined based on a comparables database. A plurality of properties of similar characteristics to the subject property may be selected from the comparables database, resulting in component of value ranges for the subject property, as shown in FIG. 16C. Point values for the components of value of the subject property may then be determined based on the component of value ranges, as shown in FIG. 16D.

In block 1606, an “as is” value of the property is determined using a discounted cash flow. The discounted cash flow may be based on the components of value determined in block 1604, as well as an outgoing capitalization rate when the valuation model includes a leasing phase (as shown in FIG. 3A). When the valuation model does not include a leasing phase, for example, as shown in FIG. 3B, the “as is” value is determined based on price points used for a bulk sale. For example the cash flow may be based on a wholesale price of a completed development project, or based on a retail price of individual sub units, for example, individual condominiums.

The “as is” value referenced in block 1610 and generally in process 1600 may vary based on the valuation model being applied. Generally, with reference to FIG. 3A, the “as is” value is the left most value for the particular valuation model/module being applied. For example, in module 1 of FIG. 3A, the “as is” value is the “as is” value of the unentitled land. When using module 2, the “as is” value referenced in block 1610 would be the “as is” value of the land at entitlement. When valuation module 4 is used, the “as is” value of block 1610 would be the “as is” complete non-stabilized value. With valuation module 5, the “as is” value of block 1610 would be the “as if Complete” at stabilized occupancy value.

With reference to the modules of FIG. 3B, the results are similar, except when using valuation module 4, the “as is” value is the “bulk” or “wholesale” value of the developed property, as shown in timeline 308b.

In block 1608, a sales price of the property is received. The sales price may be inputted to the system as a new “as is” value for the property being modeled. The sales price may be received via input received from the user, for example via a web page or application dialog. In some aspects, the sales price may be received as part of wizard questions, such as those shown in FIG. 16A.

Decision block 1610 determines whether the “as is” value determined by the discounted cash flow in block 1606 is equivalent to the sale price received in block 1608. Equivalent in this context may include values within a predetermined range of each other (for example, at least to account for rounding errors). If the values are equivalent, the outgoing capitalization rate is presented on a display. An example of this is shown in FIG. 16F below.

When process 1600 is being performed for a property that does not include a leasing phase (such as any of the models shown in FIG. 3B), but instead includes a selling phase, then a bulk sale price or individual unit price points may be presented on a display, in a similar manner to that shown below for FIG. 16F.

If the determined “as is” value is not equivalent to the sales price, decision block 1614 determines whether the “as is” value is greater than the sales price. If it is, process 1600 moves to block 1616, which increases the going out capitalization rate (for property models that include a leasing phase) and reduces the price points for property models that do not include a leasing phase. If the determined “as is” value is less than the sales price, block 1618 decreases the going out capitalization rate for property models having a leasing/income phase (FIG. 3A) and increases price points for property models that sell units before leasing (FIG. 3B). Process 1600 then returns to block 1606 where the discounted cash flow re-calculates the “as is” value of the property based on the updated values. Process 1600 then iterates until the determined “as is” value is equivalent to the sales price in decision block 1610, after which the results are presented on a display as shown by block 1612.

FIG. 16F shows another example of a discounted cash flow that reverse engineers a sales price. In this example, the reverse engineered sales price is equivalent to the actual sales price. This suggests that the outgoing capitalization rate entered by the user as part of the wizard questions shown in FIG. 16A may be relatively well matched for current market conditions.

FIG. 16G shows a development timeline presented on a user interface of a computer. The development timeline presented in FIG. 16G may be based on a discounted cash flow model that reverse engineers the sale price, as shown in the DCFs of FIG. 16E1 and/or FIG. 16F. Similar to the scenarios previously described, the user may be able to update components of value 1622. In response, the disclosed methods and systems will iterate the discounted cash flows that provide the target ending sale price (reversion) using a different going out capitalization rate until once again the known sale price is achieved, as described above with respect to FIG. 16E2.

FIG. 16H shows an example of a “what if” use case for reverse engineering a sales price. In the example of FIG. 16H, a “variable expenses to effective gross income ratio” is updated in cell 1682. This causes updates to the going out capitalization rate in cell 1684 and the “As is Prospective” stabilized value 1686 in the timeline 1692. As discussed above with respect to other modules, module 5 shown in FIG. 16H may also receive user input defining a new “as is” stabilized value. In response to the user entering this information, the system will, as described above, iterate the going out cap rate (for 3A models) or the price points (for FIG. 3B models) to allow the discounted cash flows to produce an “as is” value matching the user inputted value.

FIG. 16I is a method of reverse engineering a property's components of value based on a sales price. The method 1650 may be performed, in some aspects, by one or more of the server(s) 170a-c. In some aspects, the method 1650 may be performed by a computer such as a tablet, laptop, or desktop computer in aspects where the methods and systems are not implemented using a web based delivery model.

In block 1652, a subject property's sales price is determined. In some aspects, the property's sale price may be determined based on answers to wizard questions, such as the example wizard questions as shown in FIG. 16A. In some other aspects, the timeline may be configured to accept input from the user that allows them to enter their own “as is” value. The user entered “as is” value may be used as a sales price for purposes of block 1652.

In block 1654, one or more properties comparable to the subject property may be identified. As discussed above with respect to FIG. 16B, the comparables may be determined based on matching one or more characteristics of the subject property with properties in a comparables database. As shown in FIG. 16B, in some aspects, the characteristics may include one or more of a property type, sub-type, class/quality, city population, region, a number of units in the property, the size of the property (for example, based on a square footage or other size measurement), an average rent, an age of the property, rental growth rates in the past, an expectation of whether rents will increase or decrease in the future, and the size (as a percentage basis or other indication of future trend) of the increase/decrease.

In block 1656, components of value for the comparable properties identified in block 1654 are determined. In some aspects, components of value for the comparable properties are retrieved from the comparables database. For example, in some aspects, the comparables database may be based on property information entered by users of a system implementing the disclosed method 1650. For example, users of the system may answer wizard questions discussed above that allow the system to determine components of value for properties modeled by the system. Information, such as components of value derived from answers to the wizard questions, about these properties may be retained by the system in the comparables database and later used to derive components of value for other properties entered by that user or even for properties entered by another user. As the number of users of the system increases, such that the comparables database becomes larger and more comprehensive, users of the system will benefit from the breadth and depth of the collective property information stored in the comparables database.

In block 1658, component of value ranges are determined for the subject property.

For example, in some aspects, each component of value range may be selected based on a corresponding minimum and maximum component of value for the comparable properties identified in block 1654.

In block 1660, component of value point values are determined based on the component of value ranges. In some aspects, the point values may also be determined based on corresponding component of value point values for the comparable properties. For example, the point values may be based on a weighted average of the respective component of values for the comparable properties.

In block 1662, discounted cash flows based on the determined component of value point values are iterated until the discounted cash flows show a sales price equivalent to the known sales price of block 1652. This method is discussed above with respect to FIG. 16E2.

In block 1664, at least a portion of the component of value point values and the discounted cash flows are presented on a display. In some aspects, further input may be received modifying one or more of the component of value point values, as discussed above with respect to 16H. The discounted cash flows may be further iterated in response to the input, via method 1600 discussed above with respect to FIG. 16E2 until the known sales price is achieved again.

### Automated Valuation Model (AVM) for Stabilized Properties

There are no current automatic valuation models (AVM) for commercial property valuations. There are no current AVM valuation methodologies that use market derived COV (components of value) or “bets” associated with a sale property to compare a commercial property to be valued. Current methodologies advocated by the Appraisal Institute and the Appraisal Foundation include the cost approach, sales comparison approach and the income approach. The cost approach and sales comparison approaches use data from the past to value a commercial property. The income approach typically only looks one year in the future by capitalizing this first year's income into the subject's current value. This mean dozens of COV's are wrapped up into a single capitalization rate used to capitalize this first year's income into a value indication. The slightest change in this capitalization rate can change the value indication by tens of thousands of dollars. Because these methods do not use market derived COV's from comparable sales with a similar highest and best use, and similar neighborhood demographic/expectations, they can lead to misleading valuations. Furthermore, limiting the user of the COV or “bets” with the appraised value inhibits a user's ability to assess the hidden risks associated with the value. If the user has access to the COV's that are imbedded in the capitalization rate, he/she can better assess if the market's forecasts or bets making up the value are reasonably attainable.

Disclosed is an AVM (automatic valuation model) feature linked to a database of reversed engineered sales. This allows derivation of COV (components of value) or “bets” associated with each properties sale price. In addition, the AVM is also linked to COV for specific properties that represent various user's current forecasts or “bets” the user thinks are reasonably attainable in the future.

When using the AVM, a user may identify a property classification, type, and development status of their particular property (subject property) via a decision tree process. Two databases (reversed engineered COV's from actual sale prices, and user forecasts of properties they have recently analyzed) are filtered to identify properties with the same classification, property type, and similar physical attributes.

Through the decision tree process, the user will be presented with wizard questions relating to the selected property type. When the user answers the questions regarding their property's average rent and how these rents are expected to behave in the future, comparable properties are selected from the databases discussed above that match features of the subject property. The selected properties have similar highest and best uses as the users subject property and are within a similar market, which is expected to behave in a pattern that matches the subject property's future rental and occupancy expectation.

The COVs for the selected properties are used to derive values for the subject property's COV boxes. Initially, at least some COV boxes may be populated with a value range, based on data derived from properties selected from the database. An additional refinement process may then narrow the ranges, based on a weighting process that may weight some selected properties more heavily than other selected properties. The weights of each selected property may be based, in some aspects, on geographical proximity to the subject property and/or other statistics. Once the range of a COV has been narrowed to within an acceptable limit, the value may populate the appropriate DCF (discounted cash flow) models that will solve for the subject property's values.

In some aspects, specific local, regional, national or international economic events may affect the subject property's value. To accommodate for this situation, the disclosed methods and systems provide for user input to be received that indicates only recent forecasts (COV's) of similar properties should be used to populate the subject property's COV boxes and thus be used to derive the properties components of values. Historic COV or “bets” from reversed engineered sales quickly become obsolete when major occurrences abruptly change a subject property's economic horizon.

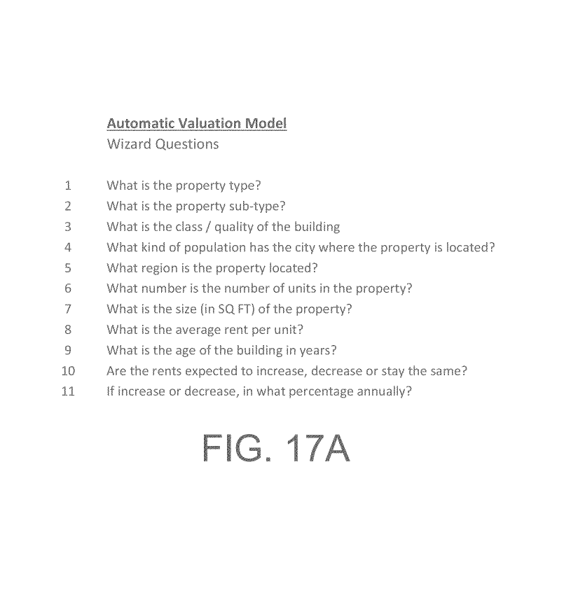

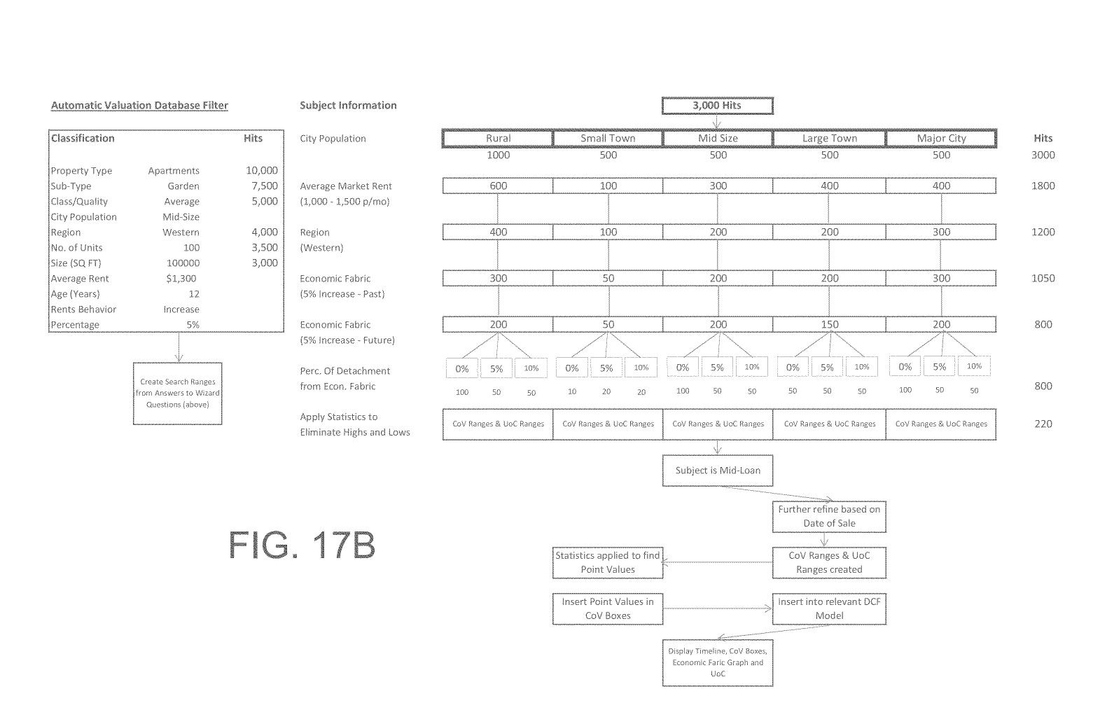

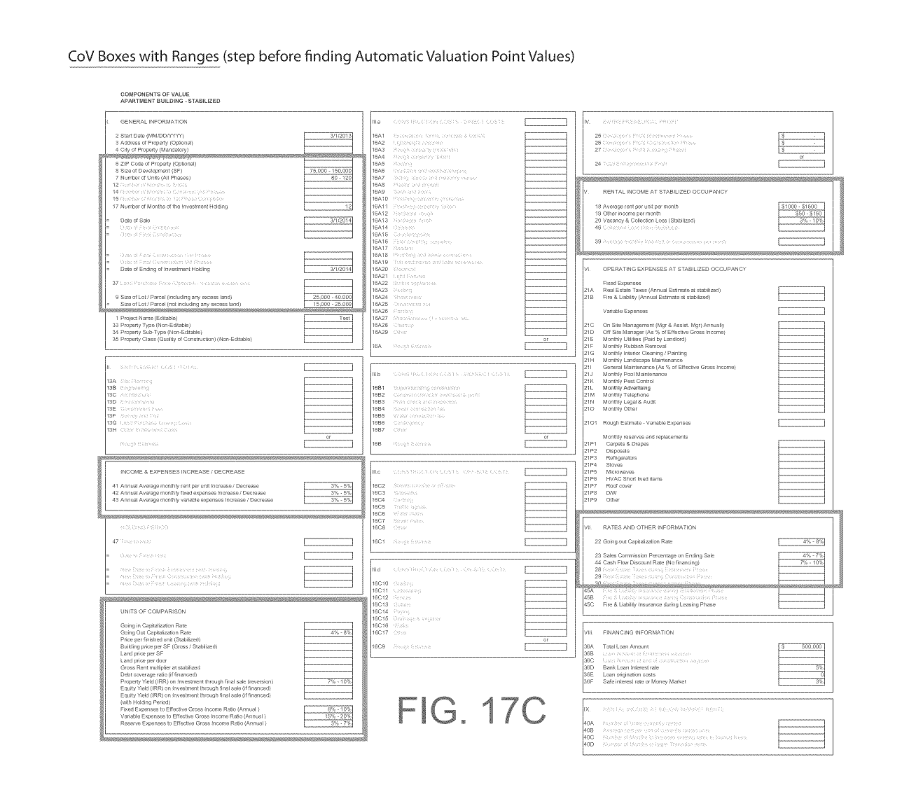

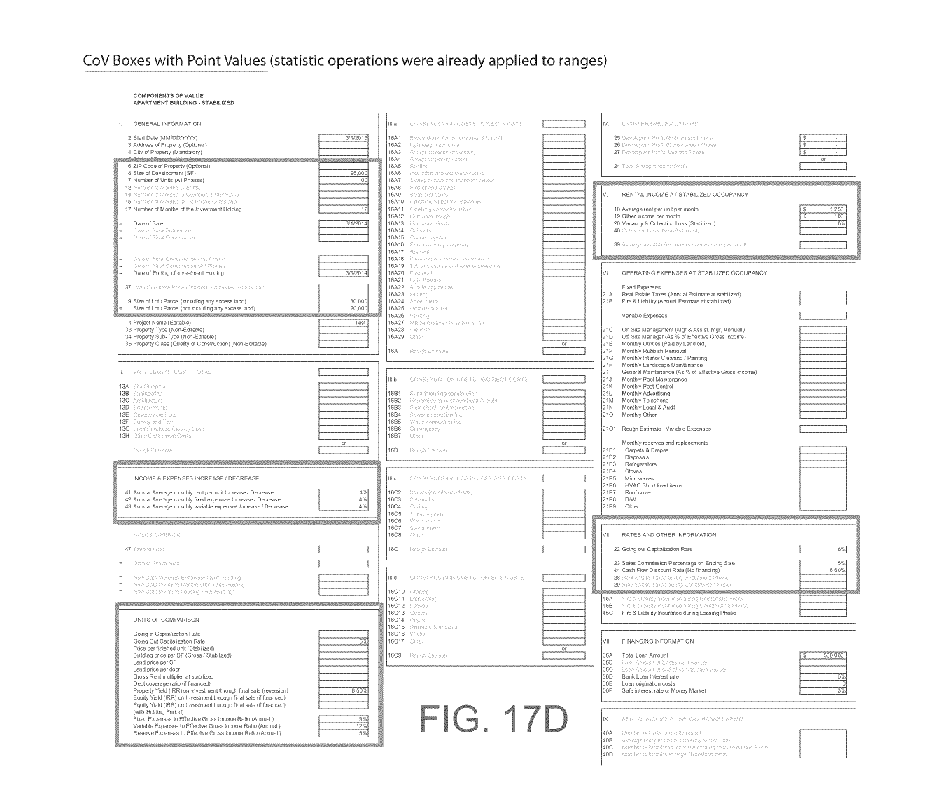

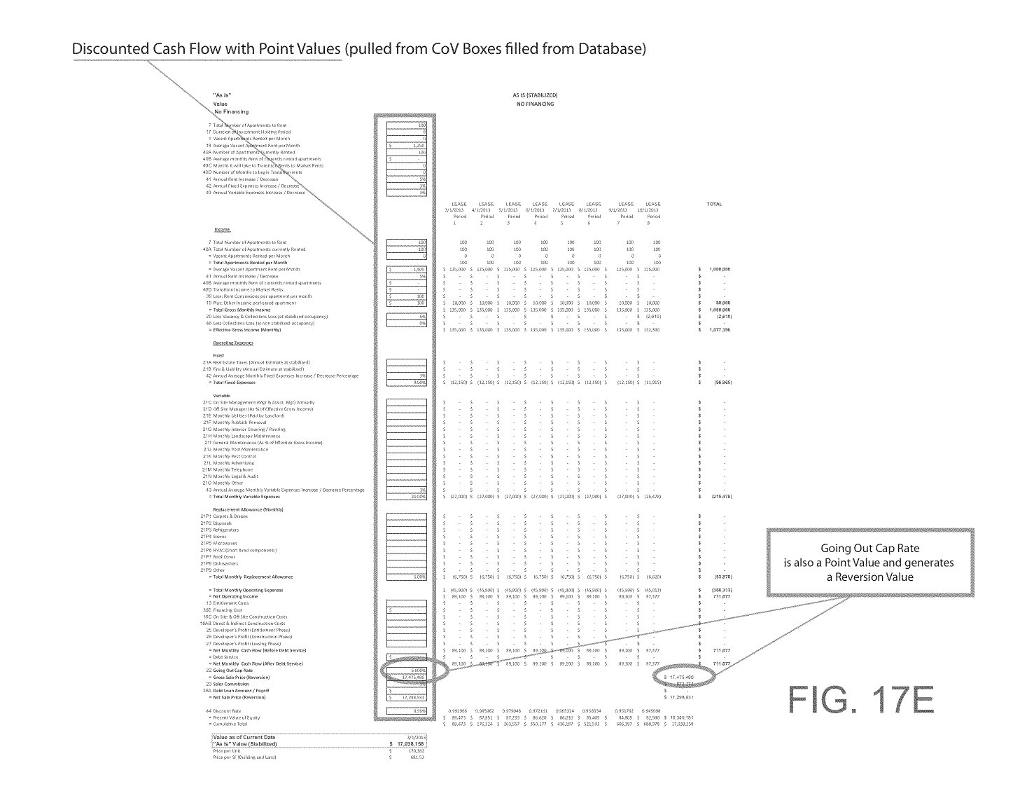

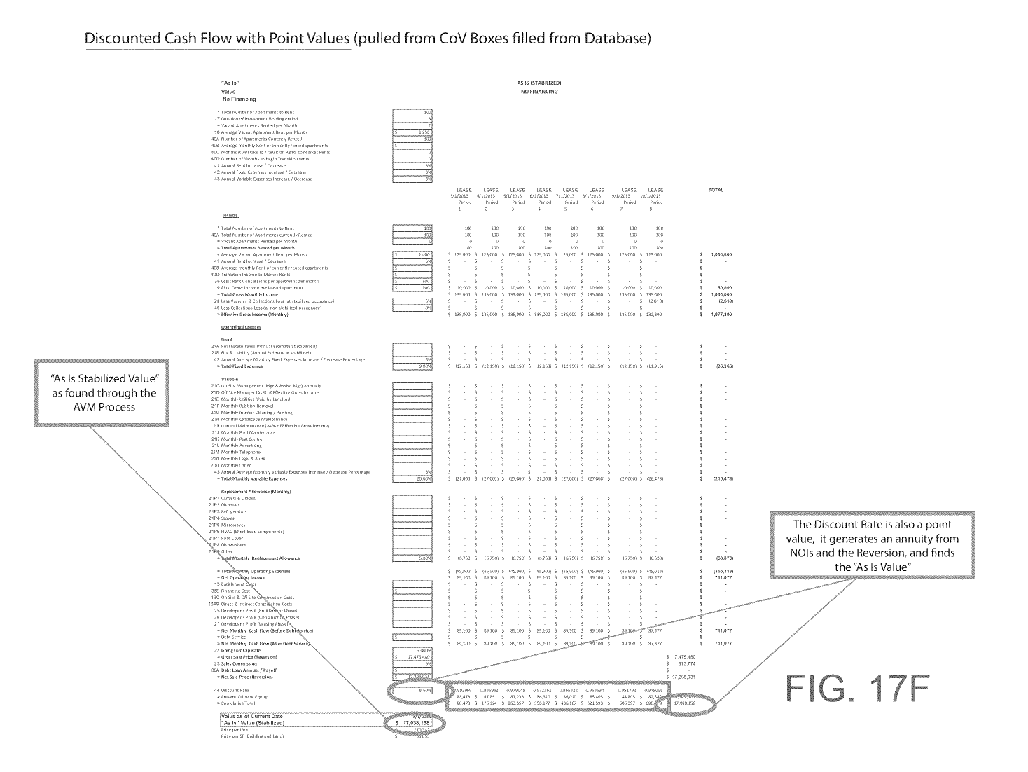

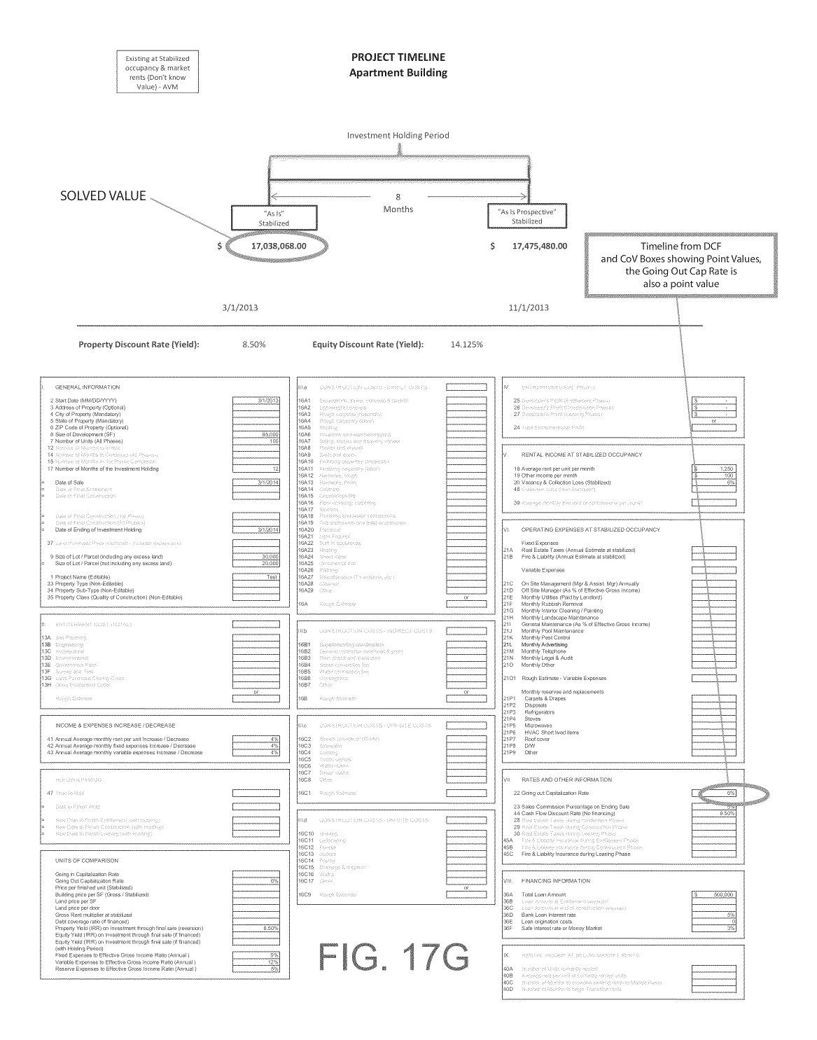

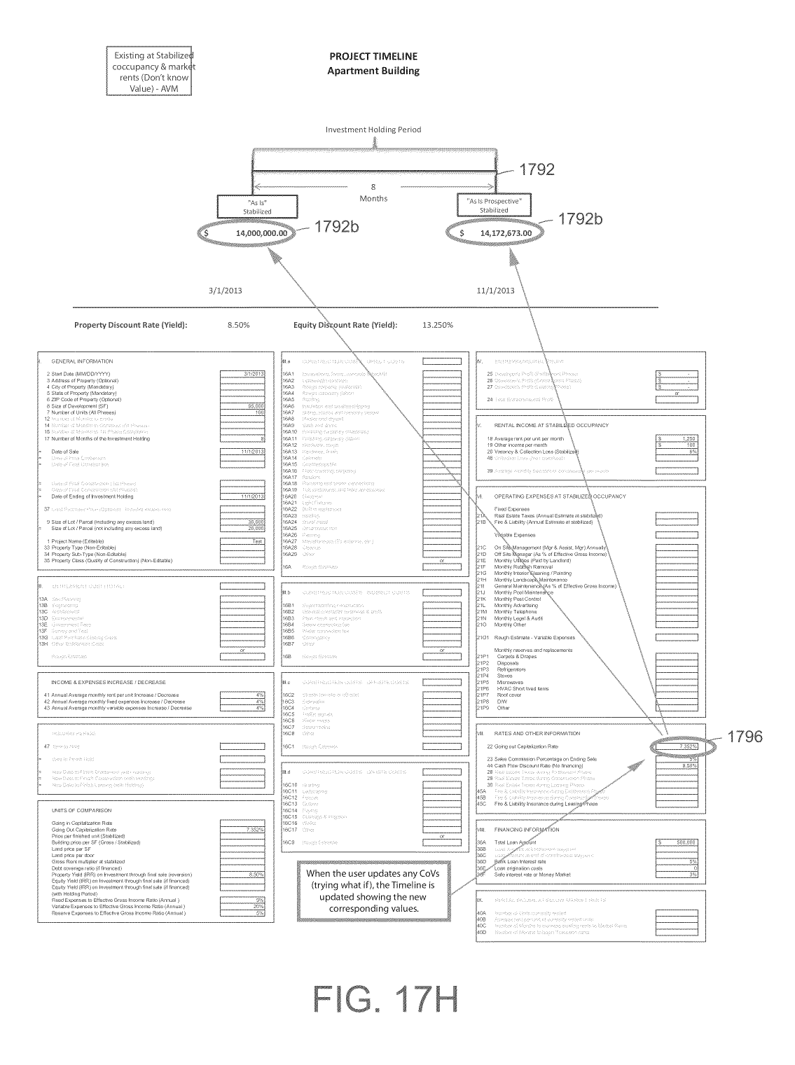

Example wizard questions for an automated valuation model are shown in FIG. 17A. After receiving responses to the wizard questions, a database may be searched for similar property sales as discussed above with respect to FIGS. 16A-I. The sales found in the database that have similar economic and specific market traits may be further refined, as shown in FIG. 17B. The final sales used as comparables will show tight ranges for their COV boxes, as shown in FIG. 17C. A statistical process for each range will refine the ranges to a final point value in each COV box, as shown in FIG. 17D. The final point values will be applied to an applicable DCF model, an example of which is shown in FIG. 17E-F. The going out cap rate indicated by the comparable sales and user forecasts may be applied to the subject's ending NOI to derive the subject's reversion. The disclosed methods and systems will now have a complete DCF model to solve for the unknown “as is” value. The comparable sales database yield used that is expected from subject's type of investment may be used as a discount rate to solve for the subjects “as is” value. The disclosed methods and systems will display the timeline values with a solved “as is” value, as shown in FIG. 17G. Component of value boxes may also be presented on the display simultaneously with the timeline.

The user can now play “what if” by changing the COV boxes if he chooses which will automatically change the solved “as is” value and the EFG model. The user will have the option to have the disclosed methods and systems show the “as is” value derived from comparable sales and/or derived from former users forecasts of similar properties.

FIG. 17H shows an example “what if” analysis when using the automated valuation model. FIG. 17H shows a user updating the going out capitalization rate in cell 1790. As a result, the timeline graphic values for the “As Is” Stabilized value 1792a and the “As is Prospective” stabilized value 1792b are updated.

### Comparable Searches

Current methodology in the selection of comparable sales for use in comparison to a property with an unknown value is to pick nearby sales that look similar to the subject property. This can lead to misleading appraisals due to a lack of nearby sales with similar highest and best uses and similar neighborhood expected behavior. Many times comparable sales are “cherry picked” to match the value result of the cost and sales comparison approaches.

Furthermore, current methodologies compare selected comparable sale to the subject property to be valued by relying on a sequence of adjustments. The first set of comparisons adjust for date of sale; (market conditions-time); real property rights conveyed (fee simple, leased fee, lease hold, etc.); financing terms (below market financing-cash equivalent adjustment); conditions of sale (arms length sale). The second set of adjustments involve physical differences between the comps and the subject. The third set of adjustments location, economic characteristics, zoning (use) and non-realty components of value. The appraiser is in violation of licensing law (USPAP—uniform standards of professional appraisal standards) if these adjustments made to the comparable sales cannot be proven from matched pairs of sales which are identical to each other except for a single difference. This requirement is difficult if not impossible due to lack up matched pairs. The appraiser is therefore forced to use his judgment and experience in determining adjustments to the comparable sales. The current process can lead to misleading results in an effort to “hit” a value conclusion.

When comparable sales are broken down into their individual COV's and expected neighborhood behavior, the comparable sales can be better judged against the subject property as a true comparable sale or not. Thus, the disclosed systems and methods select comparable sales similar to a subject property from a database of reverse engineered sales. In some aspects, potential comparable sales are selected based on the user's decision tree process (classification, property type, economic & physical condition) for a subject property.

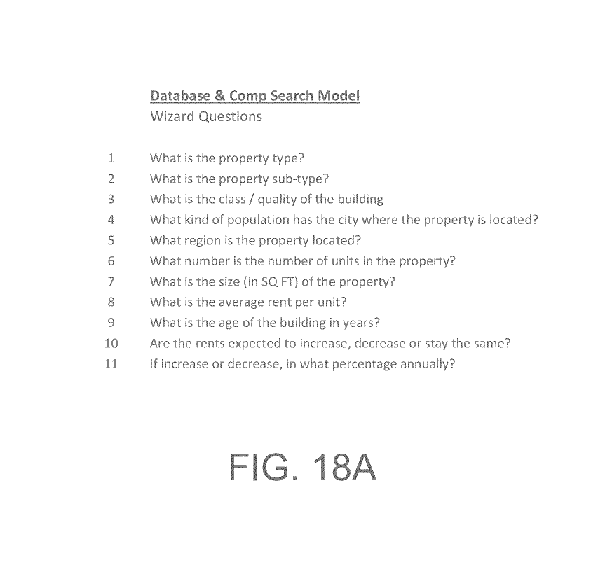

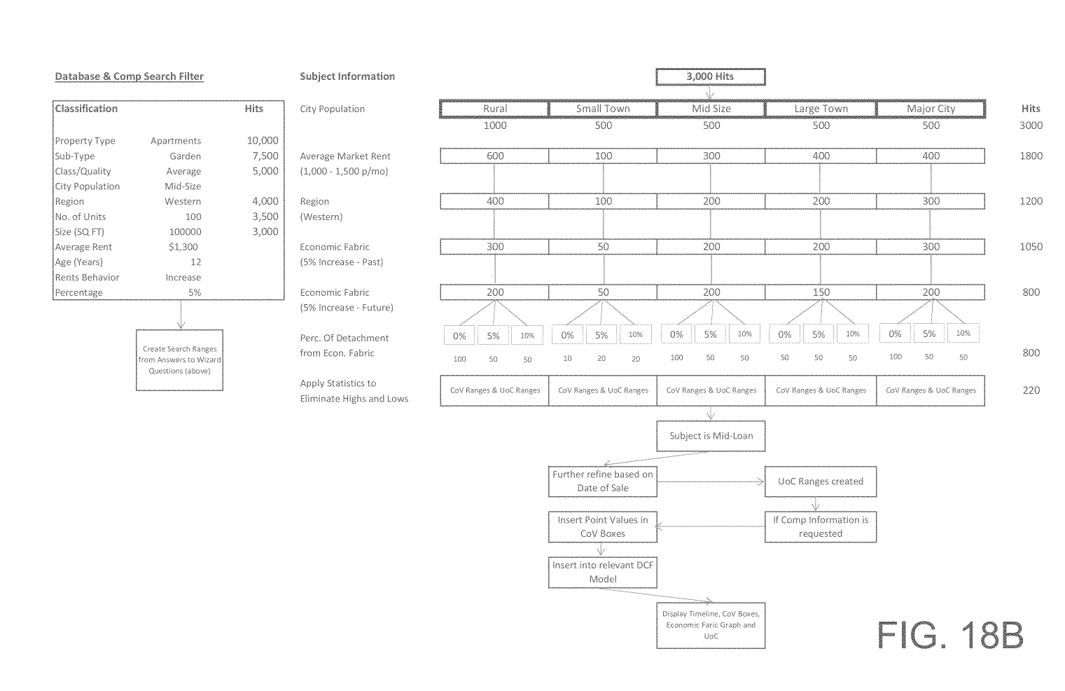

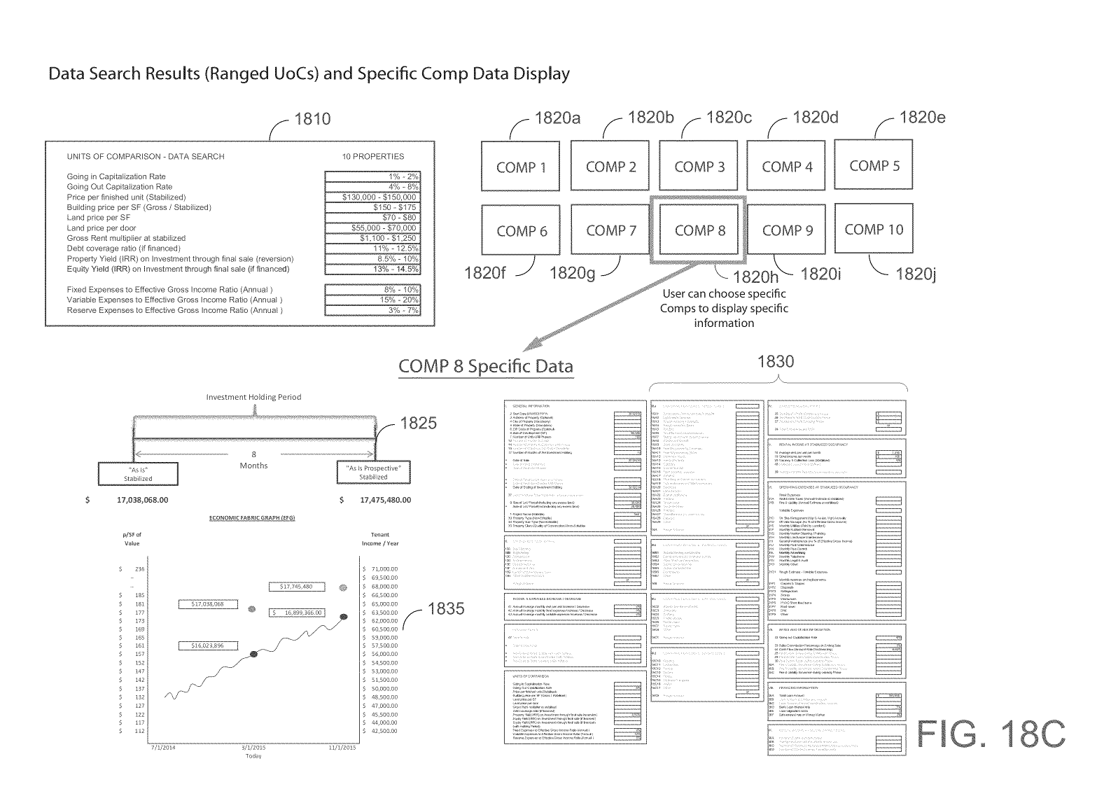

Based on the user's decision tree selection, a set of wizard questions will appear. An example set of wizard questions are shown in FIG. 18A. The user will answer more specific questions about the subject property (size, number of units, current rents, property yield expectations, neighborhood expectations, as discussed previously) which will be used to further refine the set of comparable sales. In some aspects, the results of the database search may be filtered through a decision tree model, as shown in FIG. 18B. Local, regional, state, national and international sales of comparable properties may be filtered to find properties with a similar highest and best use as the subject property and a similar future expectations. As another example, any of the components of value 1830 shown in FIG. 18C below may be used to filter comparable properties from a comparables database. Selected comparable sales are reversed engineered into components of value (“bets” or forecasts making up the comparables sale price) and shown in a composite of tight ranges for each component of value. The user/appraiser will now have market derived COV forecasts of “bets” to compare to the subject property from recent comparable sales with a similar highest and best use as the subject as well as similar physical, economic and neighborhood expectations. The user/appraiser will not be burdened with matched pair data collection (if this data can ever be found) and can better communicate the selection of his choice of comparable sales as they relate to the subject property.

FIG. 18C shows an example display 1800 on a user interface of comparable search results. The final comparable data selected 1810 may be presented to the user in the units of comparison boxes (UOC), as the compilation of comparable sales selected, in ranges for each unit of comparison for the subject property's type. This data can be further sorted using reversed engineered sale properties or from user forecasts of future predictions for similar properties as the subject. In addition, the user can select each comparable sale via controls 1820a-j to view that sale's value timeline graphic 1825; completed COV and UOC boxes 1830; and the EFG graphic 1835 for the comparable sale.

### Financial Reporting

United States banks are regulated by either the OCC, FDIC, or the Federal Reserve Board. Regulation of banks require regular examinations of the bank's loan portfolio. The regulatory agency will require valuations of a sampling of the bank's portfolio and an action plan by the bank as to their short term and long term strategy to hedge against loan collateral risks. Many of the new federal regulation require banks and publicly traded companies to periodically mark-to-market of their assets instead of using the cost basis of the asset. This requires an appraisal, evaluation or broker's opinion of the assets value. The bank will be required to engage a professional appraiser, brokers opinion or an in-house evaluation from a bank representative. The regulatory agency requires the bank to come up with its own process of risk analysis for its portfolio without much assistance from the regulatory agency.

Any of these options results in an opinion of value by a person who “possess the appropriate appraisal or collateral valuation education, expertise and experience relevant to the type of property be valued” Interagency Appraisal Evaluation Guidelines, Agencies: OCC, FRB, FDIC, OTS, NCUA (Docket ID OCC-2010-0012).

The disclosed methods and systems allow a bank to track, on a property-by-property basis, each residential or commercial property in its loan portfolio. Once the property is entered into the system's property database, the property will be reversed engineered into its components of value (COV) or “bets” associated with its sale price. This sale price may also be superimposed into an economic fabric graph (EFG) as discussed above and compared to property's natural or intrinsic value. The EFG graph may then be superimposed with the economic wave graph (discussed below) that will indicate the sustainability and timing of any loss in market value that could impact the loan collateral position of the bank.

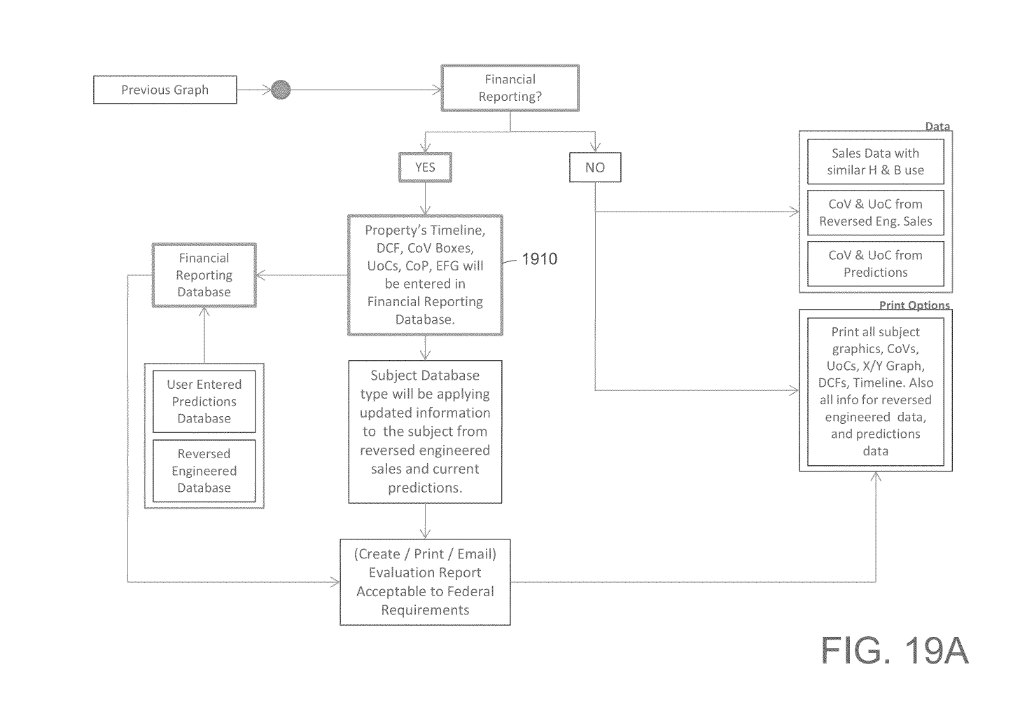

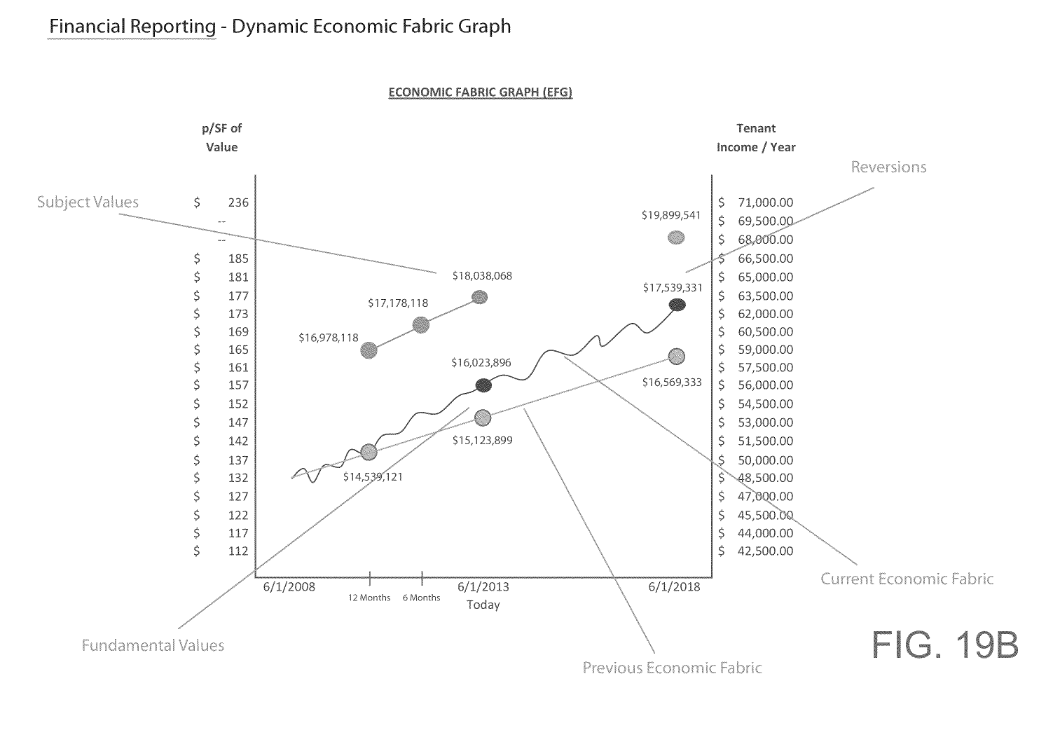

A user interface flow for financial reporting is shown in FIG. 19A. To place each property into the financial reporting database function the property may first be reversed engineered from an existing conventional appraisal or sale (as discussed above); use of the AVM feature (as also discussed above); or use the user input feature of the that produces a specific value for each property. These features may also deconstruct the property value into components of value (COV) and provide for an economic fabric graph (EFG). Use of these features is shown in FIG. 19A by box 1910.

When using the financial reporting feature, a user may select how often each properties value is to be automatically updated using the AVM function. Alternatively, a default frequency may be provided.

One or more comparables database(s) discussed in this application may be updated periodically to maintain current up to date information. A comparables database may also be utilized for financial reporting. When the appropriate interval for reporting has passed, a comparables database may be searched for each property within a portfolio. As new data is applied to the portfolio of properties, individual values for properties within a portfolio may change, depending on the frequency of the re-valuing process and changing market conditions for each property type.

FIG. 19B shows an example EFG that tracks value changes by superimposing current values, linking past values, in relation to each property's economic fabric's timeline that could also be changing. Printing functions for an evaluation of each subject's updated value may also be provided to satisfy federal reporting mark-to-market requirements.

In addition to the periodic comparison of a portfolio to the comparables database, the user may update parameters associated with individual properties in the portfolio. For example, changes in rental income, occupancy, and market expectations of each property's specific return on investment may be updated.

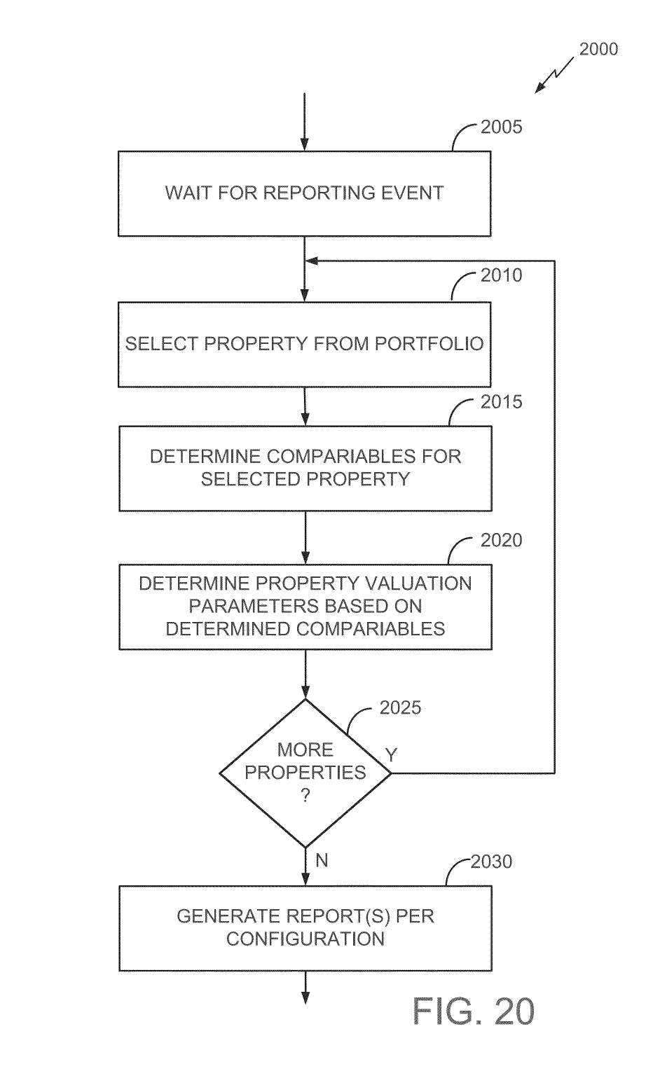

FIG. 20 is a method of periodic revaluation and reporting of a portfolio of assets. In some aspects, process 2000 may be performed by one or more of the web server(s) 170a-c. Alternatively, process 2000 may be performed by a desktop, laptop, tablet or other personal computing device when the methods and systems disclosed are not provided via a web based delivery model.

Process 2000 waits for a reporting event in block 2005. In some aspects, this may be a periodic event. For example, a user may configure to system to reevaluate a portfolio's value on a weekly, monthly, or quarterly interval. In some aspects, the event in block 2005 may be selection of a reporting function from a user interface. For example, an “on demand” reporting use case may be supported in some aspects. In block 2010, a property is selected from a portfolio. In block 2015, comparable data for the selected property is determined. For example, in some aspects, block 2015 may operate in substantial conformance with the discussion of FIG. 17B and/or FIG. 18B-C. In block 2020, property valuation parameters are determined based on the determined comparables. In some aspects, property valuation parameters may include one or more components of value shown in FIGS. 17D. These parameters may be determined in substantial accordance with the description of FIGS. 16B-16E and/or FIGS. 17B-17F.

If there are more properties in the portfolio, process 2000 moves from decision block 2025 back to block 2010 where another property is selected. Otherwise, process 2000 may generate report(s) based on a reporting configuration. For example, as discussed above, the system may be configured to automatically print reports when they are generated. Alternatively, printable versions of reports and/or link identifying hosted versions of these reports may be emailed to pre-configured email addresses for the portfolio.

### Wave Graph

Market forces naturally pull markets toward a property's natural or intrinsic value called equilibrium over the long run. However, because real estate markets are imperfect, a true balance of supply and demand is seldom achieved for long. Nevertheless, the concept of natural or intrinsic value equilibrium is vital to the analyst's understanding of market cycles and his/her ability to estimate where a property's market value is in the cycle and what the future trends are likely to be.

Factors that push a property's market value away from its natural or intrinsic value equilibrium are government politics; amount of investment capital available for this type of property; local supply and demand and yield rate changes in the capital market.

Current methodology does not compare the market value of a specific property when development is completed to its natural or intrinsic value to estimate the amount of value detachment that has occurred between the market value and its natural or intrinsic value. For example, at the height of the great recession (2004-2007) the average detachment of United States real estate from its natural or intrinsic value was 49%. In some real estate segments, the amount of detachment was 100% depending on the property's particular market.

The disclosed methods and systems can detect emerging bubbles in any market and for any real estate classification/type. In addition, the relationship of a property's actual market value and its natural or intrinsic value may be graphically disclosed via a “wave graph” that will show the user where the subject's market value lies in relation to the intrinsic value. This graphical overlay will show if the expected future value is expanding, contracting, is in a recession or in a recovery. The graph will also indicate how long these indications (expanding value, contracting value, recession, or recovery) will last until the property's market value is pulled back to its natural or intrinsic value. Thus, the quantitative information presented may alert a worldwide market that a real estate value bubble is emerging. This may prevent devastating financial collapses due to undetected real estate bubbles in the future.

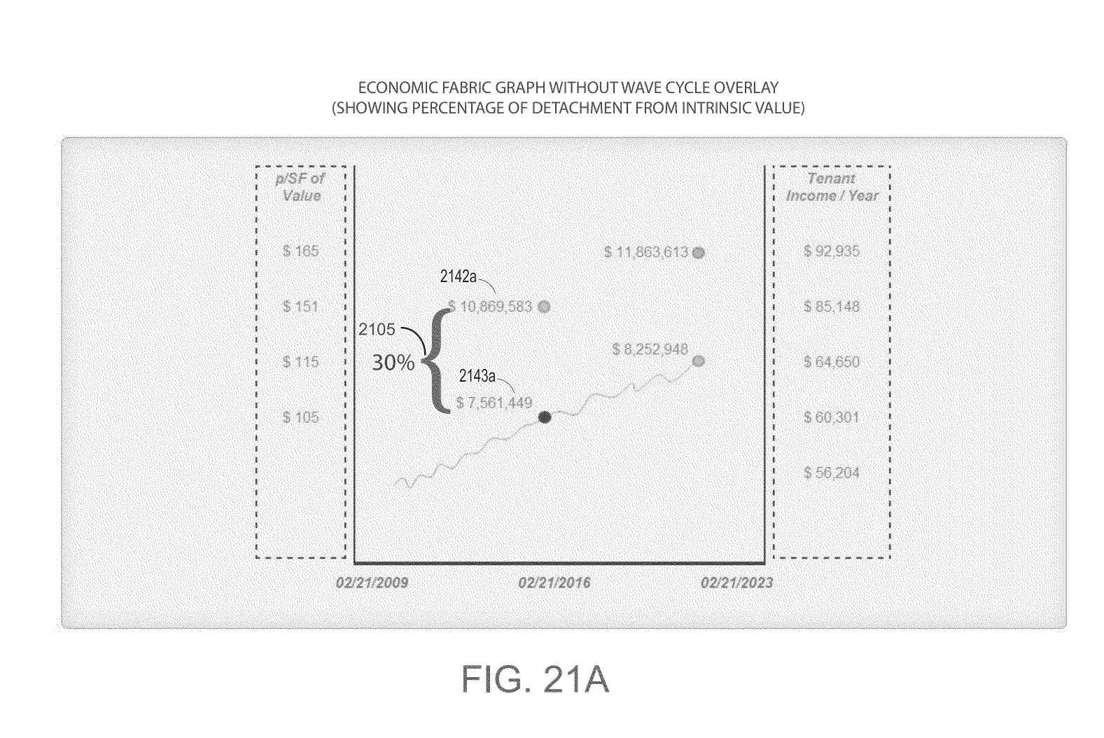

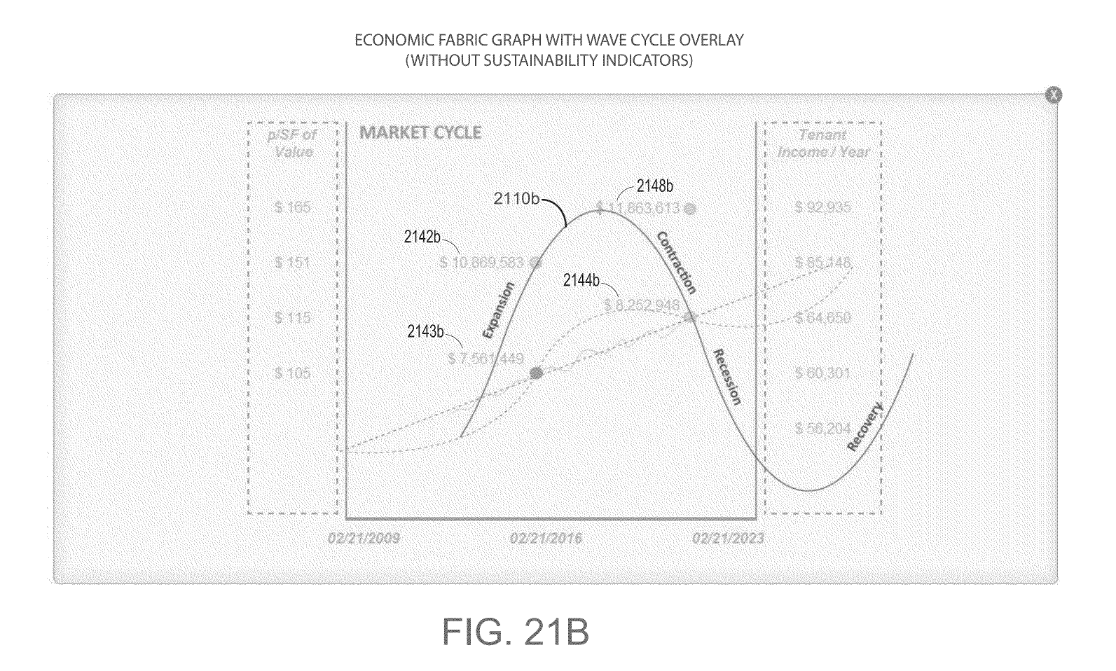

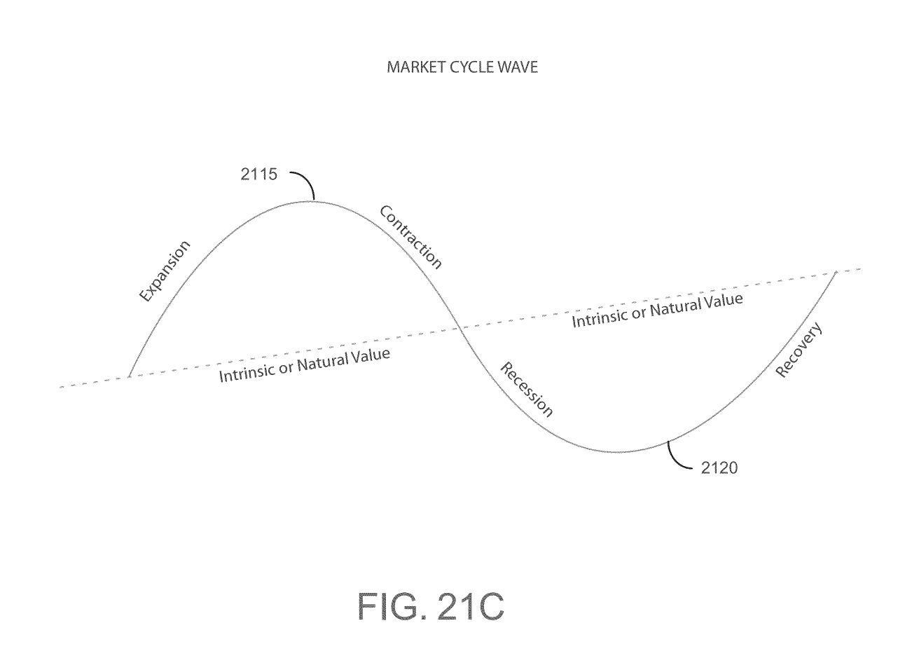

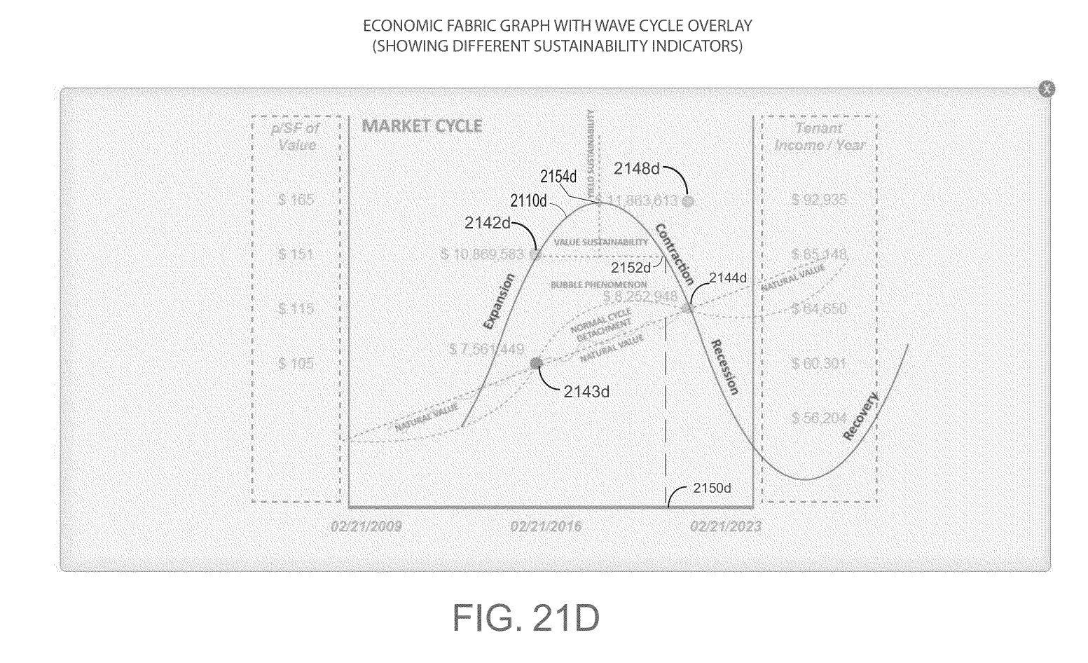

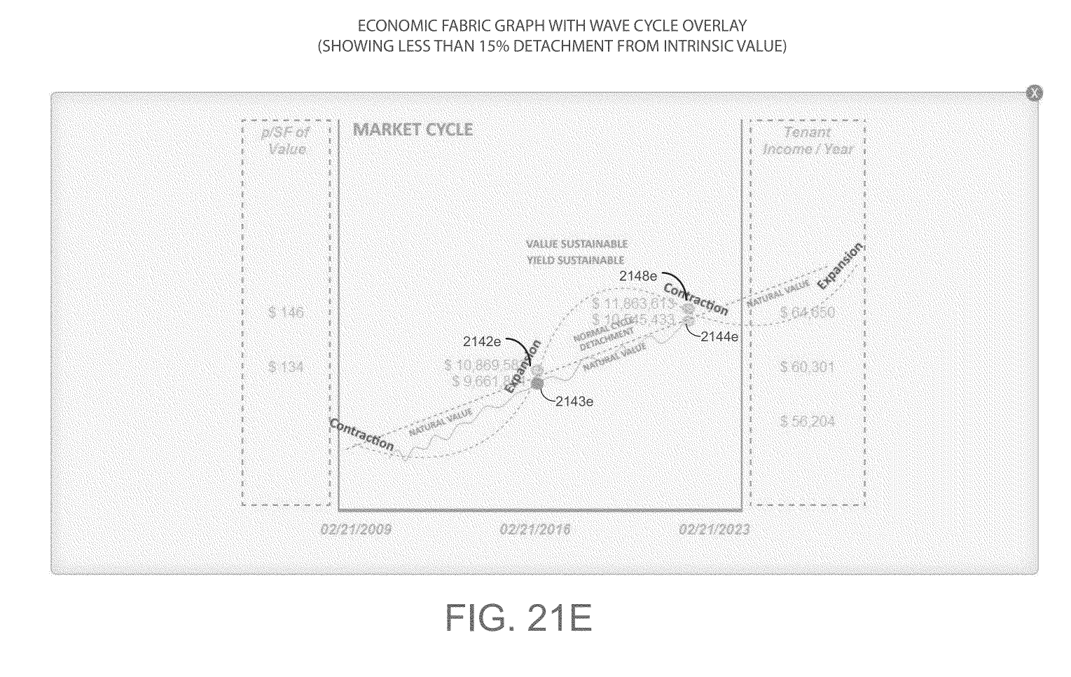

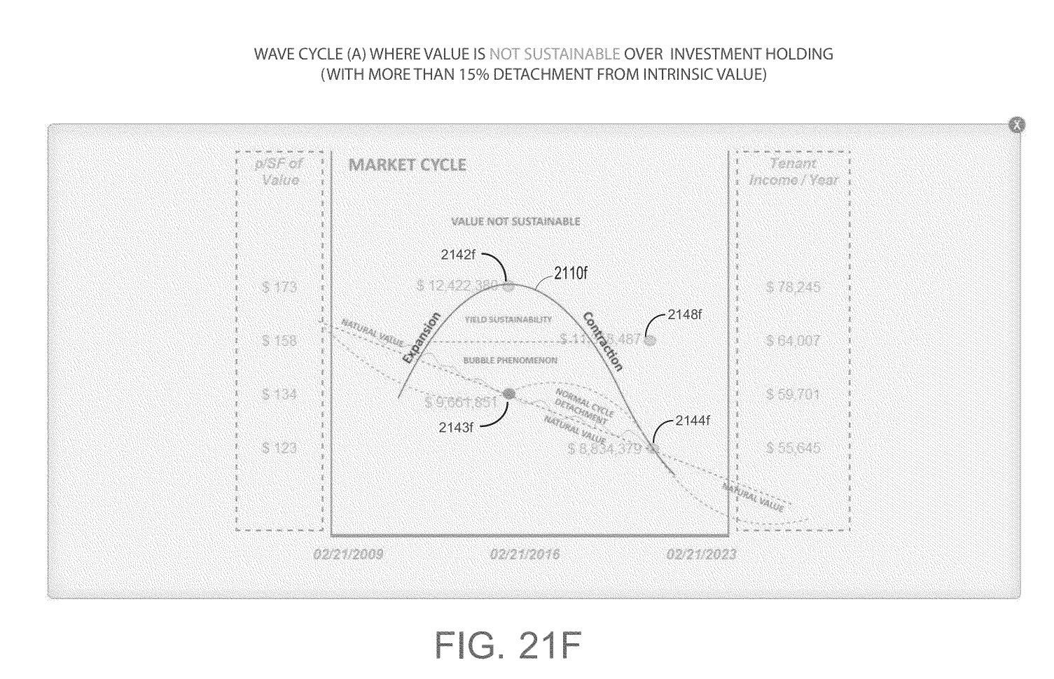

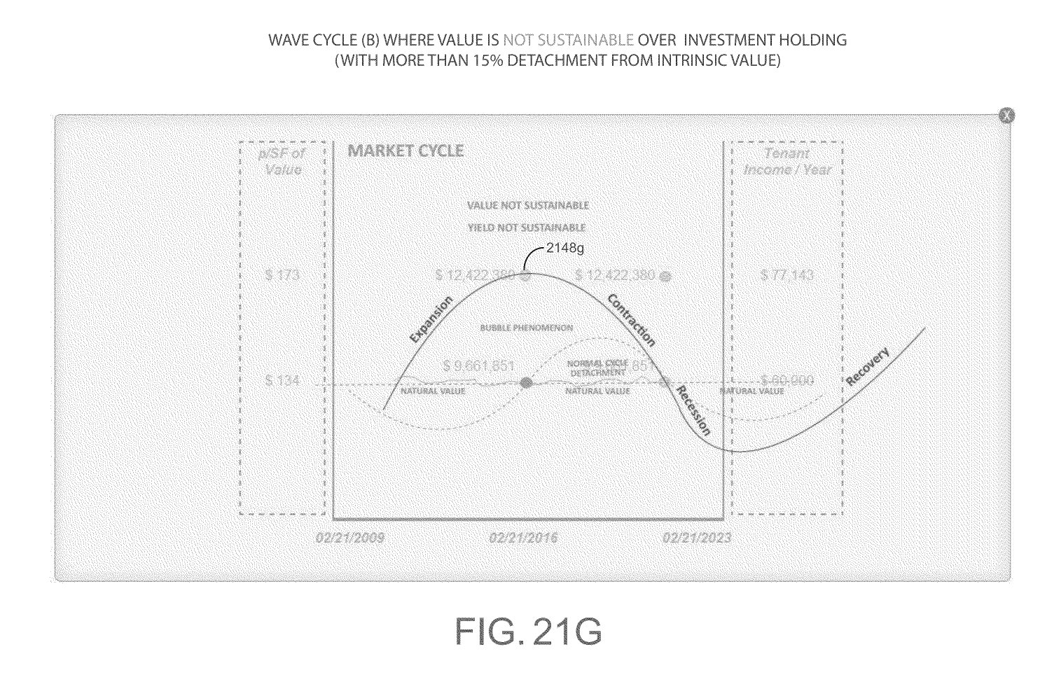

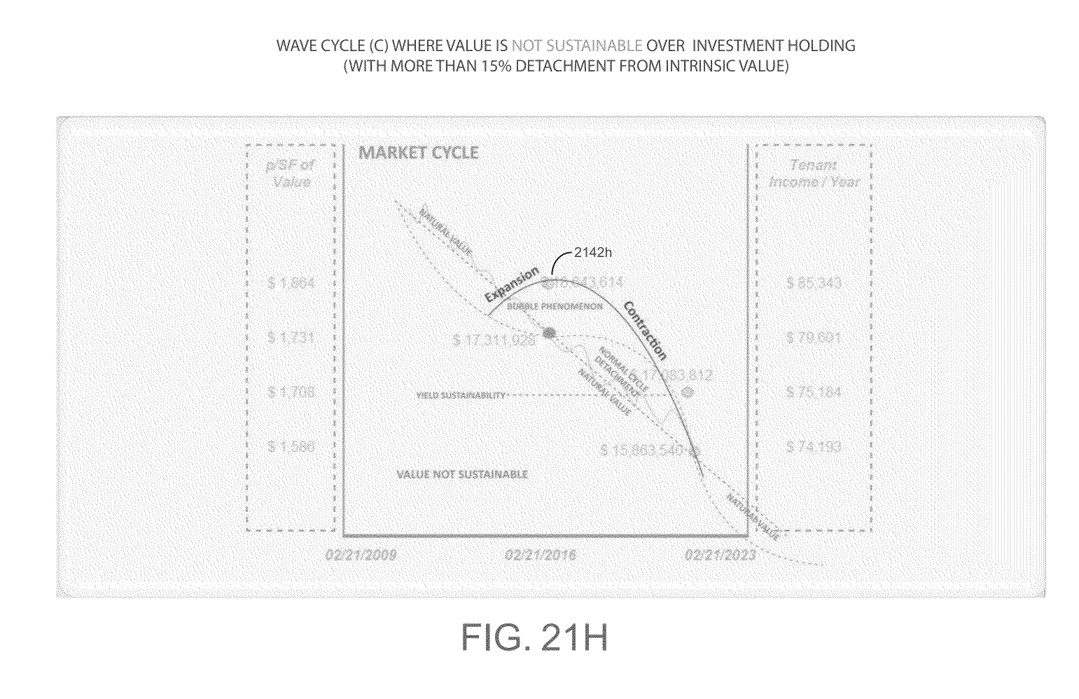

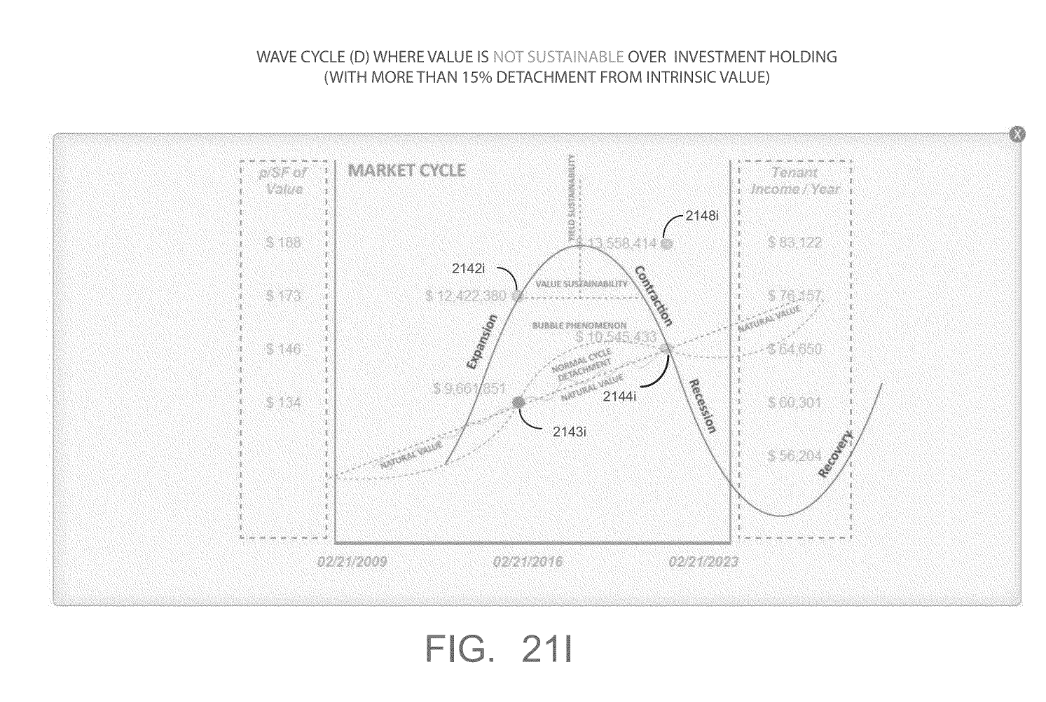

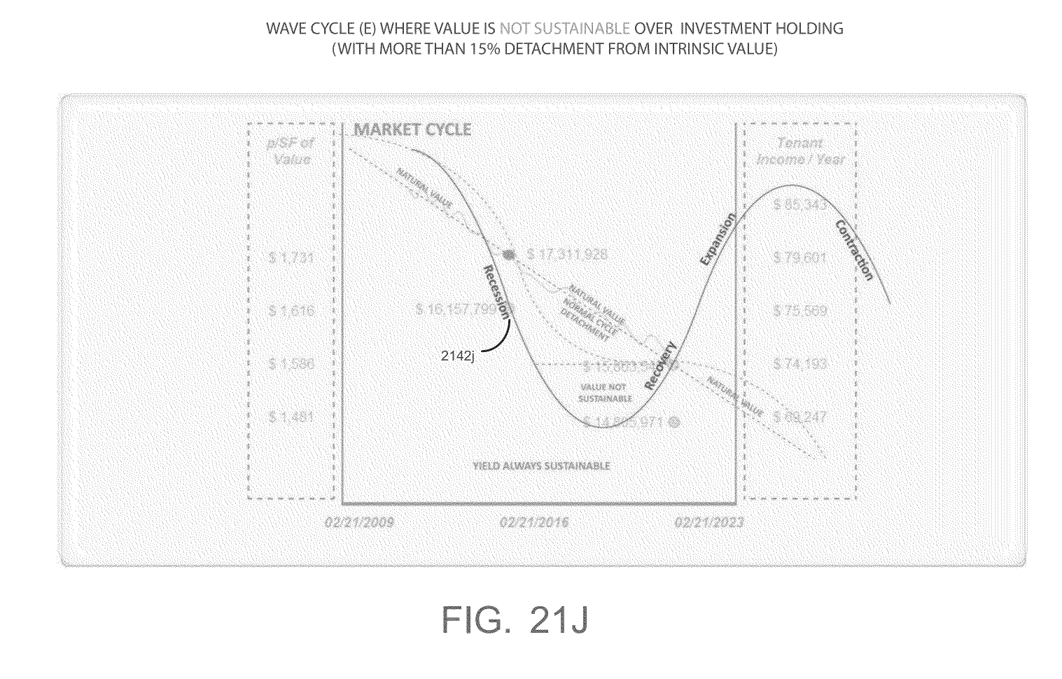

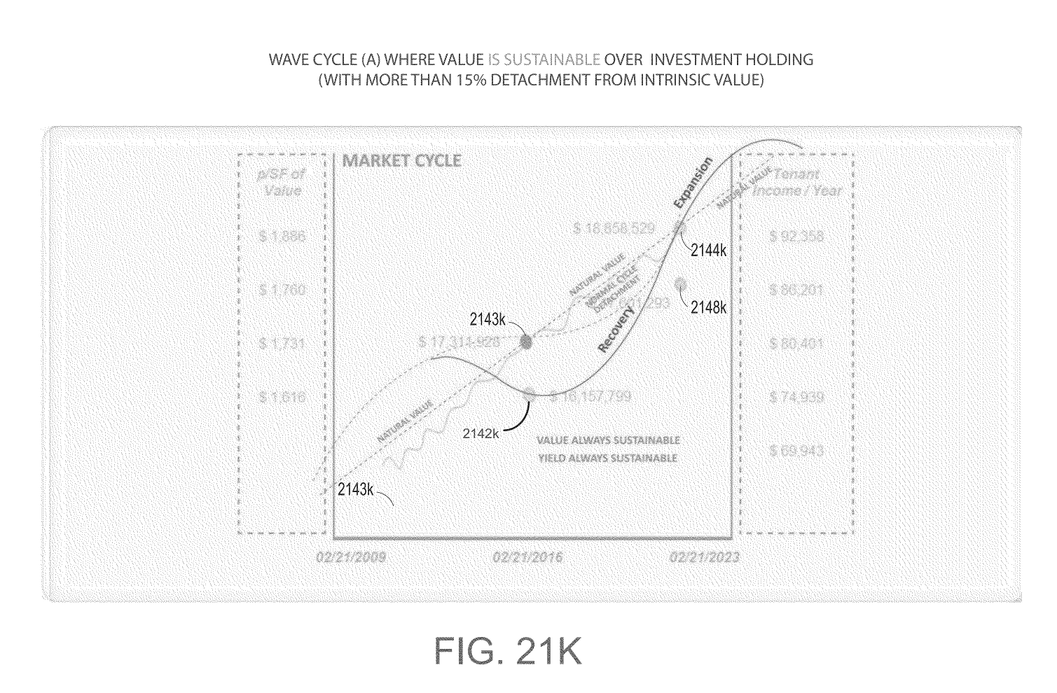

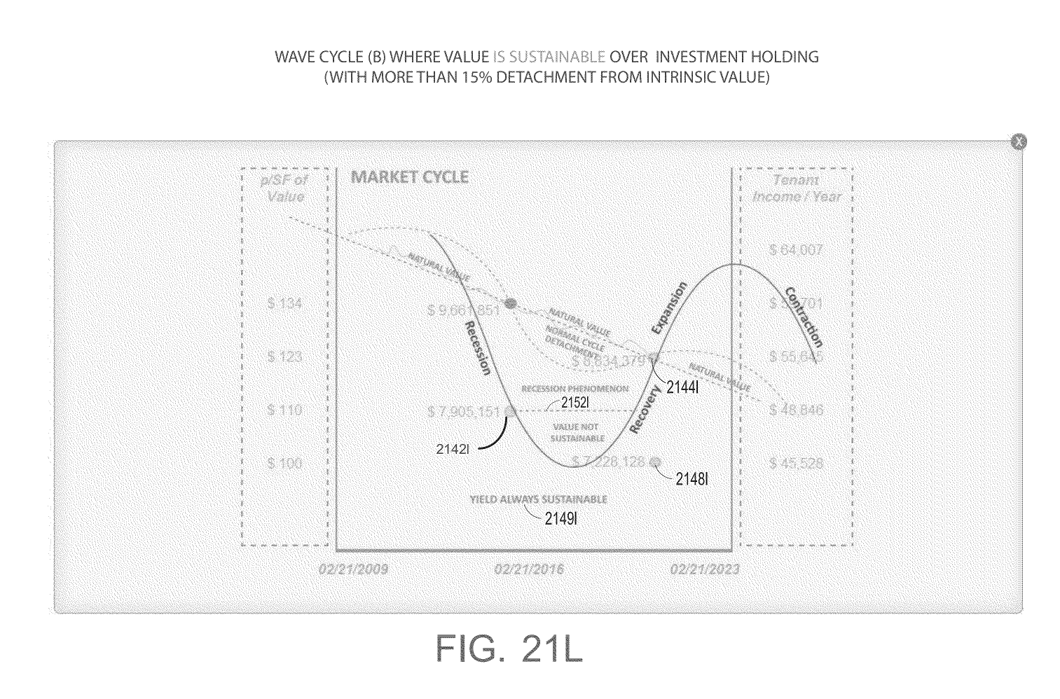

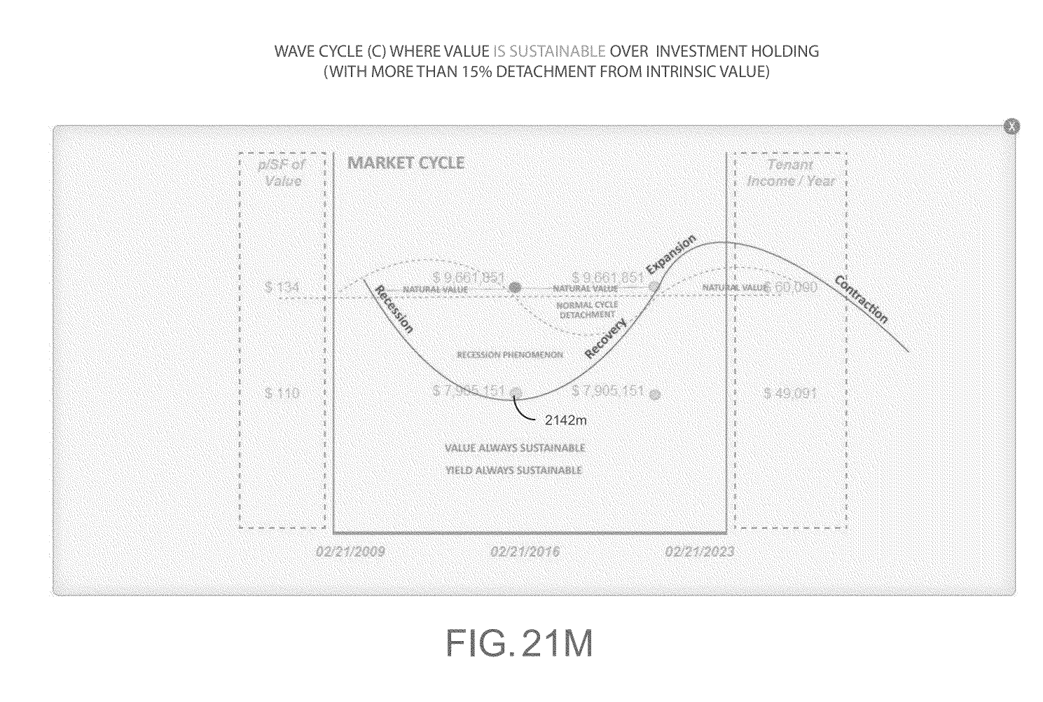

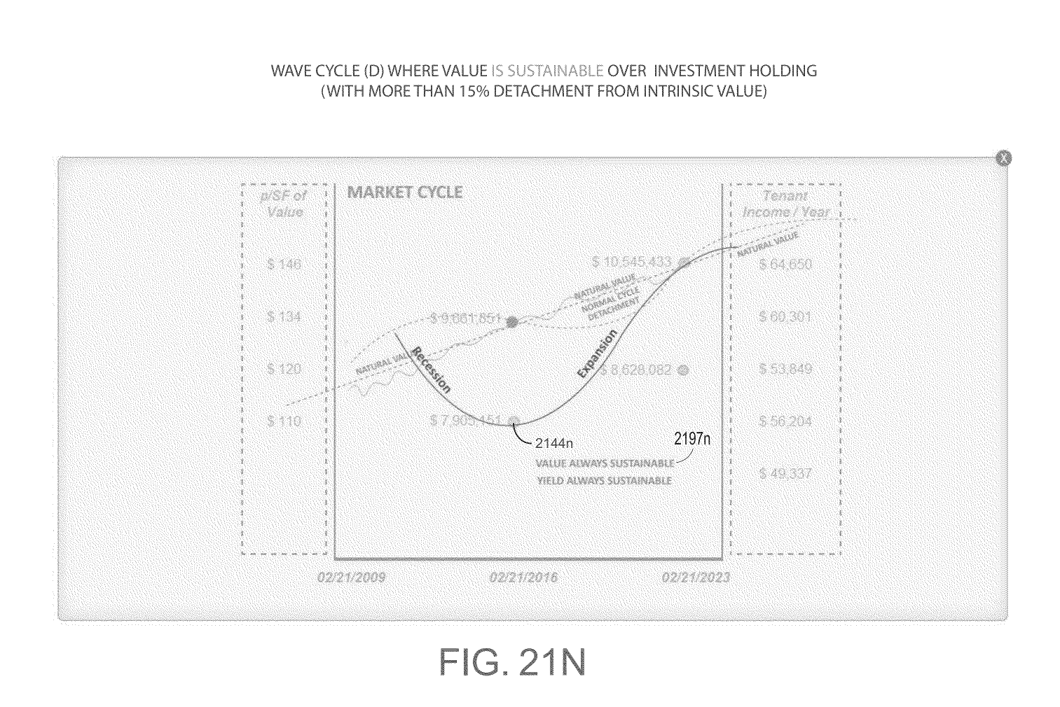

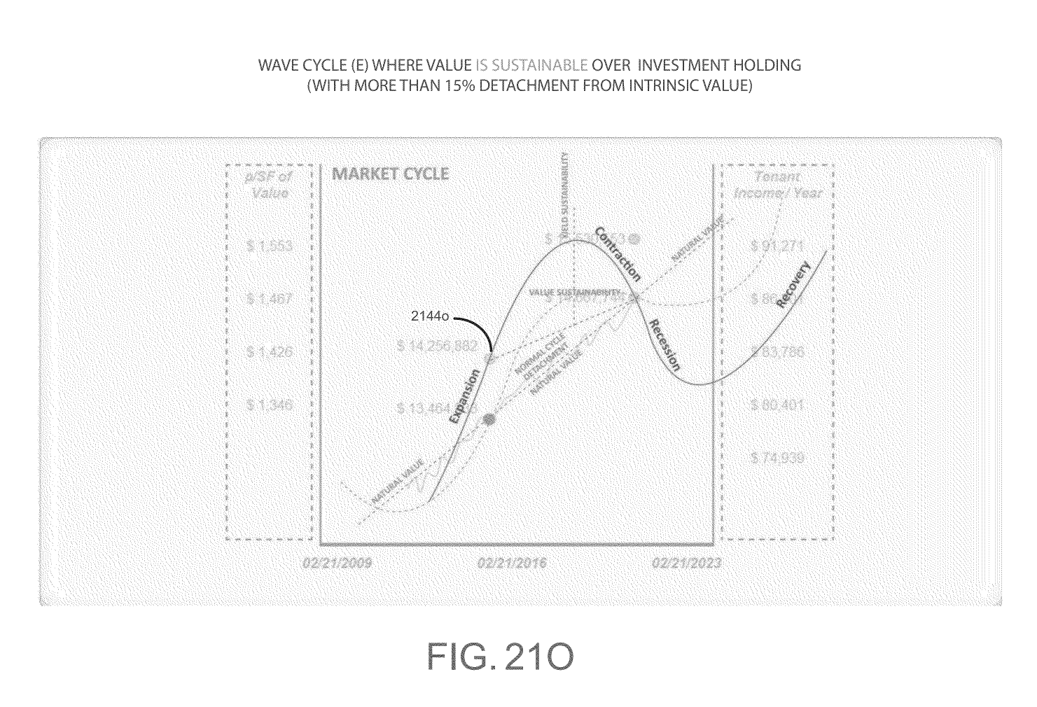

FIG. 21A shows an economic fabric graph (EFG). As discussed above, an economic fabric graph indicates how a property's market value relates to a natural or intrinsic value. The relationship between actual market value and natural or intrinsic value may indicate if the market value has significantly detached from the property's natural or intrinsic value. In FIG. 21, this “detachment” is shown by region 2105. The detachment is the difference between the market value 2142a and the natural or intrinsic value 2143a at the date for which the market value 2142a is determined. When considering a property purchase when the market value is detached as shown in FIG. 21A, a prospective buyer may need to understand if the market value is sustainable over their intended holding period. The sustainability of a property's market price may depend on local, regional, and/or national business cycle conditions.

FIG. 21B shows an economic fabric graph (EFG) that includes a wave-cycle overlay 2110b. The wave cycle graphs shown in FIG. 21B and the following FIGS. 21C-0 use an investment holding period of seven years. Other aspects may use a different investment holding period. The investment holding period is used to determine how long after the time for which the market value (2142b in FIG. 21B) is determined the wave cycle intersects the natural value timeline for the property.

The wave cycle graph 2110b of FIG. 21B is drawn so as to intersect both the market value 2142b and the natural value reversion 2144b (which is seven years out from the date for which the market value 2142b was determined). In the illustrated aspect, the reversion value 2148b is used a high water mark for the value of the wave cycle graph 2110b. However, the wave cycle graph 2110b does not intersect the reversion value 2148b, as the slope the wave cycle graph would be unrealistic if it ran from the reversion value 2148b to the natural value 2144b seven years from the market value 2142b. Instead, the reversion value 2148b is used as a peak value, but the high point is shifted in time such that the wave cycle graph 2110b can intersect the market value, have a peak equivalent to the reversion value 2148b, and also intersect the natural value 2144b seven years from the market value. Note that the method of drawing the wave cycle graph varies based on the relative value of the market value 2142b to the natural value 2143b at the time for which the market value 2142b is determined. The method of drawing the wave cycle graph also varies depending on whether the reversion value 2148b is higher or lower than the market value 2142b, and may also vary based on whether the economic fabric graph is generally increasing or decreasing over time.

FIG. 21C illustrates a wave cycle overlay with an expansion or contraction cycle 2115 of a market value, found above the property's natural or intrinsic value, and a recession or recovery cycle 2120, found below the property's natural or intrinsic value. In some aspects, a wave cycle overlay showing explicit expansion and contraction cycles as shown in FIG. 21C may only be displayed for properties where the detachment between the market value and natural value (as discussed above) is above a threshold value, for example, 15%. If the detachment is below the threshold value, some aspects may consider the difference between the determined market value and the natural value to be within a normal range, such that the market value is considered sustainable in economic fabrics that are level or generally increasing over time.

The relationship of the market value or market value, and the future reversion value (expected ending sale price) with the property's natural or intrinsic value timeline determines how the market value is positioned relative to the wave cycle and whether the market value is sustainable over a particular period of time.

FIG. 21D shows an economic fabric graph with a wave cycle 2110d overlay. The example wave cycle overlay 2110d indicates the market value is sustainable within a limited time period.

In some aspects, the wave cycle graph 2110d is generated to intersect both the current market price or market value 2142d and the reversion of the natural value 2144d seven years out from the market value 2142d. As discussed above, some aspects may use investment holding periods different than the seven year holding period shown in FIGS. 21A-210.

FIG. 21D shows the current market price value 2142d is sustainable, in that a projected market price for the property, shown by the wave cycle graph, is at or above the current market price 2142d until a point 2146d on the wave cycle graph. This point occurs at a date 2150d. Thus, if a user intends to sell the property before the date indicated by 2150d, the current market price 2142d is sustainable and they be able to recoup their investment.

Since the current market value 2142d is above the natural or intrinsic value 2143d, the wave cycle graph shows that the subject property's market value will return to its natural or intrinsic value by the end of the holding period (in the illustrated aspects, seven (7) years). Thus, the graph is drawn such that the wave cycle graph intersects the natural value at the end of the investment holding period (seven years in this example out from the “market value 2142d). This is shown by 2144d. Since the property's modeled market value has a reversion value 2148d, which is higher than the market value, the wave cycle graph is drawn using this reversion value as the high point for the subject property's market valuation. Thus, the wave cycle shows a property valuation high 2154d. In summary, the wave cycle graph is drawn to intersect the current market value 2142d and the reversion of the natural or intrinsic value seven years out 2144d. The high point of the wave cycle graph is based on reversion value 2148d.

Some aspects may include a value sustainability indicator 2152d. The value sustainability indicator is drawn from the current market value 2142d horizontally until it intersects the wave cycle graph. The value sustainability indicator 2152d shows that if the property is sold at any time before the date 2150d, the current market value (or more) may be realized. However, if a sale occurs after date 2150d, less value may be recovered as a result of the sale. Thus, the market value 2142d is considered to be non-sustainable beyond date 2150d.

Some aspects may also include a yield sustainability indicator, shown in FIG. 21D as a vertical line at the peak value of the wave cycle flow graph. The yield sustainability indicator indicates a furthest point in time on the graph within the investment holding period, in FIG. 21D seven years, where the property yield, which is a component of value, can still be achieved. Since, in the illustrated aspect of FIG. 21D, the reversion value 2148d is determined based on the property yield, the yield sustainability indicator is shown when the wave cycle graph indicates a market value equal to the reversion value.

Some aspects determine where the yield sustainability indicator is positioned on the wave cycle graph by determining yields for a series of market value reversions at different points in time along the wave cycle graph. For example, yields may be determined for market value reversions from 2142d to 2144d in some aspects. Other aspects may determine fewer yields.

Some aspects may determine which of the determined yields corresponds to the earliest point in time where the yield drops below the property yield provided in the components of value. A point in time immediately previous to this earliest point may be determined to correspond to the location of the yield sustainability indicator on the wave cycle graph.

FIG. 21E shows another example of an economic fabric graph with a wave cycle overlay. FIG. 21E indicates a current market value of a subject property is sustainable over an investment period of any significant term. The subject property of FIG. 21E has a current market value 2142e that is relatively close to its intrinsic or natural value 2143e. Because the two values are so close, the property value is shown as sustainable, assuming, as shown in FIG. 21E, the natural or intrinsic value is expected to remain level or increase in the future.

FIGS. 21F-I show examples of a current market value of a property 2142f-2142j deviating substantially above the natural or intrinsic value timelines. In the examples of FIGS. 21F-J, the market value may not be sustainable. In FIG. 21F, note that the reversion value 2148f is below its corresponding market value 2142f. In this situation, the reversion value 2148f is not used as a high point for the wave cycle graph 2110f. Instead, the current market value is used as a high point for the wave cycle graph 2110f, and drawn to intersect the natural value reversion 2144f.

FIG. 21F shows market value 2142f significantly above the natural or intrinsic value 2143f at the date the market value is determined. Furthermore, the natural or intrinsic value of the property is declining, perhaps because of an expectation that rents for similar properties will be decreasing over time. This declining intrinsic or natural value results in a steep decline in value along the wave cycle graph from the market value 2142f to the natural or intrinsic value of the property after a seven year holding period 2144f.

FIG. 21J-O show examples of an market value of a property 2142k-o that is below the natural or intrinsic value. FIG. 21J shows a market value 2142J. A reversion value 2148j is below the market value 2142J. Therefore, the reversion value 2148j is used as a low value for one “valley” of the wave cycle graph. The wave cycle graph is drawn from the “as is value” 2142j, to the low reversion value 2148j to the natural value seven years after the market value 2142j.

In contrast to FIG. 21J, in FIG. 21K, the reversion value 2148k is above the market value 2142k. Therefore, the market value 2142k forms a low point in one “valley” of the wave cycle graph. The wave cycle graph intersects the natural value reversion 2144k which in the illustrated aspect is seven years from the market value 2142k.

FIG. 21L shows a sustainability indicator 21521 when the projected market value of the wave cycle graph is below the natural or intrinsic value 21431. Since the reversion value 21461 is below the market value 21421 (and presumed purchase price). Since the value of the market reversion 21481 is below the market value 21421, which is also below the natural value, the reversion is now used as a low point for the “valley” of the wave cycle graph. The wave cycle graph is also drawn to intersect the natural value reversion (seven years from the market value 21421). This intersection is shown as 21441.

The sustainability indicator 21521 is drawn horizontally from the market value 21421 to the wave cycle graph. If the property is sold before the date corresponding to the intersection of the sustainability indicator 21521 and the wave cycle graph, the market value will not be recovered. However, a property sale after that date may provide for recovery of at least the market value 21421.

Note that FIG. 21L also demonstrates use of a yield sustainability indicator 21491. The yield sustainability indicator indicates whether the property yield is sustainable for any holding period shown by the EFG graph of FIG. 21L. While a sentence is shown in FIG. 21L as the yield sustainability indicator, other indicators are contemplated such as the use of icons, and/or colors or a combination of these techniques to denote yield sustainability. Some aspects, such as FIG. 21N demonstrate a value sustainability indicator 2197n. If the wave cycle graph continuously indicates a higher market value than the market value 2144n, the value sustainability indicator may indicate that the value is always sustainable. As discussed above with respect to the yield sustainability indicator, other methods of denoting value sustainability are contemplated, such as icons, colors, and/or a combination of these techniques.

It may be appreciated that the systems and methods described herein may be applied to environments other than commercial real estate projects. Any project receiving input from a user over a computer network, determining one or more valuations, and delivering data indicating the valuation to the user may benefit from the disclosed methods and systems.

Headings are included herein for reference and to aid in locating various sections. These headings are not intended to limit the scope of the concepts described with respect thereto. Such concepts may have applicability throughout the entire specification.

While illustrative embodiments have been disclosed and discussed, one skilled in the relevant art will appreciate that additional or alternative embodiments may be implemented within the spirit and scope of the present disclosure. Additionally, although many embodiments have been indicated as illustrative, one skilled in the relevant art will appreciate that the illustrative embodiments do not need to be combined or implemented together. As such, some illustrative embodiments do not need to be utilized or implemented in accordance with the scope of variations to the present disclosure.

Conditional language, such as, among others, “can,” “could,” “might,” or “may,” unless specifically stated otherwise, or otherwise understood within the context as used, is generally intended to convey that certain embodiments include, while other embodiments do not include, certain features, elements or steps. Thus, such conditional language is not generally intended to imply that features, elements or steps are in any way required for one or more embodiments or that one or more embodiments necessarily include logic for deciding, with or without user input or prompting, whether these features, elements or steps are included or are to be performed in any particular embodiment. Moreover, unless specifically stated otherwise, or otherwise understood within the context as used, is generally intended to convey utilization of the conjunction “or” in enumerating a list of elements does not limit the selection of a single element and can include the combination of two or more elements.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art. It will further be appreciated that the data and/or components described above may be stored on a computer-readable medium and loaded into memory of the computing device using a drive mechanism associated with a computer-readable medium storing the computer executable components, such as a CD-ROM, DVD-ROM, or network interface. Further, the component and/or data can be included in a single device or distributed in any manner. Accordingly, general purpose computing devices may be configured to implement the processes, algorithms and methodology of the present disclosure with the processing and/or execution of the various data and/or components described above. Alternatively, some or all of the methods described herein may alternatively be embodied in specialized computer hardware. In addition, the components referred to herein may be implemented in hardware, software, firmware or a combination thereof.

Having thus described a preferred embodiment of a method and system for organizing and scheduling meals over a network, it should be apparent to those skilled in the art that certain advantages of the disclosed method and system have been achieved. It should also be appreciated that various modifications, adaptations, and alternative embodiments thereof may be made within the scope and spirit of the present disclosed solution. The disclosed solution is further defined by the following claims.

What is claimed is:

1. An apparatus for computer assisted valuation modeling, comprising:
a processor, configured to present a real estate project timeline on a user interface of an electronic display, the processor configured to display the real estate project timeline as one of two types, the first type indicating an as if complete at stabilized occupancy value, the second type indicating an aggregate retail value, wherein the processor is further configured to execute:
a first module that presents an as is value of unentitled land with the timeline when the timeline is of the first or second type,
a second module that presents an as is value of entitled land with the timeline when the timeline is of the first or second type, and
a third module that presents an as is value of entitled land and improvements with the timeline when the timeline is of the first or second type.

2. The apparatus of claim 1, wherein the processor is further configured to execute a fourth module that presents an as if complete at non stabilized occupancy value with the timeline when the timeline is of the first type and displays a bulk value with the timeline when the timeline is of the second type.

3. The apparatus of claim 1, wherein the processor is further configured to present a second timeline on a user interface of an electronic display, the processor configured to execute a fifth module that presents an as is complete value and a reversion value with the second timeline.

4. An apparatus for computer assisted valuation modeling, comprising:
a network interface configured to receive data defining an economic fabric graph;
an electronic display presenting the economic fabric graph and a wave cycle overlay, the economic fabric graph relating a market value to an intrinsic/natural value; and
an electronic processor configured to receive data from the network interface and present the data on the electronic display.

5. The apparatus of claim 4, wherein the economic fabric graph relates both a real estate project's natural value to the real estate project's market value, and a reversion of the real estate project's natural value to a reversion of the real estate project's market value.

6. The apparatus of claim 5, wherein the display is presenting a wave cycle flow graph with the economic fabric graph, the wave cycle flow graph intersecting the market value and the natural value reversion.

7. The apparatus of claim 6, wherein the display presents a yield sustainability indicator intersecting the wave cycle flow graph.

8. The apparatus of claim 6, wherein the display presents the wave cycle flow graph with a bubble indicator when the market value is above the intrinsic value by greater than a threshold.

9. The apparatus of claim 6, wherein the display presents, with the wave cycle flow graph, an indication of the sustainability of the market value.

10. An apparatus for valuation modeling of a real estate project, comprising:
one or more electronic processors configured to:
present, on a user interface of a computer, a graphical depiction of a development timeline for the real estate project, and
present, simultaneously with the development timeline, an indication of whether the real estate project is economically feasible on the user interface of the computer.

11. The apparatus of claim 10, wherein the one or more processors are configured to:
determine an as is value based on a discounted cash flow based on a going out capitalization rate;
present the as is value simultaneously with the timeline on the user interface;
receive input defining an updated as is value;
update the going out capitalization rate and recompute the discounted cash flow based on the updated going out capitalization rate until the discounted cash flow generates a value equivalent to the updated as is value; and
present the updated going out capitalization rate on the user interface.

12. The apparatus of claim 10, wherein the one or more processors are configured to:
determine an as is value based on a discounted cash flow using a property discount rate;
present the as is value simultaneously with the timeline on the user interface;
receive input defining financing information;
update the property discount rate and recompute a second discounted cash flow using the updated property discount rate and the financing information until the second discounted cash flow generates a value equivalent to the as is value; and
present the updated property discount rate as an equity yield on the user interface of the computer.

13. The apparatus of claim 10, wherein the one or more processors are configured to present, on the user interface of the computer, simultaneous with the development timeline,
two or more of an as is value, an as if complete stabilized value, and an aggregate retail value.

14. The apparatus of claim 10, wherein the one or more processors are configured to:
present either an as if complete at non-stabilized occupancy value or an bulk/wholesale value on the timeline;
present a cost of production value on the timeline; and
present the indicator of financial feasibility based on a relationship between the cost of production and either the presented as if complete at non-stabilized occupancy value or the presented bulk/wholesale value.

15. The apparatus of claim 10, wherein the one or more processors are further configured to:
request holding period data from the user if the project is not financially feasible;
receive holding period data from the user in response to the request;
adjust the presented timeline based on the received holding period data;
determine whether the real estate project is financially feasible based on the received holding period data; and
present an updated indication of financial feasibility on the user interface based on the determining.

16. The apparatus of claim 10, wherein the one or more processors are further configured to:
present on the user interface, input fields for one or more components of value of the real estate project; and
iteratively receive updates to one or more of the components of value, determining an updated as is value based on the updated components of value, and updating the project timeline based on the updated “as is” value.

17. The apparatus of claim 10, wherein the one or more processors are further configured to:
receive financing parameters for the real estate project;
determine an equity yield based at least in part on the financing parameters;
present data on the user interface indicating the equity yield;
iteratively receive updates to the financing parameters; and
update the equity yield based at least in part on the updated financing parameters, and present the updated equity yield on the user interface.

18. The apparatus of claim 10, wherein the one or more processors are further configured to:
determine the property's natural value based on an estimated rent and an estimated rental growth rate;
determine the property's market value based on a discounted cash flow; and
present, on the user interface of the computer, a first graph relating the property's natural value to the property's market value.

19. The apparatus of claim 18, wherein the one or more processors are further configured to present the graph to indicate tenant rental personal income.

20. The apparatus of claim 18, wherein the one or more processors are further configured to present on the user interface, simultaneous with the first graph, a second graph of estimated valuations of the property over a plurality of points in time, the second graph intersecting the market value and a reversion value for the property's natural value.

21. The apparatus of claim 20, wherein the one or more processors are further configured to present the second graph to have a maximum or minimum value of a market reversion value.

22. The apparatus of claim 20, wherein the one or more processors are further configured to present the second graph based on whether an estimate of rental income over time is positive or negative.

23. The apparatus of claim 20, wherein the one or more processors are further configured to present on the user interface, simultaneous with the second graph, a horizontal line indicating the sustainability of the market value, each end of the horizontal line intersecting a separate point on the second graph, wherein one of the separate points is the market value.
